(19) United States
(12) Patent Application Publication
(10) Pub. No.: US 2013/0061477 A1
(43) Pub. Date: Mar. 14, 2013

(54) Safety Cutter with Improved Blade Depth Adjustment Mechanism

(71) Applicants: Joseph L. Lutgen, Costa Mesa, CA (US); Markus E. Gropl, Huntington Beach, CA (US); Brandon L. Spoelstra, Costa Mesa, CA (US); Joseph P. Garavaglia, Newport Beach, CA (US)

(72) Inventors: Joseph L. Lutgen, Costa Mesa, CA (US); Markus E. Gropl, Huntington Beach, CA (US); Brandon L. Spoelstra, Costa Mesa, CA (US); Joseph P. Garavaglia, Newport Beach, CA (US)

(21) Appl. No.: 13/228,416

(22) Filed: Sep. 8, 2011

(51) Int. Cl. B26B 1/02; B26B 1/00

(52) U.S. Cl. 30/158; 30/164

(57) ABSTRACT

A cutter apparatus includes a housing with an opening, a blade carrier coupled to and repositionable in relation to the housing, an actuator for repositioning the blade carrier to a deployed position, the blade carrier repositioning toward the deployed position in response to movement of the actuator toward an actuator blade deployment position, a push rod that is repositionable within the housing and coupled to the blade carrier such that a location of one or more portions of the push rod in relation to the housing determines the blade depth extending from the opening of the housing when the blade carrier is deployed, and a blade depth selector coupled to the push rod such that a user of the cutter apparatus can set the location to provide a desired blade depth by selectively repositioning the blade depth selector in relation to the housing.

### CROSS-REFERENCE TO RELATED APPLICATIONS

This application is related to U.S. Design Pat. No. ______, entitled “Cutter Housing” filed herewith, U.S. Utility Pat. No. ______, entitled “Ergonomic Cutter” filed herewith, U.S. Utility Pat. No. ______, entitled “Cutter and Safety Holster System” filed herewith, U.S. Utility Pat. No. ______, entitled “Safety Cutter with Improved Blade Deployment Mechanism” filed herewith, U.S. Utility Pat. No. ______, entitled “Safety Cutter with Improved Blade Locking Mechanism” filed herewith, U.S. Utility Pat. No. ______, entitled “Safety Cutter with Improved Blade Change Mechanism” filed herewith, U.S. Utility Pat. No. ______, entitled “Safety Cutter with Improved Blade Storage Mechanism” filed herewith, which are hereby incorporated by reference.

### TECHNICAL FIELD

The present invention relates generally to cutters and, in particular, a cutter with a mechanism or device that facilitates a blade depth adjustment for the cutter.

### BACKGROUND ART

A great variety of knives, cutters, safety cutters, and cutter apparatuses (and holsters for same) are known. Features variously found in prior knives, cutters, safety cutters, and cutter apparatuses include mechanisms and devices facilitating, for example, blade deployment, blade locking, blade depth adjustment, blade change, or blade storage. Various ergonomic devices and apparatuses are also known.

It would be useful to be able to provide one or more of: an ergonomic hand tool such as a cutter and/or an ergonomic housing or handle for same; a safety holster for a hand tool (such as a cutter); a cutter with a mechanism or device that facilitates improved, advantageous, or otherwise desirable or useful deployment of a blade from the cutter; a cutter with a mechanism or device that facilitates improved, advantageous, or otherwise desirable or useful locking (i.e., securing) of a blade of the cutter in position during a cutting operation; a cutter with a mechanism or device that facilitates an improved, advantageous, or otherwise desirable or useful blade depth adjustment for the cutter; a cutter with a mechanism or device that facilitates an improved, advantageous, or otherwise desirable or useful blade change operation for the cutter; and a cutter with a mechanism or device that facilitates an improved, advantageous, or otherwise desirable or useful blade change operation for the cutter.

### SUMMARY OF THE INVENTION

In an example embodiment, a cutter apparatus includes a housing with an opening, a blade carrier coupled to and repositionable in relation to the housing, an actuator for repositioning the blade carrier to a deployed position, the blade carrier repositioning toward the deployed position in response to movement of the actuator toward an actuator blade deployment position, a push rod that is repositionable within the housing and coupled to the blade carrier such that a location of one or more portions of the push rod in relation to the housing determines the blade depth extending from the opening of the housing when the blade carrier is deployed, and a blade depth selector coupled to the push rod such that a user of the cutter apparatus can set the location to provide a desired blade depth by selectively repositioning the blade depth selector in relation to the housing.

### BRIEF DESCRIPTION OF THE DRAWINGS

FIG. 1 is a perspective view of an example embodiment of a cutter apparatus;

FIG. 2 is an exploded perspective view of the cutter apparatus of FIG. 1;

FIG. 3 is a partial cross-sectional side view of the cutter apparatus of FIG. 1 showing a blade carrier for holding a blade, an actuator for deploying the blade, and a linkage member for controlling deployment of the blade to a selected blade depth, the linkage member being shown positioned to facilitate repositioning of the blade to a deployed position at which a full blade depth is extended;

FIG. 4 shows that, with the linkage member positioned as in FIG. 3, movement of the actuator to its activated position causes the blade to reposition to the deployed position at which its full blade depth is extended;

FIG. 5A is a partial cross-sectional perspective view of another example embodiment of a cutter apparatus showing a blade carrier for holding a blade and an actuator for deploying the blade;

FIG. 5B shows the actuator of FIG. 5A in a blade deployment position;

FIG. 6A is a partial cross-sectional perspective view of another example embodiment of a cutter apparatus showing a blade carrier for holding a blade and an actuator for deploying the blade;

FIG. 6B shows the actuator of FIG. 6A in a blade deployment position;

FIG. 7 is a partial cross-sectional side view of the cutter apparatus of FIG. 1 showing a blade carrier for holding a blade, an actuator for deploying the blade, and a linkage member for controlling deployment of the blade to a selected blade depth, the linkage member being shown positioned to facilitate repositioning of the blade to a deployed position at which a partial blade depth is extended;

FIG. 8 shows that, with the linkage member positioned as in FIG. 7, movement of the actuator to its activated position causes the blade to reposition to the deployed position at which a partial blade depth is extended;

FIG. 9 is a bottom view of the cutter apparatus of FIG. 1 showing its actuator in an activated position and dual cut guards (of the cutter apparatus) in their respective fully retracted positions;

FIG. 10 is a bottom perspective view showing the right side cut guard of FIG. 9 repositioned to an extended position;

FIG. 11 is a perspective view showing the linkage member of the cutter apparatus of FIG. 1 slidably supported within the housing;

FIGS. 12A and 12B show an example configuration of “locking slots” for locking or securing the blade carrier of the cutter apparatus of FIG. 1 in an extended position;

FIGS. 13A-13E show the blade depth selector of the cutter apparatus of FIG. 1 in operation;

FIGS. 14A-14C show another example embodiment of a blade depth selector which includes resiliently coupled engagement elements;

FIGS. 15A and 15B show another example embodiment of a blade depth selector which includes a cam wheel;

FIG. 16 shows that, with the linkage member positioned as in FIG. 4, movement of the deployed blade to an extended position brings the blade carrier into engagement with a “lock slot” configured to accommodate the full blade depth;

FIG. 17 shows that, with the linkage member positioned as in FIG. 8, movement of the deployed blade to an extended position brings the blade carrier into engagement with a “lock slot” configured to accommodate the partial blade depth;

FIGS. 18-20 show another example embodiment in which the linkage member includes an alignment slot that prevents the blade carrier in an extended position from rotating back into the housing of the cutter apparatus;

FIG. 21 shows the hood of the cutter apparatus of FIG. 1 being repositioned away from the housing of the cutter apparatus after latching members of the hood are disengaged from the housing;

FIG. 22 shows another example embodiment of latching members for the hood;

FIG. 23 shows the blade release device of the cutter apparatus of FIG. 1 in operation, repositioning toward the blade carrier;

FIG. 23A is a perspective view of the blade carrier of the cutter apparatus of FIG. 1 showing the blade lock in its locked position;

FIG. 24 shows the blade release device of the cutter apparatus of FIG. 1 in operation, deflecting the blade lock away from the blade carrier;

FIG. 25 shows a blade being removed from the blade carrier after the blade lock is disengaged;

FIG. 26 shows the blade release device of the cutter apparatus of FIG. 1 in its blade release position at which a portion of the blade release device engages a portion of the blade carrier preventing the blade carrier from rotating back into the housing during the blade change operation;

FIG. 27 shows the hood of the cutter apparatus of FIG. 1 being opened to gain access to the blade storage assembly mounted on the underside of the hood;

FIG. 28 shows the hood of the cutter apparatus of FIG. 1 in its fully opened position and the new blade storage compartment of the blade storage assembly repositioned away from the hood;

FIG. 29 illustrates that the new blade storage compartment of FIG. 28 serves as a cover for the used blade storage compartment of the blade storage assembly;

FIG. 29A shows the slider of the new blade storage compartment of FIG. 28 repositioned to extend a blade from the new blade storage compartment;

FIG. 29B illustrates that the guide member of the new blade storage compartment of FIG. 28 serves as a cover for the new blade storage compartment;

FIGS. 30, 30A, and 30B show another example embodiment of a blade storage assembly;

FIGS. 31, 31A, 31B, 31C, 31D, and 31E are perspective, right side, cross-sectional, top, bottom, and front views, respectively, of an example blade carrier;

FIGS. 32, 32A, 32B, 32C, and 32D are perspective, right side, front, top, and bottom views, respectively, of an example blade actuator (or flapper);

FIGS. 33, 33A, 33B, 33C, and 33D are perspective, right side, front, top, and bottom views, respectively, of an example linkage member (or push rod);

FIGS. 34, 34A, 34B, 34C, and 34D are perspective, right side, front, top, and bottom views, respectively, of an example blade depth selector;

FIGS. 35, 35A, 35B, 35C, 35D, and 35E are top right perspective, top left perspective, right side, top, back, and front views, respectively, of an example blade release device;

FIG. 36 is a perspective view of an example embodiment of a cutter and safety holster system;

FIG. 37 is a perspective view showing the holster, the clip, the hinge, and the locking element of the cutter and safety holster system of FIG. 36;

FIGS. 38A, 38B, and 38C are top, left side, and front views, respectively, of the holster, the clip, the hinge, and the locking element of the cutter and safety holster system of FIG. 36;

FIGS. 39A and 39B show example configurations facilitated by the rotatable/reconfigurable coupling between the holster body and the hinge of the cutter and safety holster system of FIG. 36;

FIG. 40A shows the hinge and the clip of the cutter and safety holster system of FIG. 36 in an example rotatably selected orientation of the hinge in relation to the clip;

FIG. 40B shows the locking element of the cutter and safety holster system of FIG. 36 engaged with the base portion of the clip to lock in place the selected orientation of the hinge in relation to the clip;

FIGS. 41 and 42 illustrate how the holster of the cutter and safety holster system of FIG. 36 is utilized by first placing the front of the cutter apparatus into the pocket on the front of the holster and then pressing the rear of the cutter apparatus into the holster body;

FIGS. 43 and 44 show how the cutter-holster interface of the cutter and safety holster system of FIG. 36 repositions the engagement elements (of the blade depth selector of the cutter apparatus) laterally in relation to the housing and along the housing, respectively, as the cutter apparatus is pushed into the holster body;

FIGS. 45 and 46 show how the cutter-holster interface of the cutter and safety holster system of FIG. 36 repositions the engagement portion (of the blade depth selector of the cutter apparatus) along the housing to a “safe position” as the cutter apparatus is repositioned into the holster body;

FIG. 47 shows the retaining elements (of the holster body) of the cutter and safety holster system of FIG. 36 holding the cutter apparatus in place when the cutter apparatus is fully inserted into the holster body;

FIG. 48 shows that when the cutter apparatus is taken out of the holster body of the cutter and safety holster system of FIG. 36 the blade depth selector (of the cutter apparatus) is already set to the safe position;

FIGS. 49 and 50 illustrate example hand-housing interfaces provided by a cutter apparatus which are favorable to natural accommodation of the hand while using the cutter apparatus;

FIGS. 51-54 show example curved surfaces and recessed portions of a cutter apparatus that facilitate or accommodate ergonomic handling or other utilizations of the cutter apparatus;

FIG. 55 shows an example embodiment of a cutter apparatus being used (in a “top cut mode”) with one of its cut guards extended; and

FIG. 56 shows an example embodiment of a cutter apparatus being used (in a “tray cut mode” or “standard cut mode”) with both cut guards retracted.

### DISCLOSURE OF INVENTION

### Blade Deployment

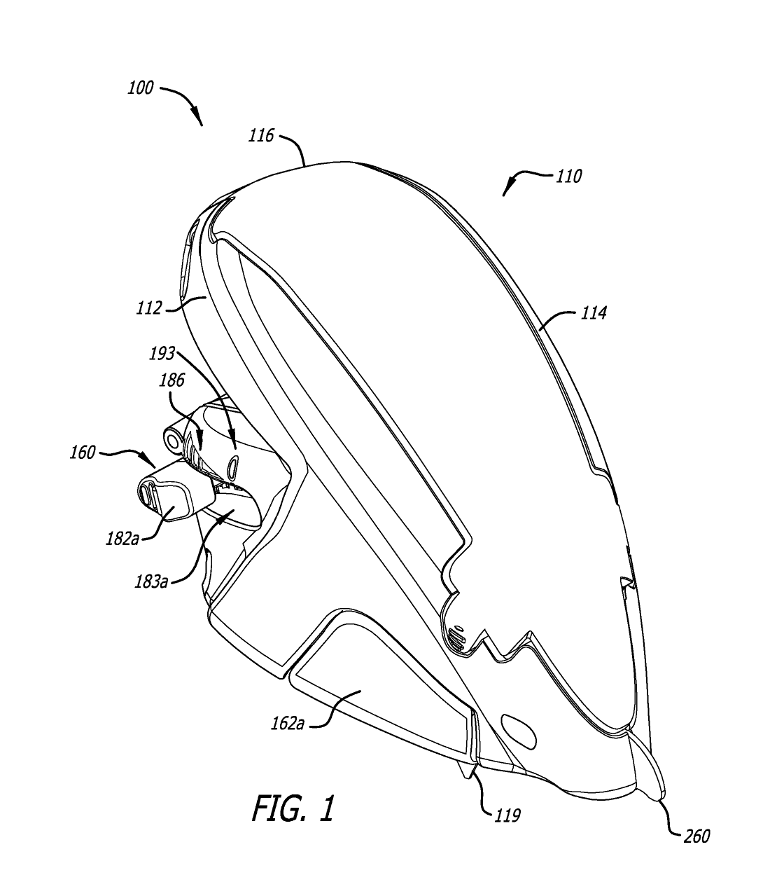

In example embodiments described herein, a cutter (or cutter apparatus) includes a mechanism or device that facilitates deployment of a blade from the cutter. Referring to FIGS. 1-4, in an example embodiment, a cutter apparatus 100 includes a housing 110 with a right side portion 112, a left side portion 114, and a hood 116 configured as shown. The right side portion 112, the left side portion 114, and the hood 116 can be formed of various materials, for example, a thermoplastic that has high strength, rigidity, and impact resistance (e.g., Acrylonitrile butadiene styrene (ABS)), and by various processes (e.g., injection molding).

In this example embodiment, the cutter apparatus 100 includes a blade holder (or blade carrier) 118, which is coupled to the housing 110 and configured for holding a blade 119. In example embodiments, the blade carrier 118 is repositionable in relation to the housing 110 and provides a structure in which to hold the blade 119. In this example embodiment, the blade carrier 118 includes left and right portions as shown, which are secured together at opposite sides of the blade 119 to hold the blade 119 in a fixed position in relation to the blade carrier 118. The left and right portions of the blade carrier 118 can be formed of various materials, for example, a zinc alloy (e.g., Zamak 2), and by various processes (e.g., die cast). In an example embodiment, the blade carrier 118 is assembled in a manner (e.g., with heads deformed by a punch, similar to a solid rivet) that prevents or at least discourages a user of the cutter apparatus 100 from attempting to separate the blade 119 from the blade carrier 118.

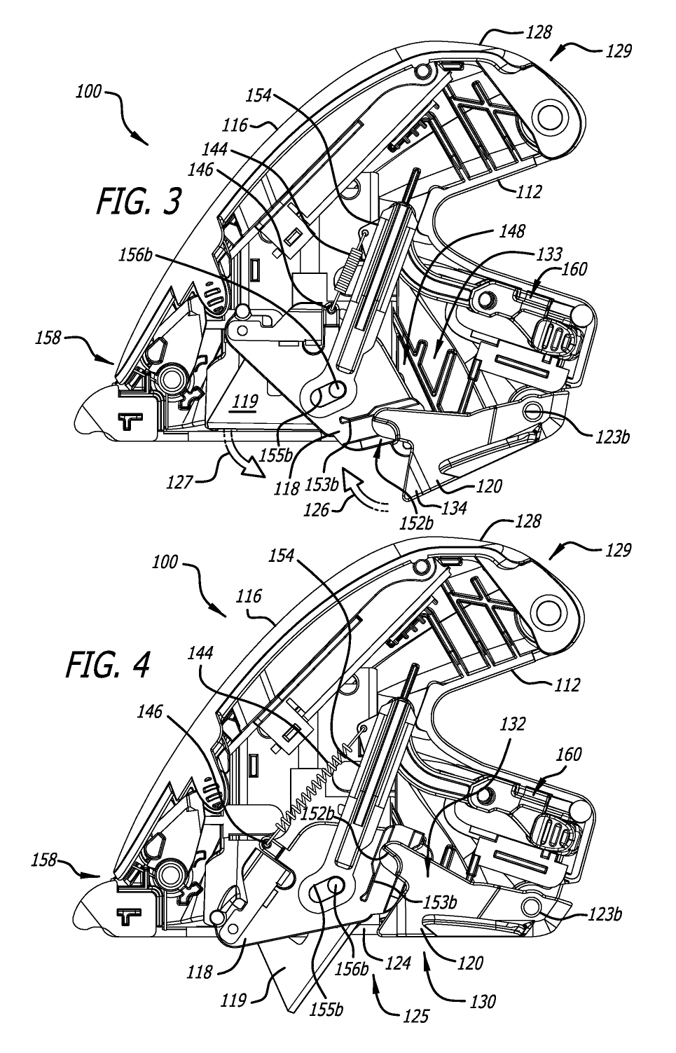

In this example embodiment, the cutter apparatus 100 includes an actuator 120 which is repositionable (e.g., in relation to the housing 110) for deploying the blade 119. The actuator 120 can be formed of various materials, for example, a zinc alloy (e.g., Zamak 2), and by various processes (e.g., die cast). In example embodiments, the actuator 120 is coupled to the housing 110. By way of example, a post 121 (e.g., a rivet) is fitted through apertures 122a and 122b (of the housing 110) and through apertures 123a and 123b (of the actuator 120) to pivotally couple the actuator 120 to the housing 110. In this example embodiment, the actuator 120 is repositionable in relation to the housing 110 and coupled to the blade carrier 118 such that movement of the actuator 120 (e.g., to an actuator blade deployment position) repositions the blade carrier 118. In example embodiments, the blade carrier 118 and the actuator 120 are configured such that repositioning the actuator 120 along a first path causes the blade carrier 118 to reposition along a second path. Referring to FIG. 3, in this example embodiment, an opening 124 is provided at a bottom portion 125 of the housing 110, and the blade carrier 118 and the actuator 120 are configured such that repositioning the actuator 120 upward toward the opening 124 (e.g., along a first arcuate path denoted by arrow 126) causes the blade carrier 118 to reposition downward toward the other side of the opening 124 (e.g., along a second arcuate path denoted by arrow 127). In example embodiments, the actuator 120 is located at the bottom portion 125 of the housing 110. An actuator (or actuators) for deploying the blade 119 can be provided in the form of various mechanisms and devices and at various locations including but are not limited to the bottom portion 125 of the housing 110. In example embodiments, the housing 110 includes a handle 128 (e.g., as shown) located at a top portion 129 of the housing 110. A handle for gripping the cutter apparatus 100 can be provided in the form of various structures and components and at various locations including but are not limited to the top portion 129 of the housing 110.

Referring to FIGS. 3 and 4, in this example embodiment, a portion 130 of the actuator 120 is substantially flush with the bottom portion 125 of the housing 110 when the actuator 120 is moved to its blade deployment position (FIG. 4). Also, in this example embodiment, a portion 132 of the actuator 120 is positioned within an interior portion 133 of the housing 110 when the actuator 120 is moved to its blade deployment position.

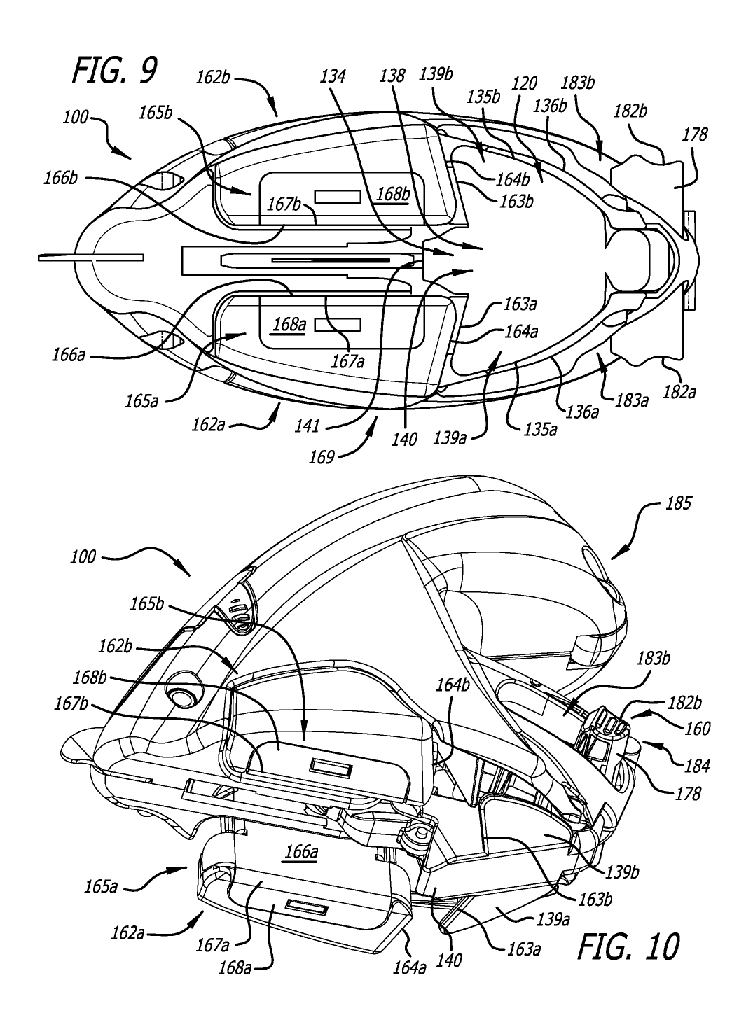

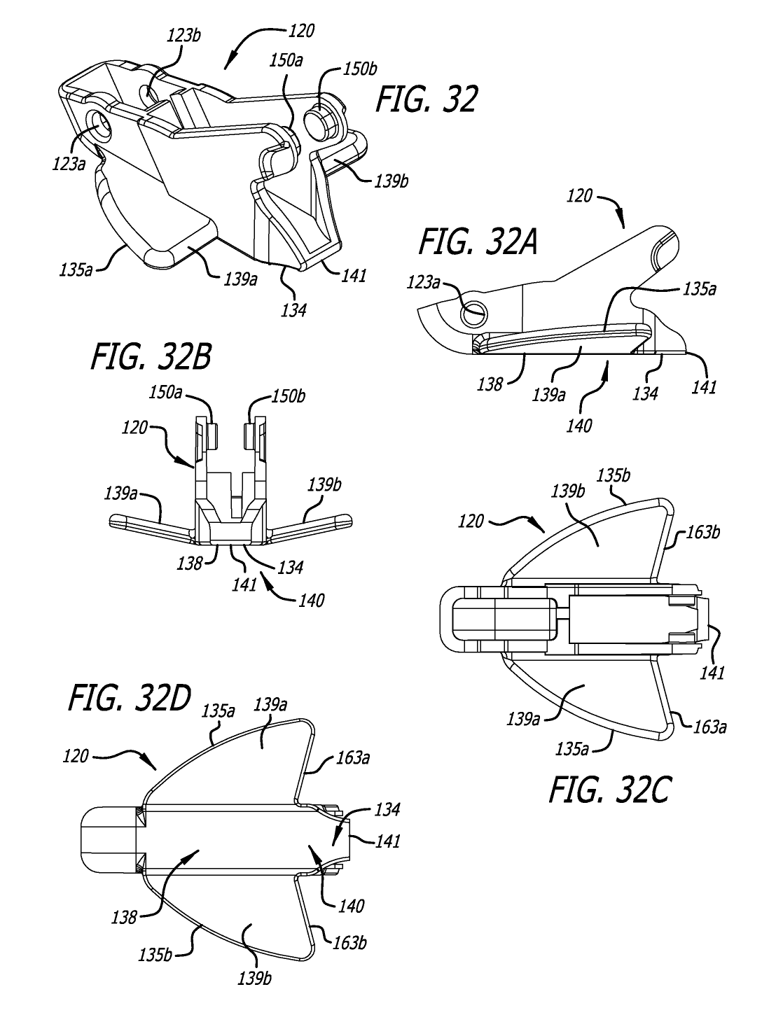

Referring additionally to FIGS. 9, 32, 32A, 32B, 32C, and 32D, in this example embodiment, the actuator 120 includes a flapper 134 with surfaces 135a, 135b that are complementary in shape to portions 136a, 136b, respectively, of the housing 110. The actuator 120 can include portions interfacing with and/or adjacent to various components of the cutter apparatus 100. In this example embodiment, the actuator 120 includes a central portion 138 and side portions 139a and 139b that laterally extend from the central portion 138. The actuator 120 can include one or more contact portions. In this example embodiment, the actuator 120 includes a contact portion 140 that is repositionable toward the housing 110 when the flapper 134 is brought into contact with a workpiece. In this example embodiment, the contact portion 140 includes an edge portion 141 that is repositioned adjacent to the opening 124 in the housing 110 when the actuator 120 is moved to its blade deployment position.

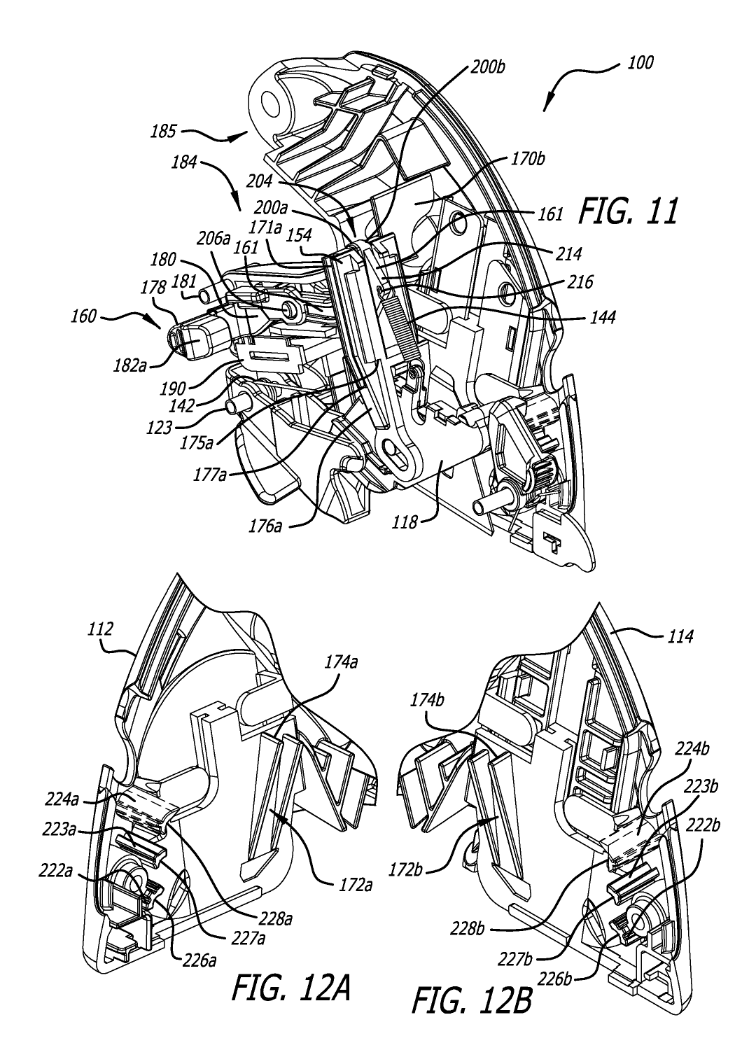

The cutter apparatus 100 can be provided with biasing mechanisms or devices, such as a spring 142 (see also, FIG. 11) configured to urge the actuator 120 to move away from its blade deployment position and (as shown in FIGS. 3 and 4) a spring 144 configured to urge a portion 146 of the blade carrier 118 away from the opening 124.

The blade carrier 118 and the actuator 120 can be configured to simultaneously reposition. Referring again to FIGS. 3 and 4, in this example embodiment, the housing 110 includes a channel 148 and the blade carrier 118 and the actuator 120 are configured to simultaneously reposition within the channel 148 as the actuator 120 moves in relation to the housing 110. In example embodiments, the blade carrier 118 and the actuator 120 simultaneously reposition, with the actuator 120 repositioning from one of multiple (e.g., user selectable) initial positions that provide different amounts of blade depth when the blade carrier 118 is deployed.

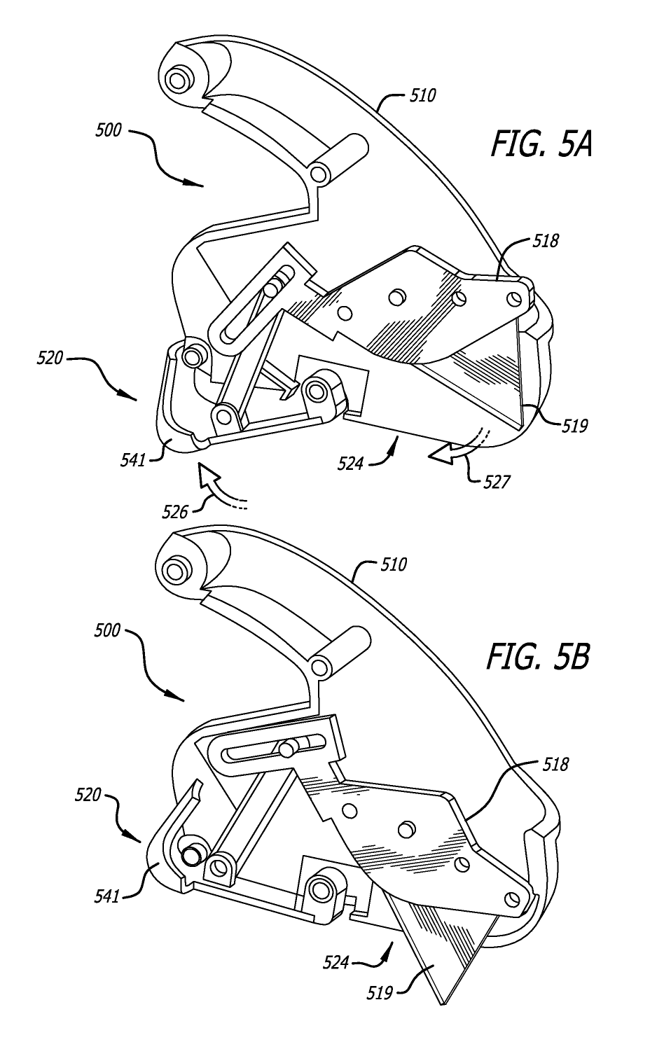

Example embodiments of cutters (or cutter apparatuses) can include other blade deployment mechanisms or devices. By way of example, and referring to FIGS. 5A and 5B, a cutter apparatus 500 (e.g., substantially similar to the cutter apparatus 100, except as described differently herein) includes a housing 510 and a blade holder (or blade carrier) 518 that holds a blade 519. In this example embodiment, the cutter apparatus 500 includes an actuator 520 (e.g., configured as a “reversed flapper” including a contact portion), which is pivotally coupled to the housing 510 adjacent to an opening 524. In example embodiments, the blade carrier 518 and the actuator 520 are configured such that repositioning the actuator 520 upward toward the opening 524 (e.g., along a first arcuate path denoted by arrow 526) causes the blade carrier 518 to reposition downward toward the other side of the opening 524 (e.g., along a second arcuate path denoted by arrow 527). In this example embodiment, the actuator 520 includes an edge portion 541 (e.g., that faces away from the opening 524) and is configured such that the edge portion 541 is repositionable in relation to the housing 510.

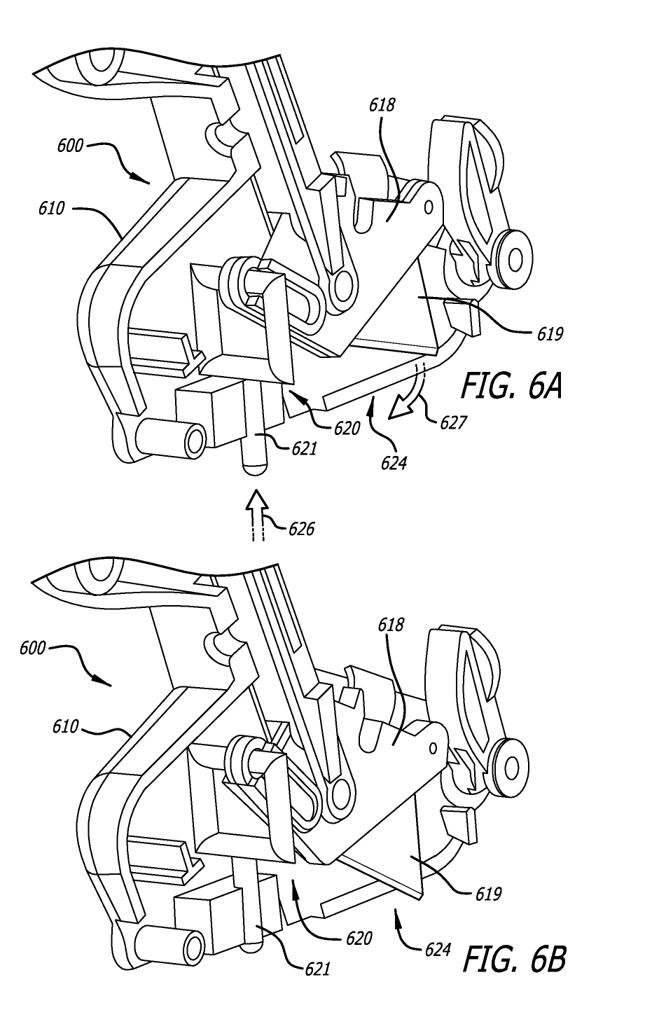

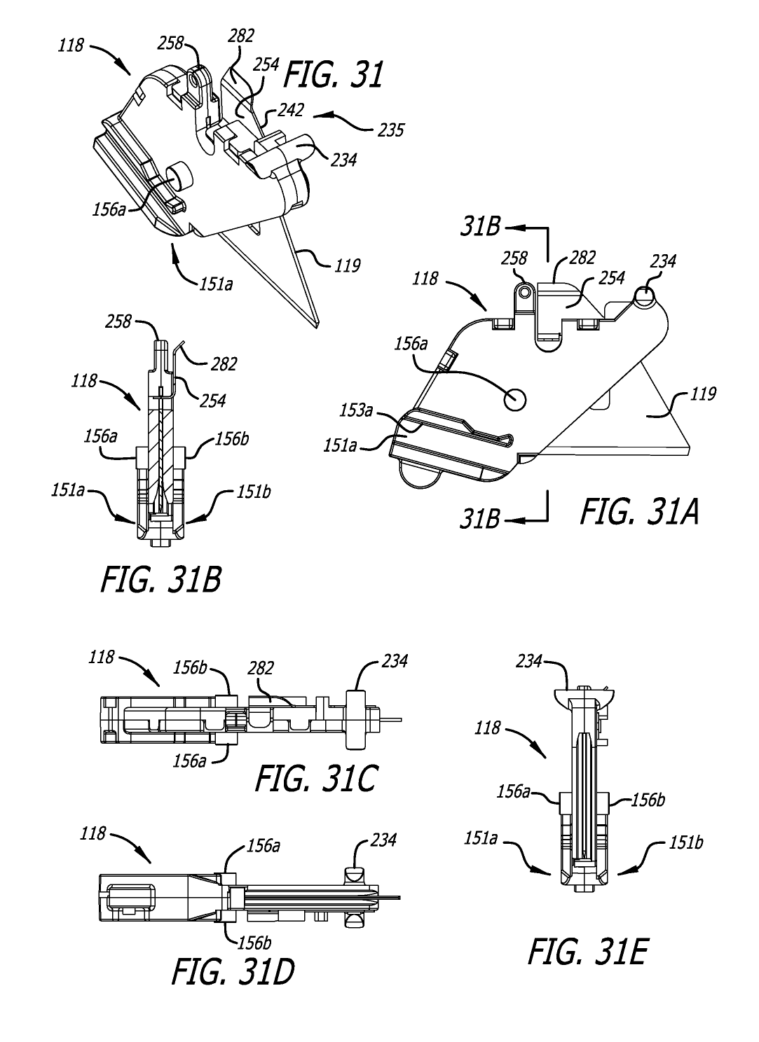

Referring to FIGS. 6A and 6B, in another example of an alternative blade deployment mechanism or device, a cutter apparatus 600 (e.g., substantially similar to the cutter apparatus 100, except as described differently herein) includes a housing 610 and a blade holder (or blade carrier) 618 that holds a blade 619. In this example embodiment, the cutter apparatus 600 includes an actuator 620 (e.g., with a push post 621 configured as shown), which is slidably coupled to the housing 610 adjacent to an opening 624. In example embodiments, the blade carrier 618 and the actuator 620 are configured such that repositioning the actuator 620 upward toward the opening 624 (e.g., along a linear path denoted by arrow 626) causes the blade carrier 618 to reposition downward toward the other side of the opening 624 (e.g., along an arcuate path denoted by arrow 627). In this example embodiment, the housing 610 and the push post 621 are configured such that the push post 621 is repositionable along a linear path in relation to the housing 610. Referring again to FIGS. 3 and 4, in this example embodiment, the actuator 120 is repositionable in relation to the housing 110 and coupled to the blade carrier 118 such that movement of the actuator 120 to an actuator blade deployment position (FIG. 4) repositions the blade carrier 118 toward the opening 124 via one or more coupling (and/or engagement) elements that provides mechanical advantage in deploying the blade 119 and maintaining the blade 119 in a deployed position. In example embodiments, one or more coupling (and/or engagement) elements provide mechanical advantage in deploying the blade 119 and/or maintaining the blade 119 in a deployed position. Gears, levers or other devices can be utilized to create or provide mechanical advantage. In example embodiments, the actuator 120 includes one or more bearing surfaces, e.g., bearings 150a and 150b (FIGS. 32 and 32B), and the blade carrier 118 includes one or more channels, e.g., channels 151a and 151b (FIGS. 31, 31A, 31B, and 31E), along which the one or more bearings slide as the actuator 120 is repositioned in relation to the housing 110. In example embodiments, the one or more channels are linear (or include linear portions). The one or more channels can also include or be provided with portions that are non-linear (e.g., curved). In example embodiments, the blade carrier 118 and the actuator 120 are coupled and/or configured such that one or more portions of the actuator 120 bear against one or more surfaces of the blade carrier 118 at an angle of incidence that increases as the actuator 120 is moved toward its blade deployment position. Referring to FIGS. 3 and 4, in this example embodiment, the blade carrier 118 and the actuator 120 are mechanically coupled such that portions 152a and 152b (of the actuator 120) bear against surfaces 153a and 153b (of the blade carrier 118), respectively. The portions 152a and 152b of the actuator 120 include, for example, contact surfaces of the bearings 150a and 150b, respectively. The surfaces 153a and 153b of the blade carrier 118 include, for example, side walls of the channels 151a and 151b, respectively. In example embodiments, the blade carrier 118 and the actuator 120 are one or more of directly coupled (e.g., in direct contact with each other as the actuator 120 is moved toward its blade deployment position), indirectly coupled (e.g., coupled together by one or more intermediary coupling elements or components), continuously coupled (e.g., at least one portion of the actuator 120 repositioning in relation to a continuous portion of the blade carrier 118 as the actuator 120 is moved toward its blade deployment position), and intermittently coupled (e.g., the actuator 120 contacting or engaging different portions of the blade carrier 118 at different times and/or without continuous coupling or surface contact as the actuator 120 repositions in relation to the housing 110).

In operation, the blade 119 is deployed (or activated) for example by pressing the flapper 134 against a box (or other object that is to be cut). The sliding linkage between the flapper 134 and the blade carrier 118 causes mechanical advantage to be increased as the flapper 134 is depressed, allowing a small amount of force on the flapper 134 to oppose (or overcome) a relatively large amount of force which is imparted upon the blade 119 as the blade 119 makes contact with and is pushed into the object being cut.

Thus, in an example embodiment, a cutter apparatus includes a housing with an opening, a blade carrier coupled to the housing and repositionable in relation to the housing, and an actuator (e.g., including a flapper) repositionable in relation to the housing and coupled to the blade carrier such that movement of the actuator to an actuator blade deployment position repositions the blade carrier toward the opening and provides mechanical advantage in deploying the blade or maintaining the blade in a deployed position.

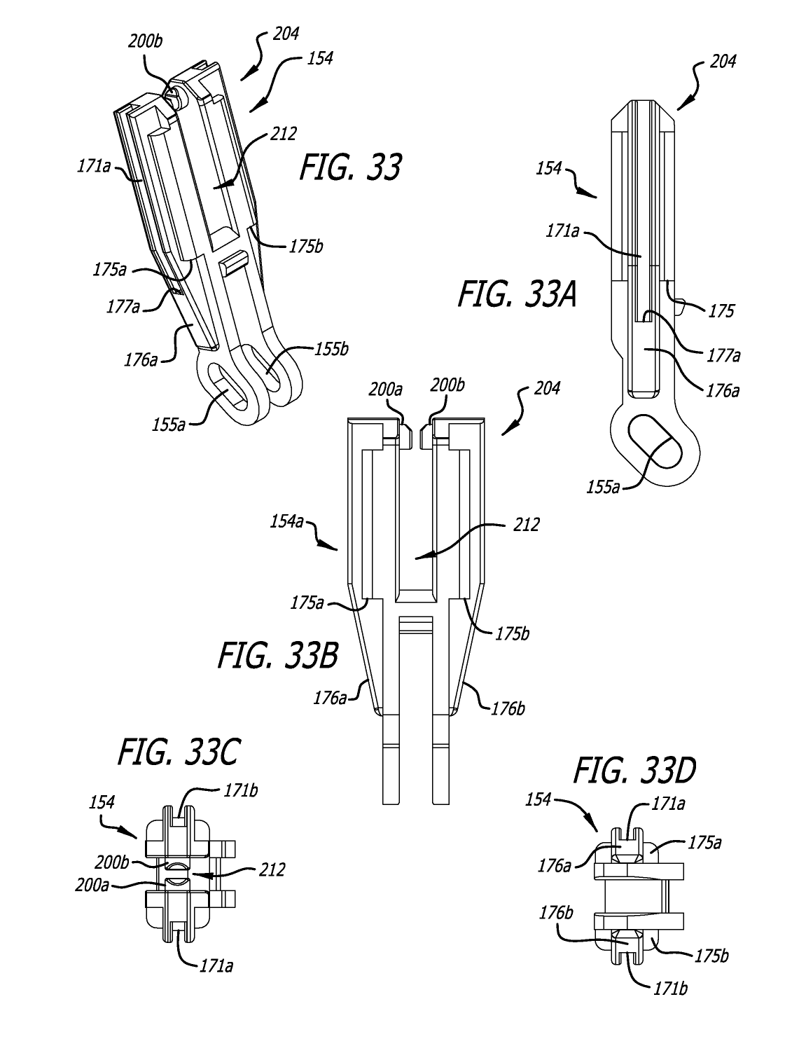

In this example embodiment, the cutter apparatus 100 includes a linkage member 154 which is repositionable (e.g., in relation to the housing 110). The linkage member 154 (e.g., a push rod) can be formed of various materials, for example, a thermoplastic that has high stiffness, creep resistance, low warpage, and high dimensional stability (e.g., Polyoxymethylene (POM), Glass Filled), and by various processes (e.g., injection molding). In example embodiments, the linkage member 154 is mechanically coupled to the blade carrier 118. Referring to FIGS. 3 and 4, in this example embodiment, the linkage member 154 includes portions 155a and 155b (FIG. 33) which are configured to receive portions 156a and 156b (FIGS. 31, 31A, 31B, 31C, 31D, 31E), respectively, of the blade carrier 118. The portions 155a and 155b of the linkage member 154 are provided, for example, as channels formed in a lower portion of the linkage member 155 (e.g., the channels including side walls and semi-circular end portions as shown). The portions 156a and 156b of the blade carrier 118 are provided, for example, as laterally extending protrusions located at opposing sides of the blade carrier 118 (e.g., the protrusions include peripheral contact surfaces as shown) that are fitted within the channel portions 155a and 155b (of the linkage member 154), respectively. In example embodiments, the portions 155a and 155b (of the linkage member 154) and the portions 156a and 156b (of the blade carrier 118) are configured such that portions of the blade carrier 118 pivotally reposition in relation to the linkage member 154 as the actuator 120 is moved toward its blade deployment position. Thus, in example embodiments, the linkage member 154 includes one or more portions configured to receive one or more complementary portions of the blade carrier 118 about which adjacent portions of the blade carrier 118 pivot as the actuator 120 is moved toward its blade deployment position. In example embodiments, the blade carrier 118 and the linkage member 154 are one or more of directly coupled (e.g., in direct contact with each other as the actuator 120 is moved toward its blade deployment position), indirectly coupled (e.g., coupled together by one or more intermediary coupling elements or components), continuously coupled (e.g., at least one portion of the blade carrier 118 repositioning in relation to a continuous portion of the linkage member 154 as the actuator 120 is moved toward its blade deployment position), and intermittently coupled (e.g., the blade carrier 118 contacting or engaging different portions of the linkage member 154 at different times and/or without continuous coupling or surface contact as the actuator 120 repositions in relation to the housing 110).

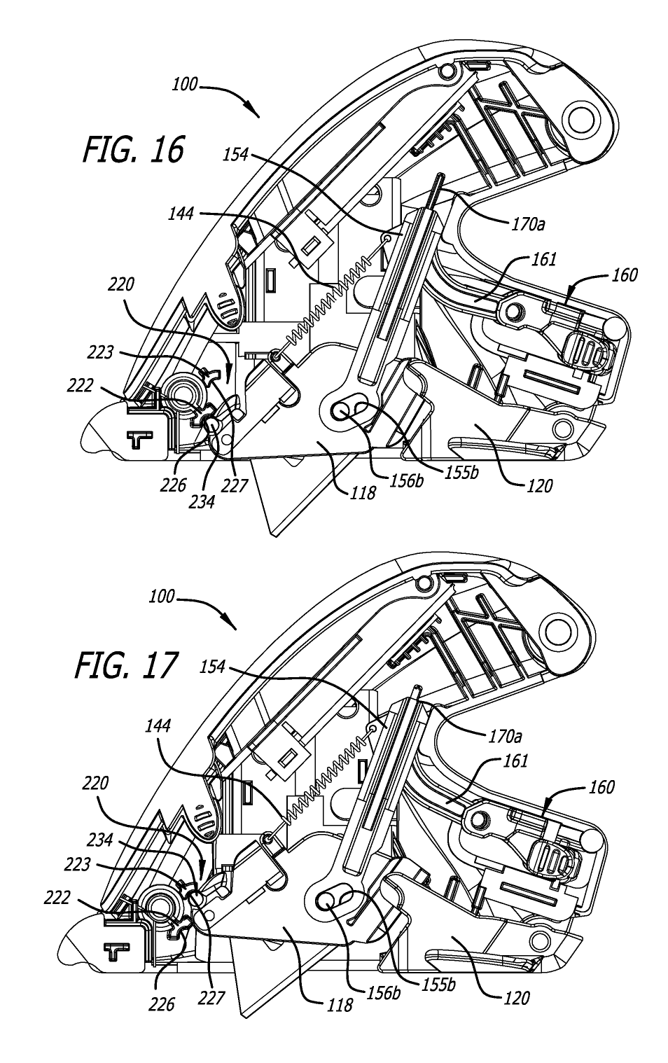

In example embodiments, one or more portions of the linkage member 154 (e.g., the channel portions 155a and 155b) are shaped to permit movement of the blade carrier 118 (from its deployed position as shown in FIG. 4) toward a distal end 158 of the cutter (as shown in FIG. 16), e.g., in response to a cutting edge of the blade 119 coming into contact with a workpiece. In example embodiments, the linkage member 154 is repositionable within the housing 110 for changing a blade depth that the blade is extended from the housing 110 when the actuator 120 is moved to its blade deployment position. Referring to FIGS. 16 and 17, in this example embodiment, the cutter apparatus 100 includes a blade depth selector (or switch) 160 and a blade depth linkage member 161 which mechanically couples the blade depth selector 160 to the linkage member 154 as shown. The blade depth selector 160 is repositionable (e.g., in relation to the housing 110) and configured to allow a user of the cutter apparatus 100 to select the blade depth by repositioning the linkage member 154. In example embodiments, the blade depth linkage member 161 provides one or more mechanical couplings and/or engagement elements or interfaces between the blade depth selector 160 and the linkage member 154. In example embodiments, the blade depth linkage member 161 pivotally couples the blade depth selector 160 to the linkage member 154. The blade depth selector 160 and the blade depth linkage member 161 can be formed of various materials, for example, a thermoplastic that has high stiffness, creep resistance, low warpage, and high dimensional stability (e.g., Polyoxymethylene (POM)), and by various processes (e.g., injection molding). In example embodiments, the blade depth linkage member 161 is mechanically coupled to at least one of the linkage member 154 and the blade depth selector 160. In example embodiments, one or more springs or biasing elements are operatively connected between (or operatively connect or engage) the blade depth selector 160 and the blade carrier 118. For example, a spring is connected between the blade depth linkage member 161 (which is coupled to the blade depth selector 160) and the blade carrier 118. In this example embodiment, the blade depth linkage member 161 and the blade carrier 118 are directly connected by the spring 144.

Example cutter apparatuses described herein can include one or more cut guards. Referring additionally to FIGS. 9 and 10, in this example embodiment, the cutter apparatus 100 includes a pair of cut guards 162a and 162b coupled to the housing 110 at opposite sides of the opening 124, the cut guards 162a and 162b being repositionable in relation to the housing 110 and independently extendable therefrom. The cut guards 162a and 162b can be formed of various materials, for example, a thermoplastic that has high strength, rigidity, and impact resistance (e.g., Acrylonitrile butadiene styrene (ABS)), and by various processes (e.g., injection molding).

In example embodiments, one or more components of the cutter apparatus 100 include surfaces (e.g., edges) that are complementary in shape to portions (e.g., edges and/or sides) of the cut guards 162a and 162b. In this example embodiment, surfaces 163a and 163b of the flapper 134 are complementary in shape (e.g., as shown) to portions 164a and 164b of the cut guards 162a and 162b, respectively.

In example embodiments, one or more components of the cutter apparatus 100 reposition between the cut guards 162a and 162b when the actuator 120 is moved to its blade deployment position. By way of example, one or more portions of the blade carrier 118 and/or the actuator 120 reposition between the cut guards 162a and 162b when the actuator 120 is repositioned toward the housing 110. In this example embodiment, the actuator 120 and the cut guards 162a and 162b are configured (e.g., as shown) such that the distal edge 141 (FIG. 9) of the central portion 138 (of the flapper 134) repositions toward the housing 110 and between the cut guards 162a and 162b when the actuator 120 is moved to its blade deployment position.

### Blade Depth Adjustment

In example embodiments described herein, a cutter (or cutter apparatus) includes a mechanism or device that facilitates a blade depth adjustment for the cutter. To this end, in example embodiments, a cutter includes a depth selector element or device and one or more linkage members configured to effect a repositioning of a blade carrier and/or a blade of the cutter in response to a repositioning of the depth selector (e.g., in relation to a portion of the cutter). In example embodiments, a mechanism or device that facilitates a blade depth adjustment includes a linkage member (e.g., the linkage member 154) that is mechanically coupled to the blade carrier 118 (e.g., as previously discussed). In example embodiments, a mechanism or device that facilitates a blade depth adjustment includes a linkage member (e.g., the blade depth linkage member 161) that is mechanically coupled to the depth selector element or device. In example embodiments, a mechanism or device that facilitates a blade depth adjustment includes a depth selector element or device (e.g., the blade depth selector 160) that is configured such that activation of the blade depth selector (e.g., repositioning the blade depth selector 160 in relation to the housing 110 and/or another component of the cutter apparatus 100) effects a blade depth adjustment via a resulting movement of the blade carrier 118 (e.g., a repositioning of the blade carrier 118 in relation to the housing 110 and/or another component of the cutter apparatus 100).

Referring also to FIGS. 7 and 11, in this example embodiment, the linkage member (or push rod) 154 is slidably supported at opposing sides thereof by a pair of ridges 170a (FIGS. 7) and 170b (FIG. 11) within the housing 110. In this example embodiment, the push rod 154 includes a complimentary pair of channels 171a and 171b (e.g., located at opposing upper side portions of the push rod 154 as shown that receive the ridges 170a and 170b, respectively. See also FIGS. 33, 33A, 33B, 33C, and 33D. Referring to FIGS. 12A and 12B, in this example embodiment, the push rod 154 is also slidably supported at opposing sides thereof by a pair of channels 172a and 172b within the housing. In this example embodiment, the push rod 154 also includes ridge portion 176a and 176b (e.g., located at opposing lower side portions of the push rod 154 and formed with beveled or angled side surfaces as shown) that are slidably coupled to the channels 172a and 172b, respectively.

In this example embodiment, the channels 172a and 172b (of the housing 110) include stop surfaces 174a and 174b, respectively, and the push rod 154 includes surfaces 175a and 175b, which limit the extent to which the push rod 154 is downwardly repositionable (i.e., toward the opening 124) when movement of the push rod 154 brings its surfaces 175a and 175b into contact with the stop surfaces 174a and 174b (of the housing 110), respectively. In this example embodiment, the ridge portions 176a and 176b (of the push rod 154) also define at least a portion of the channels 171a and 171b, respectively. In this example embodiment, the ridge portions 176a and 176b (of the push rod 154) also define upward facing surfaces 177a and 177b, respectively, which serve to limit upward movement of the push rod 154 when the surfaces 177a and 177b are brought into contact with the bottom edges of the ridges 170a and 170b, respectively.

Thus, in example embodiments, a cutter apparatus (or other hand tool) with a housing includes or is provided with a linkage member (e.g., an internal linkage member such a push rod) that is slidably supported at opposing sides thereof by a pair of ridges within the housing and/or by a pair of channels within the housing.

Further with regard to a mechanism or device that facilitates a blade depth adjustment, in example embodiments, a cutter includes a linkage member and a blade depth selector coupled to the linkage member such that a user of the cutter can set a location of the linkage member to provide a desired blade depth by selectively repositioning the blade depth selector in relation to the housing.

Thus, in an example embodiment, a cutter apparatus includes a housing with an opening, a blade carrier coupled to and repositionable in relation to the housing, an actuator for repositioning the blade carrier to a deployed position, the blade carrier repositioning toward the deployed position in response to movement of the actuator toward an actuator blade deployment position (e.g., a depressed position), a push rod that is repositionable within the housing and coupled to the blade carrier such that a location of one or more portions of the push rod in relation to the housing (e.g., a distance between one or more portions of the push rod and the opening 124 of the housing 110) determines the blade depth (i.e., the portion or amount of the blade 119 extending from the opening 124) when the blade carrier is deployed, and a blade depth selector coupled to the push rod such that a user of the cutter apparatus can set the location to provide a desired blade depth by selectively repositioning the blade depth selector in relation to the housing.

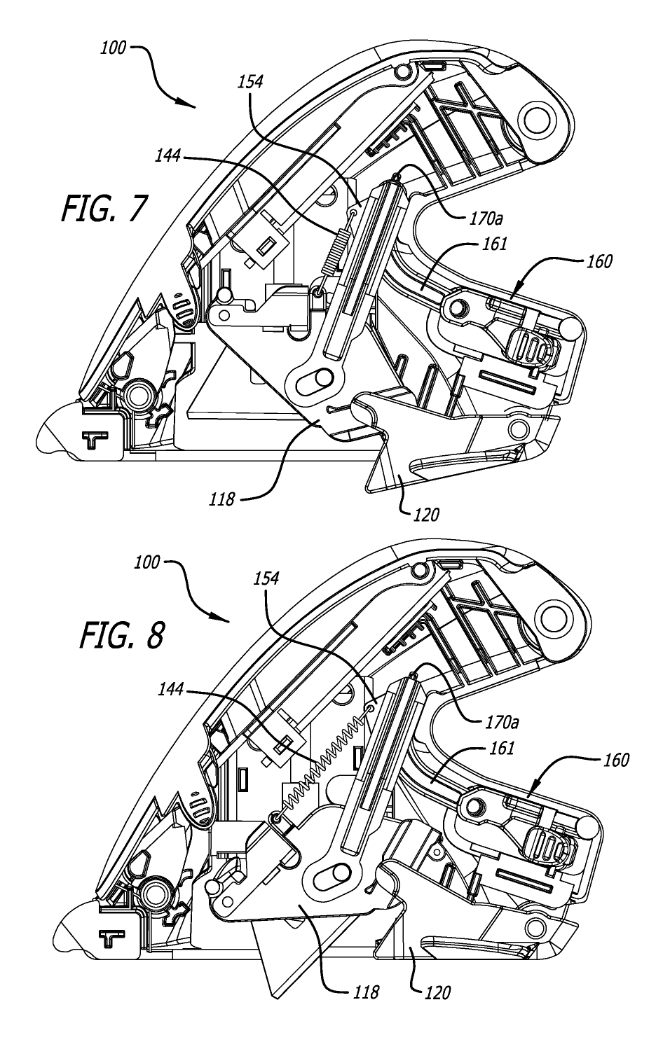

In example embodiments described herein, a cutter (or cutter apparatus) includes a blade carrier that is repositionable (e.g., in relation to a portion of the cutter) with multiple degrees of freedom of operational movement (e.g., translational movement and rotational movement). By way of example, a comparison of FIGS. 3 and 7 illustrates translational movement of the blade carrier 118 along a first axis parallel to the channels 171a and 171b of the push rod 154. Further as to translational movement of the blade carrier 118, a comparison of FIGS. 4 and 16 (or of FIGS. 8 and 17) illustrates translational movement of the blade carrier 118 along a second axis parallel to the portions 155a and 155b of the push rod 154. As to rotational movement of the blade carrier 118, a comparison of FIGS. 3 and 4 illustrates rotational movement of the blade carrier 118 about an axis defined by the portions 155a and 155b of the push rod 154. Accordingly, in this example embodiment, the blade carrier 118 is repositionable (e.g., in relation to the housing 110) with multiple degrees of freedom of operational movement that include translational movement along two different axes associated with movement of the blade carrier 118 in relation to the push rod and rotational movement about an axis defined by one or more portions of the push rod 154 that receive complementary portions of the blade carrier 118 and about which the blade carrier 118 pivots as the actuator 120 is moved toward its blade deployment position.

In example embodiments, a cutter (or other hand tool) includes an actuator coupled to a blade depth selector such that movement of the blade depth selector to a different blade depth selection position causes at least a portion of the actuator to reposition in relation to the housing. Referring to FIGS. 3 and 7, in this example embodiment, the actuator 120 is coupled to the blade depth selector 160 such that movement of the blade depth selector 160 to a different blade depth selection position causes at least a portion of the actuator 120 to reposition in relation to the housing 110 thereby providing a visual indication of the blade depth selected.

In example cutters (or cutter apparatuses), the blade depth selector includes or is provided with linkage facilitating ambidextrous operation. Referring to FIGS. 11, 13A-13E, 34, 34A, 34B, 34C, 34D, in this example embodiment, the blade depth selector 160 includes an engagement portion 178 and linkage 180 (e.g., provided as shown in the form of pivoting linkage) that allows the engagement portion 178 to reposition (e.g., pivot laterally) in relation to the housing 110. In this example embodiment, an additional post 181 (e.g., a rivet) secures the left and right side portions of the housing together behind the engagement portion 178 as shown. In this example embodiment, the engagement portion 178 includes opposing engagement elements 182a and 182b that extend from openings 183a and 183b, respectively, on opposite sides of the housing 110 to allow ambidextrous operation of the blade depth selector 160.

In example cutters (or cutter apparatuses) that include a housing, the blade depth selector (e.g., a switch) is repositionable along a blade depth selector path (e.g., within or partially within the housing) and includes an engagement portion with opposing engagement elements (e.g., a pair of buttons) that extend respectively from a pair of openings on opposite sides of the housing. In this example embodiment, the engagement elements 182a and 182b are provided as opposing engagement elements that are fixed in position in relation to each other.

In example cutters (or cutter apparatuses) that include a housing and a blade depth selector with one or more engagement elements, the housing includes (or is provided with) one or more openings from which the one or more engagement elements extend, the one or more openings being located (or provided) at a portion of the housing which is separate from another portion of the housing. Referring to FIG. 10, in this example embodiment, the openings 183a and 183b are located (or provided) at a rear bottom portion 184 of the housing 110 which is separate from an upper portion 185 of the housing 110, the upper portion 185 being shaped for gripping by a hand.

In example cutters (or cutter apparatuses) that include a housing and a blade depth selector with one or more engagement portions or elements, the housing includes (or is provided with) blade depth indicator markings or other indicia. In this example embodiment, and referring to FIG. 1, the housing 110 includes blade depth indicator markings 186 (e.g., a progression of markings of different heights/depths as shown) adjacent to each of the openings 183a and 183b. The blade depth indicator markings 186 provide visual representations of blade depths that are selectable by repositioning the engagement elements 182a and 182b within and along the openings 183a and 183b, respectively. The visual representations correspond (e.g., in their progression and/or positioning) to a sequence of blade depth selection positions that the engagement elements 182a and 182b can be moved to, and locked or set at as described herein. Accordingly, example embodiments of cutters (or cutter apparatuses) described herein are configured to provide multiple visual representations and/or indications of selectable blade depths, the visual representations and/or indications being located or provided, for example, at opposite sides as well as at the bottom of the cutter housing and/or being presented via changes in positions of a blade depth selector and/or a blade deployment actuator of the cutter.

Example cutters (or cutter apparatuses) include a blade depth selector which serves as a mechanism or device for locking or setting a selected blade depth via a mechanical engagement of or contact with the blade depth selector (or a portion or a component thereof) that prevents the blade depth selector (or a portion or a component thereof) from repositioning along a blade depth selector path of or associated with the cutter (e.g., within or partially within the cutter housing).

In example embodiments, the blade depth selector 160 serves as a mechanism or device for locking or setting at least a portion of the blade depth selector 160 at a location or position at which the blade depth selector 160 is prevented from repositioning along a blade depth selector path (e.g., within the housing 110). In example embodiments, the blade depth selector 160 serves as a mechanism or device for selectively locking or setting at least a portion of the blade depth selector 160 at one of multiple locations or positions at which the blade depth selector 160 is prevented from repositioning along a blade depth selector path (e.g., within the housing 110).

In example embodiments, the blade depth selector 160 serves as a mechanism or device for locking or setting at least a portion of the blade depth selector 160 at a location or position associated with a selected blade depth or a safe position (or configuration) at which the blade carrier (and/or the blade) is prevented from being deployed.

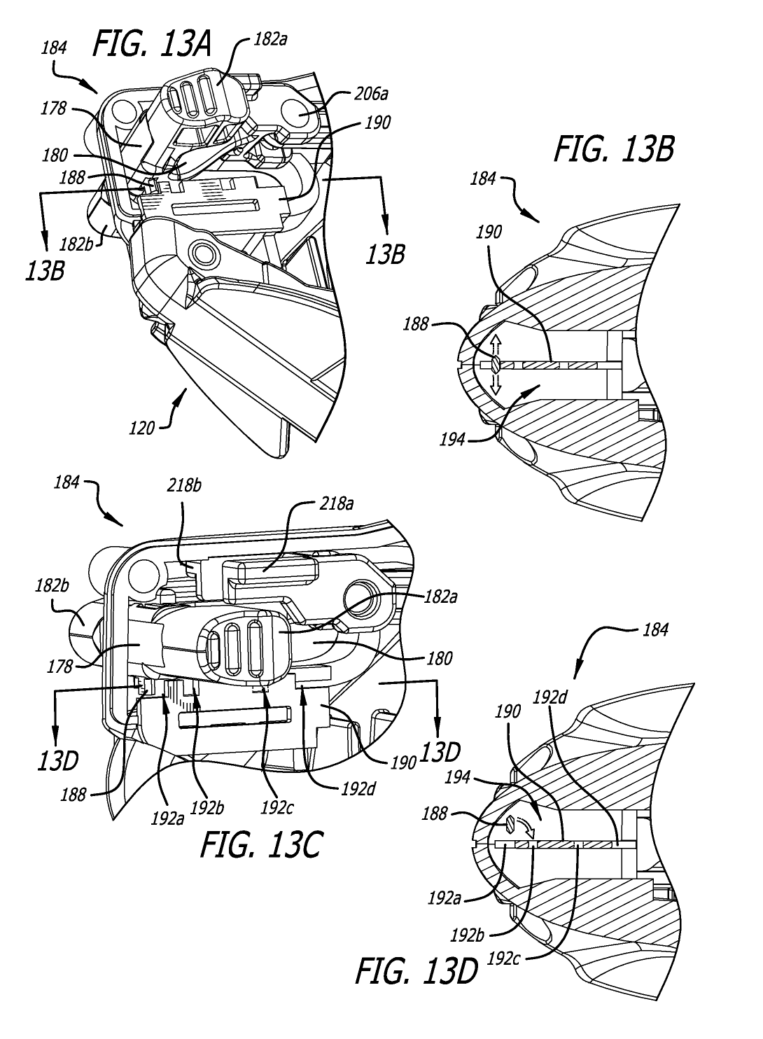

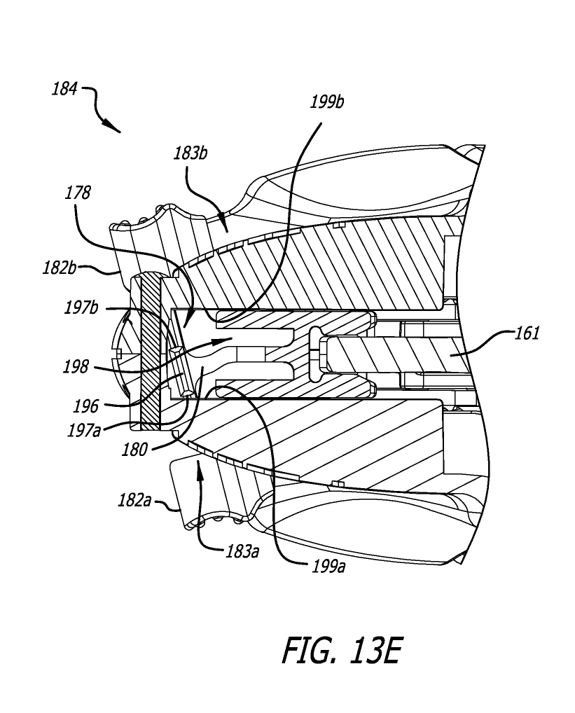

Referring to FIGS. 13A-13E, in this example embodiment, the blade depth selector 160 includes a blade depth stop tab 188 which is sized and configured for engaging one or more stop surfaces within (or portions of) the housing 110. The blade depth stop tab 188 can be formed of various materials, for example, a material made of or including a metal (or a metal alloy or a plastic) that has high strength and wear resistance (e.g., stainless steel), and by various processes (e.g., stamped). In example embodiments, the blade depth stop tab 188 is secured to (e.g., interconnected or engaged by complementary surfaces of) the blade depth selector 160.

The one or more stop surfaces (or portions) can be provided by one or more components or portions of the cutter. The one or more stop surfaces (or portions) can be provided, for example, in the form of notches or steps, as well as by other surfaces or structures. In this example embodiment, the one or more stop surfaces (or portions) are provided by a blade depth stop plate 190 which is sized and configured for receiving and engaging the blade depth stop tab 188. The blade depth stop plate 190 can be formed of various materials, for example, a material made of or including a metal (or a metal alloy or a plastic) that has high strength and wear resistance (e.g., stainless steel), and by various processes (e.g., stamped). In example embodiments, the blade depth stop plate 190 is secured to (e.g., interconnected or engaged by complementary surfaces of) the housing 110. For example, the blade depth stop plate 190 can be secured to the housing 110 between opposing surfaces or portions of the right side portion 112 and the left side portion 114 (of the housing 110), respectively. In this example embodiment, the blade depth stop plate 190 includes notches (or stops) 192a and 192b, and optionally, a notch (or a stop) 192c (shown in dashed lines), which are complementary in shape to the blade depth stop tab 188. The blade depth stop plate 190 additionally includes a notch (or a stop) 192d, which is sized and configured for receiving and engaging the blade depth stop tab 188 to provide a safe position (or configuration). For example, when moved to its safe position, the blade depth selector 160 (e.g., via the linkage members 154 and 161) forces the actuator 120 to, and locks or sets the actuator 120 at, a location or position (e.g., flush with and/or against the underside of the housing 110), thereby preventing the actuator 120 from extending the blade 119 from the housing 110. Thus, in an example embodiment, movement of the blade depth selector 160 to its safe position causes the actuator 120 to move to a location or position at which all or substantially all of the “throw” (potential for extending the blade 119) is eliminated. The notches (or stops) 192a, 192b, 192c, and 192d can be configured to provide four blade depth settings, for example, 15 mm, 9 mm, 4 mm, and 0 mm (safe), respectively.

In example embodiments, a cutter (or cutter apparatus) includes or is provided with two or more stop surfaces (or portions) configured to provide a mechanical interface with at least a portion of a blade depth selector (or switch). In example embodiments, the stop surfaces (or portions) are associated (e.g., mutually exclusively) with different blade depth positions that are selectable by the blade depth selector 160. In example embodiments, the stop surfaces are associated with at least one blade depth position of and/or selectable by the blade depth selector 160 (e.g., a fully-extended/maximum blade depth position or a partially-extended/reduced blade depth position) and with at least one safe position of and/or selectable by the blade depth selector 160 (e.g., a safe position at which the actuator 120 cannot be used to extend the blade 119 from the housing 110). The stop surfaces can be eliminated if, for example, the one or more coupling (and/or engagement) elements that provide mechanical advantage are configured to provide additional reaction force to hold the blade in the extended position.

In example cutters (or cutter apparatuses) that include a housing and a blade depth selector with one or more engagement portions or elements, the housing includes (or is provided with) a safe position indicator marking or other indicia. In this example embodiment, and referring again to FIG. 1, the housing 110 includes safe position indicator markings 193 (e.g., an oval-shaped marking as shown) adjacent to each of the openings 183a and 183b. The safe position indicator markings 193 provide visual representations of a safe position that is selectable by repositioning the engagement elements 182a and 182b to the forward most positions within the openings 183a and 183b, respectively. The visual representations symbolize and indicate (e.g., by their locations in relation to the openings 183a and 183b) a selectable safe position of the engagement elements 182a and 182b (i.e., at the forward most positions within the openings 183a and 183b, respectively) at which the actuator 120 cannot be used to extend the blade 119 from the housing 110. Accordingly, example embodiments of cutters (or cutter apparatuses) described herein are configured to provide multiple visual representations and/or indications of a selectable safe position or configuration, the visual representations and/or indications being located or provided, for example, at opposite sides as well as at the bottom of the cutter housing and/or being presented via changes in positions of a blade depth selector and/or a blade deployment actuator of the cutter.

Referring again to FIGS. 13A-13E, in this example embodiment, the linkage 180 (of the blade depth selector 160) includes or is provided in the form of a flexible (central) portion that allows a user of the cutter apparatus 100 to disengage the blade depth stop tab 188 from an opposing stop surface (e.g., one of the notches 192a, 192b, 192c, and 192d of the blade depth stop plate 190) so that the blade depth selector 160 can be repositioned along a blade depth selector path (e.g., along the topside of the blade depth stop plate 190). In this example embodiment, the flexible (central) portion is configured to allow a portion of the blade depth selector to reposition (e.g., pivot) laterally, as shown in FIGS. 13B-13D, in relation to the blade depth selector path.

In this example embodiment, the cutter apparatus 100 includes a channel 194 (FIGS. 13B and 13D) within which the blade depth stop tab 188 travels as the engagement portion 178 is repositioned in relation to the openings 183a and 183b. The channel 194 is sized and/or otherwise configured to permit sufficient lateral repositioning of the engagement portion 178 to disengage the blade depth stop tab 188 from an opposing stop surface (e.g., one of the notches 192a, 192b, 192c, and 192d of the blade depth stop plate 190) while preventing excessive lateral movement of the engagement portion 178, which could result in the blade depth selector 160 breaking or bending. Referring to FIG. 13E, in this example embodiment, the blade depth selector 160 further includes a lateral movement stop tab 196 (e.g., provided as shown at a top portion of the engagement portion 178) with opposing side portions 197a and 197b. The housing 110 additionally includes a channel 198 (e.g., provided as shown on opposite sides of the lateral movement stop tab 196) that limits lateral movement of the engagement portion 178 by limiting how far the lateral movement stop tab 196 can pivot. In this example, the channel 198 includes surfaces 199a and 199b that serve as stops for the side portions 197a and 197b, respectively. When the blade depth selector 160 is positioned at the back of the channel 198 (e.g., with the blade depth stop tab 188 facing the notch 192a), as previously discussed, the upward facing surfaces 177a and 177b (of the push rod 154) serve to limit upward movement of the push rod 154 when the surfaces 177a and 177b are brought into contact with the bottom edges of the ridges 170a and 170b, respectively, to allow a gap (i.e., behind the engagement portion 178) for lateral movement of the blade depth selector 160.

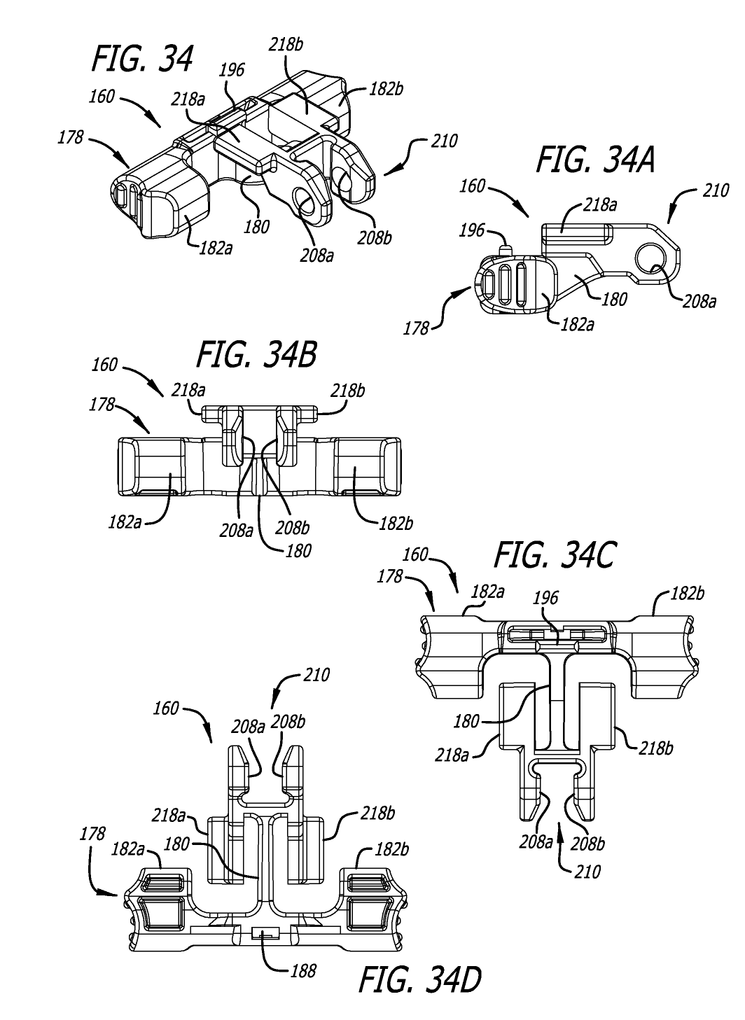

In this example embodiment, the push rod 154 includes bearings 200a and 200b (FIGS. 33, 33B, and 33C) that are received within channels 202a and 202b (FIG. 11), respectively, of the blade depth linkage member 161. The bearings 200a and 200b and channels 202a and 202b are configured such that the linkage member 161 is pivotally coupled to, for example, an upper portion 204 of the push rod 154 as shown. In this example embodiment, the linkage member 161, in turn, includes bearings 206a and 206b (e.g., at an opposite end of the linkage member 161 from the channels 202a and 202b) that are received within channels 208a and 208b (FIGS. 34, 34A, 34B, 34C, and 34D), respectively, of the blade depth selector 160. The bearings 206a and 206b and channels 208a and 208b are configured such that the linkage member 161 is pivotally coupled to, for example, a distal portion 210 of the blade depth selector 160 as shown. In this example embodiment, the push rod 154 includes a slot 212 (e.g., formed or provided as shown), and the linkage member 161 is sized and configured to fit within and to be pivotally repositionable in relation to the slot 212. The linkage member 161 includes a forward portion 214 that is provided, for example, with a structure 216 (e.g., including an aperture as shown) that is connected or coupled to one end of the spring 144. In this example embodiment, the blade depth selector 160 includes guide members 218a and 218b which are sized and configured to slidably couple the blade depth selector 160 to adjacent supporting structures and/or surfaces within the rear bottom portion 184 (of the housing 110). Thus, in this example embodiment, the linkage member 161 (e.g., curved as shown and rigid or substantially rigid in structure) drives the push rod 154 upward along the channels 172a and 172b (of the housing 110) in response to the blade depth selector 160 being repositioned forward along its blade depth selector path (i.e., toward the distal end 158 of the cutter apparatus 100).

In operation, the blade depth is set by the position of the blade depth selector (or switch) 160, which is repositioned by pushing the engagement portion 178 in from either side (allowing ambidextrous operation), then sliding the engagement portion 178 forward or back. The blade depth selector (or switch) 160 bends about the center “neck” (of the linkage 180), allowing the blade depth stop tab 188 to disengage from the blade depth stop plate 190. The lateral movement stop tab 196 on the top of the blade depth selector (or switch) 160 prevents the engagement portion 178 from being pushed over too far, which could result in the blade depth selector (or switch) 160 breaking or bending. The blade depth indicator markings 186 on the exterior of the body show the user at which depth the blade is set. When the blade depth selector (or switch) 160 is moved, it changes the height of the push rod 154 by way of the blade depth linkage member 161, which in turn determines the height of the blade carrier 118. The push rod 154 slides along the ridges 170a and 170b molded into the body halves 112 and 114, respectively, and within the channels 172a and 172b (of the housing 110)

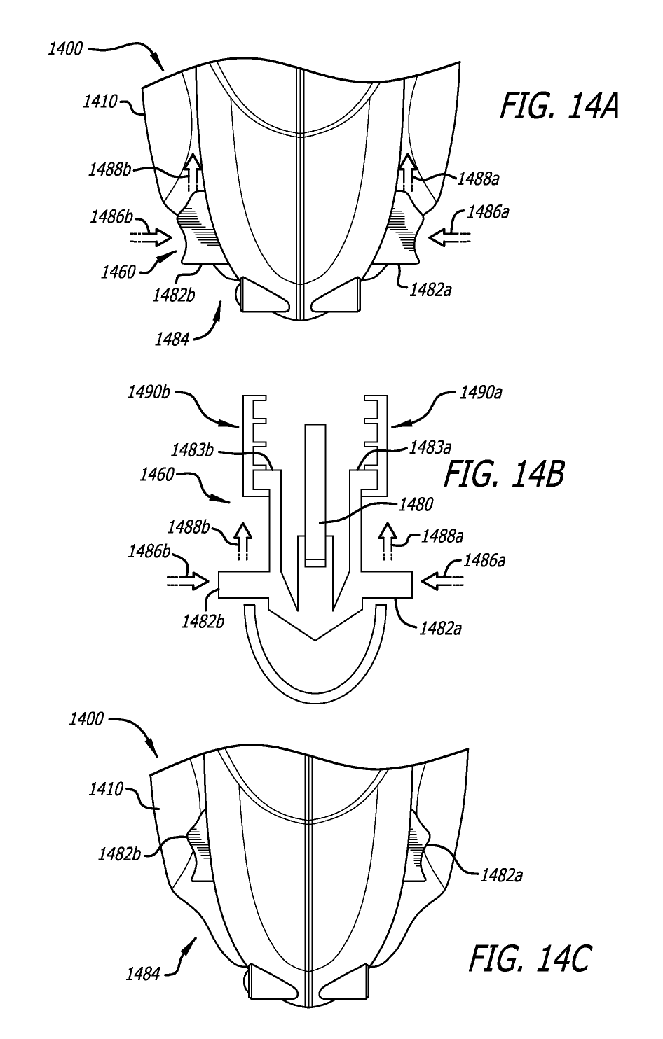

Example embodiments of cutters (or cutter apparatuses) can include other blade depth adjustment mechanisms or devices. By way of example, and referring to FIGS. 14A-14C, a cutter apparatus 1400 (e.g., substantially similar to the cutter apparatus 100, except as described differently herein) includes a housing 1410 and a blade depth selector (or switch) 1460, which is repositionable along a blade depth selector path (e.g., within or partially within the housing 1410). The blade depth selector (or switch) 1460 includes a central portion 1480 and engagement elements 1482a and 1482b (e.g., a pair of buttons) that extend respectively from a pair of openings on opposite sides of the housing 1410. In this example embodiment, the opposing engagement elements 1482a and 1482b are resiliently coupled (or connected), e.g., as shown in FIG. 14B, to the central portion 1480 of the blade depth selector (or switch) 1460. In example embodiments, the blade depth selector (or switch) 1460 is configured to be slidably coupled to adjacent supporting structures and/or surfaces within a rear bottom portion 1484 (of the housing 1410). In this example embodiment, the blade depth selector (or switch) 1460 includes a pair of fingers 1483a and 1483b that are coupled (or connected) respectively to the engagement elements 1482a and 1482b. Stop surfaces structures 1490a and 1490b within the housing 1410 include, by way of example, multiple opposing pairs of slots (e.g., as shown in FIG. 14B). In example embodiments, the stop surfaces structures 1490a and 1490b are molded into the interior of the housing 1410. The stop surfaces are configured to facilitate engagement of the blade depth selector (or switch) 1460 at positions providing, for example, four different cutting depths as shown (e.g., ranging from 15 mm to full safe).

In example embodiments, a cutter (or cutter apparatus) includes a blade depth selector (or switch) with resiliently coupled (or connected) engagement elements configured to bias opposing portions of the blade depth selector (or switch) to engage stop surfaces within the housing. In this example embodiment, the engagement elements 1482a and 1482b bias opposing portions (e.g., the fingers 1483a and 1483b, respectively) of the blade depth selector (or switch) 1460 to engage one of a plurality of pairs of stop surfaces (e.g., provided by the stop surfaces structures 1490a and 1490b, respectively, as shown) within the housing 1410.

In example embodiments, a cutter (or cutter apparatus) includes a blade depth selector (or switch) with resiliently coupled (or connected) engagement elements configured to require simultaneous (or substantially simultaneous) activation of the engaging elements in order to reposition the blade depth selector along a blade depth selector path. In this example embodiment, the blade depth selector (or switch) 1460 and the stop surfaces structures 1490a and 1490b are configured such that when both of the engagement elements 1482a and 1482b are depressed (as indicated by arrows 1486a and 1486b, respectively), the engagement elements 1482a and 1482b disengage from the stop surfaces so that the blade depth selector (or switch) 1460 can be repositioned along the blade depth selector path (as indicated by arrows 1488a and 1488b). In this example embodiment, the cantilevered end portions of the fingers 1483a and 1483b disengage from the stop surfaces structures 1490a and 1490b, respectively, when both of the engagement elements 1482a and 1482b are depressed.

In example embodiments of cutters (or cutter apparatuses) that include a housing and a blade depth selector (or switch) that is repositionable along a blade depth selector path (e.g., within or partially within the housing), the blade depth selector (or switch) includes engagement elements (e.g., buttons) that are repositionable in relation to each other (e.g., resiliently or flexibly coupled together).

In operation, the blade depth selector (or switch) 1460 is adjusted by squeezing the engagement elements 1482a and 1482b from both sides and sliding the blade depth selector (or switch) 1460 forward. Alternatively, the blade depth selector (or switch) 1460 and its engagement elements 1482a and 1482b can be configured such that the engagement elements 1482a and 1482b disengage from the stop surfaces when either of the engagement elements 1482a and 1482b is depressed.

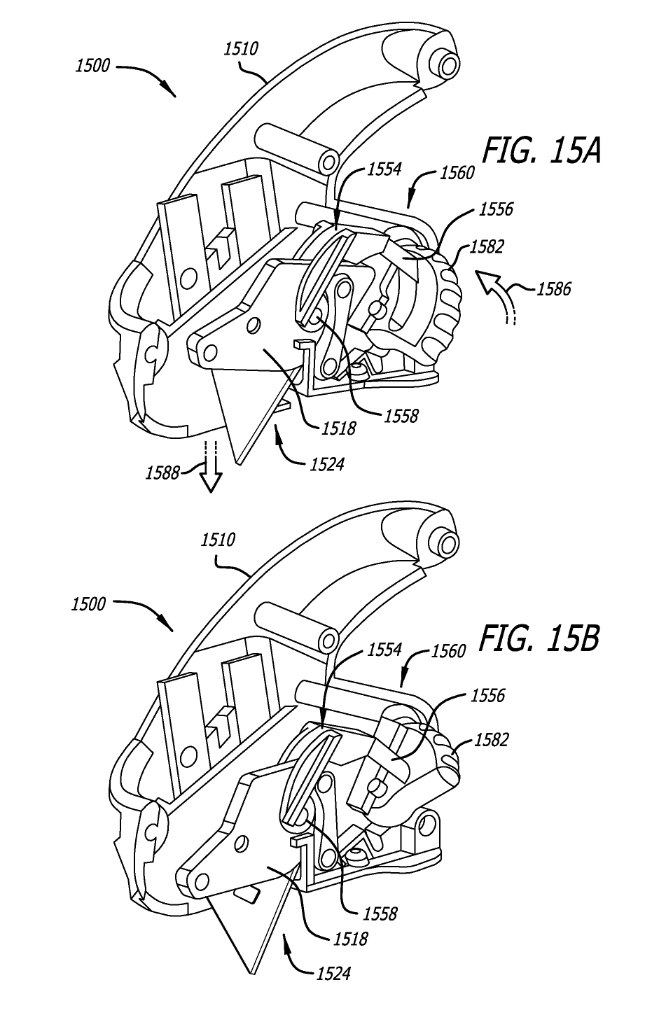

Referring to FIGS. 15A and 15B, in another example of an alternative blade depth adjustment mechanism or device, a cutter apparatus 1500 (e.g., substantially similar to the cutter apparatus 100, except as described differently herein) includes a housing 1510 and a blade holder (or blade carrier) 1518 that holds a blade. In this example embodiment, the cutter apparatus 1500 includes a blade depth selector 1560 with a cam wheel 1582 that is pivotally coupled to and repositionable in relation to the housing 1510, and a push rod 1554 configured to reposition relative to the housing 1510 in response to movement of the cam wheel 1582. In this example embodiment, the push rod 1554 includes a portion 1556 that repositions in relation to the housing 1510 against an interior portion of the cam wheel 1582. The push rod 1554 is mechanically coupled at another portion thereof to the blade carrier 1518 (e.g., by a coupling 1558 configured to pivotally couple an end portion of the push rod 1554 to the blade carrier 1518). In this example embodiment, the push rod 1554 is curved in shape and pivotally coupled to the blade carrier 1518 (to accommodate rotational movement of the blade carrier 1518 in relation to the push rod 1554). The portion 1556 (of the push rod 1554) and the aforementioned interior portion (of the cam wheel 1582) together provide a cam interface (e.g., including one or more cam surfaces) for repositioning the push rod 1554 in relation to the housing 1510 in response to movement of the cam wheel 1582 along a blade depth selector or adjustment path (e.g., within or partially within the housing 1510). In operation, blade depth for the cutter apparatus 1500 is adjusted by repositioning the cam wheel 1582 (as indicated by arrow 1586) which, in turn, via the push rod 1554 repositions the blade carrier 1518 downward toward the opening 1524 (as indicated by arrow 1588).

Thus, in example embodiments, a cutter (or cutter apparatus) includes one or more linkage members and/or push rods configured to facilitate a blade depth adjustment for a blade and/or blade carrier of the cutter. In example embodiments, a cutter (or cutter apparatus) includes a linkage member or a push rod (e.g., configured to facilitate a blade depth adjustment as described herein) with one or more portions that receive one or more complementary portions of a blade carrier of the cutter and about which the blade carrier pivots or otherwise repositions as a blade is deployed from the cutter (e.g., when an actuator of the cutter is moved toward a blade deployment position). In example embodiments, the one or more portions of the linkage member or the push rod are also shaped or otherwise configured to permit movement of the blade carrier toward an end portion (e.g., a distal end) of the cutter in response to a cutting edge of the blade coming into contact with a workpiece.

### Blade Locking

In example embodiments described herein, a cutter (or cutter apparatus) includes a mechanism or device that facilitates locking (i.e., securing) a blade of the cutter in position during a cutting operation. Example cutters (or cutter apparatuses) include a cutting positions lock configured to secure a blade of the cutter in one of multiple different extended positions (e.g., depending upon the blade depth).

Referring to FIGS. 16 and 17, in this example embodiment, the cutter apparatus 100 includes a cutting positions lock 220 configured to secure the blade in an extended position during a cutting operation (i.e., while the blade is in contact with the workpiece). In this example embodiment, the cutting positions lock 220 includes elements 222 and 223 (e.g., stop elements) which are configured to engage the blade carrier 118 in extended positions defined by and/or accommodating first and second blade depths, respectively. In this example embodiment, the blade carrier 118 (independent of the blade depth selected) is aligned when in a cutting position with a complementary surface (e.g., a surface of one of the elements 222 and 223) that prevents the blade carrier 118 from rotating back into the housing (until the cutting edge separates from the workpiece).

Example embodiments of cutters (or cutter apparatuses) include a blade carrier and a cutting positions lock configured to engage the blade carrier depending upon the blade depth. Referring to FIGS. 16 and 17, in this example embodiment, the cutting positions lock 220 including multiple elements (e.g., stop elements 222 and 223) which engage a portion (e.g., a member 234) of the blade carrier 118 depending upon the blade depth selected. By way of example, in FIG. 16, the blade carrier 118 is shown in an extended position (e.g., at a first blade depth) at which the member 234 (of the blade carrier 118) is engaged by the stop element 222. In FIG. 17, the blade carrier 118 is shown in an extended position (e.g., at a second blade depth) at which the member 234 (of the blade carrier 118) is engaged by the stop element 223.

In an example embodiment, a cutter (or cutter apparatus) includes a housing with an opening and a blade carrier coupled to the housing to permit rotational movement of the blade carrier between a retracted position and a deployed position and to permit movement of the blade carrier (e.g., from a deployed position) toward a distal end of the cutter (e.g., to a cutting position) in response to a cutting edge of the blade coming into contact with a workpiece, the blade carrier being coupled to the housing and configured for holding and deploying a blade at one of a multiple selectable blade depths and for preventing the blade carrier from rotating back into the housing when the blade carrier is deployed at any of the selectable blade depths and advanced to an extended position (e.g., a cutting position). In example embodiments, the blade carrier is repositionable (e.g., in relation to a portion of the cutter) with multiple degrees of freedom of operational movement (e.g., translational movement and rotational movement as previously discussed). In example embodiments, the cutter includes a spring (or other mechanism or device) configured to bias the blade carrier to reposition rotationally (e.g., in relation to the opening).

Example embodiments of cutters (or cutter apparatuses) include a blade carrier configured for deploying a blade at multiple different blade depths, a blade depth selector for selecting and/or setting (or locking) a blade depth, and a cutting positions lock configured to secure and/or engage the blade carrier depending upon the blade depth. In example embodiments, the cutters (or cutter apparatuses) further include one or more linkage elements (e.g., a push rod) coupling the blade carrier to the blade depth selector. In example embodiments, the cutters (or cutter apparatuses) further include an actuator coupled to the blade carrier such that the blade carrier is repositioned (e.g., toward an opening of the housing) in response to movement of the actuator toward an actuator blade deployment position. Moreover, in an example embodiment, the actuator is coupled to the blade depth selector such that movement of the blade depth selector to a different blade depth selection position causes at least a portion of the actuator to reposition in relation to the housing thereby providing a visual indication of the blade depth selected.

Referring to FIGS. 16 and 17, in this example embodiment, the blade depth selector 160 is repositionable in relation to the housing and coupled to the blade carrier 118 such that a distance between one or more portions (e.g., the portions 156a and 156b) of the blade carrier 118 and the opening 124 changes to set a blade depth when the blade carrier 118 is deployed. In this example embodiment, a portion (e.g., the engagement portion 178) of the blade depth selector 160 is repositioned, e.g., as previously described in relation to FIGS. 13A-13E, to select and/or set (or lock) a blade depth.

Example embodiments of cutters (or cutter apparatuses) include a housing, a blade carrier, a blade depth selector configured to allow a user of the cutter apparatus to select a blade depth from multiple selectable blade depths (e.g., predetermined blade depths), and a cutting positions lock that engages the blade carrier during a cutting operation preventing the blade carrier from rotating back into the housing. In example embodiments, the cutting positions lock is configured to prevent the blade carrier from rotating back into the housing until the cutting edge separates from the workpiece. In example embodiments, the cutting positions lock includes one or more stop elements which engage the blade carrier depending upon the blade depth selected.

Thus, in an example embodiment, a cutter (or cutter apparatus) includes a housing with an opening, a blade carrier coupled to the housing and configured for holding and deploying a blade at a plurality of selectable blade depths, the blade carrier being coupled to the housing to permit movement of the blade carrier toward a distal end of the cutter in response to a cutting edge of the blade coming into contact with a workpiece and to permit rotational movement of the blade carrier during movement of the blade carrier to and from a deployed position, a spring biasing the blade carrier to reposition rotationally in relation to the opening, a blade depth selector configured to allow a user of the cutter apparatus to select (e.g., by repositioning the blade carrier in relation to the opening) a blade depth from the plurality of selectable blade depths, and a cutting positions lock that engages the blade carrier during a cutting operation preventing the blade carrier from rotating back into the housing (e.g., until the cutting edge separates from the workpiece), the cutting positions lock including a plurality of stop elements which engage the blade carrier depending upon the blade depth selected. In example embodiments, the blade carrier is repositionable (e.g., in relation to a portion of the cutter) with multiple degrees of freedom of operational movement (e.g., translational movement and rotational movement as previously discussed). In example embodiments, the cutter (or cutter apparatus) further includes one or more linkage elements (e.g., a push rod) coupling the blade carrier to the blade depth selector.

In example embodiments, one or more of the stop elements is configured to engage the blade carrier, for example, by receiving or catching a portion of the blade carrier. In example embodiments, one or more of the stop elements is complementary in shape to a portion of the blade carrier. In example embodiments, one or more of the stop elements includes a curved surface. The one or more of the stop elements can also include surfaces (or structures) of other shapes and/or configurations. In example embodiments, one or more of the stop elements includes a surface (e.g., including a curved portion and/or a slot) which, when engaging the blade carrier, receives or catches a portion of the blade carrier. In example embodiments, one or more of the stop elements, when engaging the blade carrier, contacts a portion of the blade carrier at a top and/or distal side of the blade carrier.

Referring to FIGS. 16 and 17, in this example embodiment, the stop elements 222 and 223 (of the cutting positions lock 220) include or are provided with curved surfaces 226 and 227, respectively, which are configured to engage (e.g., receive or catch) the member 234 (of the blade carrier 118) when the blade carrier 118 repositions to an extended position. In this example embodiment, the member 234 is located at a top or distal side 235 (FIG. 31) of the blade carrier 118.

In example embodiments, one or more of the stop elements, when engaging the blade carrier, contacts the blade carrier at a portion thereof that faces generally away from the opening in the housing. The one or more stop elements can be configured to directly or indirectly engage (e.g., via one or more intermediary elements or components) the blade carrier. In example embodiments, one or more of the stop elements also prevents, when engaging the blade carrier, further movement of the blade carrier toward a distal end of the cutter. In example embodiments, the stop elements are configured to engage the blade carrier at one or more selectable blade depths. In example embodiments, the stop elements are configured to engage in mutually exclusive fashion a (common) portion of the blade carrier.

Referring to FIGS. 12A and 12B, in this example embodiment, the cutting positions lock 220 includes a first pair of stop elements 222a and 222b and a second pair of stop elements 223a and 223b, provided on the right and left side portions 112 and 114 (of the housing 110), respectively. The first pair of stop elements 222a and 222b and the second pair of stop elements 223a and 223b serve as a first “locking slot” and a second “locking slot”, respectively. In this example embodiment, the cutting positions lock 220 can also include an optional third pair of stop elements 224a and 224b (shown in dashed lines), provided on the right and left side portions 112 and 114 (of the housing 110), respectively. Thus, an optional third “locking slot” can also be provided (e.g., for a 3 mm cutting depth). In example embodiments, there are two slots on each body half, one for each of two user-selectable cutting depths. In example embodiments, there are three slots on each body half, one for each of three user-selectable cutting depths. In example embodiments, the locking slots are molded into the housing 110.

In operation, after the blade 119 has been deployed, contact with a workpiece (e.g. a box) causes the blade carrier 118 to slide forward along the channel portions 155a and 155b (of the push rod 154) until the member 234 (of the blade carrier 118) engages with one of the stop elements (or “locking slots”) of the cutting positions lock 220. When the flapper 134 comes off the edge of the workpiece at the end of the cut, the “locking slot” continues to engage the blade carrier 118 utilizing force imparted to the blade 119 by the workpiece to secure (or lock) the blade 119 in its cutting position allowing the cut to be completed.

A cutter (or cutter apparatus) can be configured with other mechanisms or devices that facilitate locking (i.e., securing) a blade of the cutter in position during a cutting operation. By way of example, one or more portions of the cutter (e.g., portions other than the housing) are configured such that the blade carrier aligns when in a cutting position with one or more complementary surfaces that prevent the blade carrier from rotating back into the housing. In example embodiments, the one or more complementary surfaces are provided by one or more structures (or other elements or components) of a mechanism or device that facilitates deployment of a blade from the cutter and/or a blade depth adjustment for the cutter.

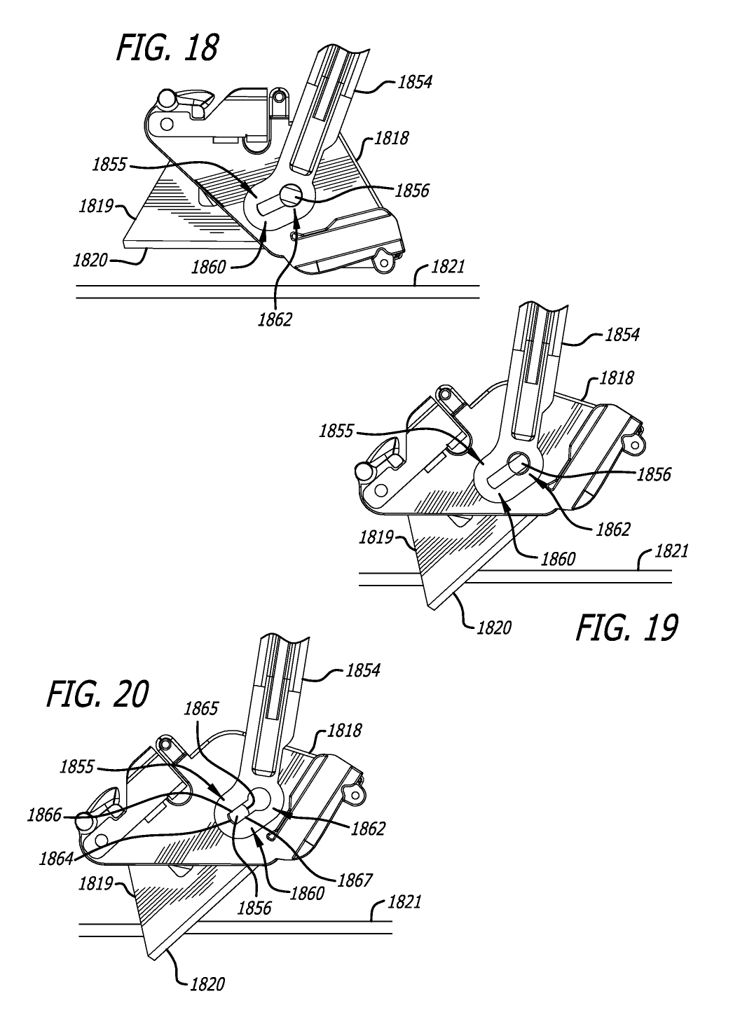

In example embodiments, a cutter (or cutter apparatus) includes a blade carrier and a linkage element (e.g., a push rod) which are configured such that the blade carrier aligns when in a cutting position with complementary surfaces that prevent the blade carrier from rotating back into the housing. Referring to FIGS. 18-20, a cutter apparatus (e.g., substantially similar to the cutter apparatus 100, except as described differently herein) includes a blade carrier 1818 and a push rod 1854 which are configured such that the blade carrier 1818 aligns when in a cutting position with complementary surfaces that prevent the blade carrier 1818 from rotating back into the housing until the cutting edge 1820 of the blade 1819 separates from the workpiece 1821. In this example embodiment, the complementary surfaces are defined by the opposing sides of a channel 1855 of the push rod 1854. The blade carrier 1818 include an alignment post 1856, and the push rod 1854 includes an alignment slot 1860. In this example embodiment, the push rod 1854 includes a circular end portion 1862 shaped (e.g., as shown) to permit rotational movement of the blade carrier 1818 as shown in FIGS. 18 and 19 when the blade 1819 is deployed. In this example embodiment, the alignment post 1856 includes arcuate surfaces 1864 and 1865, which facilitate the aforementioned rotational movement of the blade carrier 1818 at the circular end portion 1862 (of the push rod 1854). The alignment post 1856 additionally includes parallel surfaces 1866 and 1867, which align (as shown in FIG. 19) with the alignment slot 1860 (of the push rod 1854) after the blade carrier 1818 is initially deployed. Aligned in this manner, the alignment post 1856 is drawn into the alignment slot 1860 (as shown in FIG. 20) when the blade 1819 is brought into contact with the workpiece 1821.

In example embodiments, a cutter (or cutter apparatus) includes a blade carrier and a linkage element (e.g., a push rod) with one or more surfaces that prevent the blade carrier from rotating back into the housing when the blade carrier is in an extended position (e.g., a cutting position). In example embodiments, the blade carrier and the linkage element are configured such that a portion of the blade carrier aligns with the one or more surfaces after the blade is deployed. In example embodiments, the blade carrier and the linkage element are configured such that a portion of the blade carrier aligns with the one or more surfaces when the blade carrier is in an extended position (e.g., a cutting position). In example embodiments, the one or more surfaces include complementary surfaces (e.g., parallel surfaces). In example embodiments, the linkage element couples the blade carrier to a blade depth selector.

In example embodiments, a cutter (or cutter apparatus) includes a blade carrier with one or more surfaces that prevent the blade carrier from rotating back into the housing when the blade carrier is in an extended position (e.g., a cutting position). In example embodiments, the one or more surfaces are provided by one or more alignment posts of the blade carrier (e.g., alignment posts located on opposite sides of the blade carrier). The alignment posts each include, by way of example, a pair of opposing arcuate surfaces and a pair of opposing parallel surfaces. In example embodiments, the blade carrier is coupled to a blade depth selector by a linkage element (e.g., a push rod). In example embodiments, the linkage element includes one or more alignment slots with which the one or more alignment posts align after the blade is deployed. The one or more alignment slots and the one or more alignment posts are configured such that the one or more alignment posts align with and reposition into the one or more alignment slots in response to the blade in its deployed position coming into contact with a workpiece.

Thus, in an example embodiment, a cutter (or cutter apparatus) includes a housing with an opening, a blade carrier coupled to the housing and configured for holding and deploying a blade at a plurality of selectable blade depths, the blade carrier being coupled to the housing to permit rotational movement of the blade carrier during movement of the blade carrier between a retracted position and a deployed position and to permit movement of the blade carrier (e.g., from a deployed position) toward a distal end of the cutter (e.g., to a cutting position) in response to a cutting edge of the blade coming into contact with a workpiece, a spring biasing the blade carrier to reposition rotationally in relation to the opening, and a blade depth selector configured to allow a user of the cutter apparatus to select (e.g., by repositioning the blade carrier in relation to the opening) a blade depth from the plurality of selectable blade depths, wherein the blade carrier independent of the blade depth selected aligns when in a cutting position with a complementary surface that prevents the blade carrier from rotating back into the housing. In example embodiments, the blade carrier is repositionable (e.g., in relation to a portion of the cutter) with multiple degrees of freedom of operational movement (e.g., translational movement and rotational movement as previously discussed). In example embodiments, the cutter (or cutter apparatus) further includes one or more linkage elements (e.g., a push rod) coupling the blade carrier to the blade depth selector.

In operation, the blade carrier 1818 is deployed, for example, by activating a flapper (e.g., as previously described). After the blade 1819 is deployed, the alignment post 1856 (of the blade carrier 1818) is aligned with the alignment slot 1860 (of the push rod 1854). The force exerted on the blade 1819 by the material being cut causes the blade carrier 1818 to slide into the alignment slot 1860, preventing the blade carrier 1818 from rotating back into the body of the cutter. After the cut is completed, one or more springs (e.g., as previously described) pull the blade carrier 1818 back out of the alignment slot 1860. With the alignment post 1856 (of the blade carrier 1818) repositioning back into the circular end portion 1862 (of the push rod 1854), the alignment slot 1860 no longer prevents the blade carrier 1818 from rotationally repositioning in relation to the push rod 1854 and the one or more springs are now free to rotate the blade carrier 1818 back into the cutter.

### Blade Change

In example embodiments described herein, a cutter (or cutter apparatus) includes a mechanism or device that facilitates a blade change operation for the cutter. In example embodiments, a cutter (or cutter apparatus) includes a blade release device that is configured to release a blade from a blade holder (or blade carrier) in response to the blade release device repositioning in relation to the blade holder. In example embodiments, the blade release device is configured to release the blade by disengaging (e.g., deflecting) a blade lock element from the blade. In example embodiments, the blade release device includes or is provided in the form of a blade change lever. In example embodiments, the blade release device is located within and repositionable in relation to the blade holder (or blade carrier). In example embodiments, the blade release device is accessible only by opening a cover portion (e.g., a lid) of the cutter.

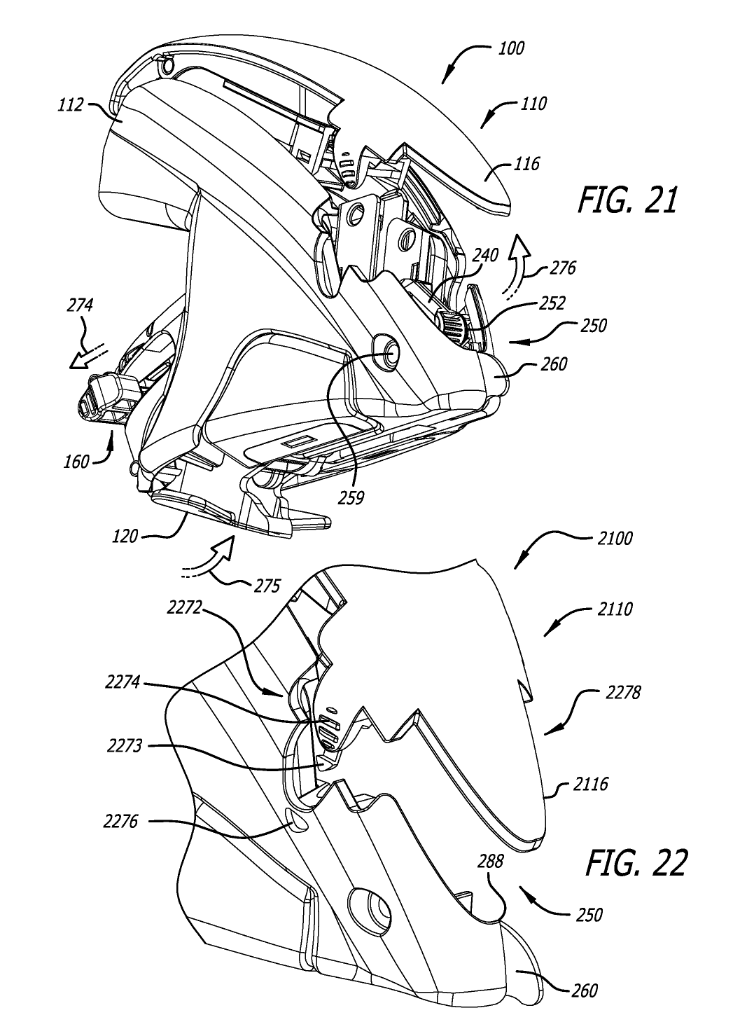

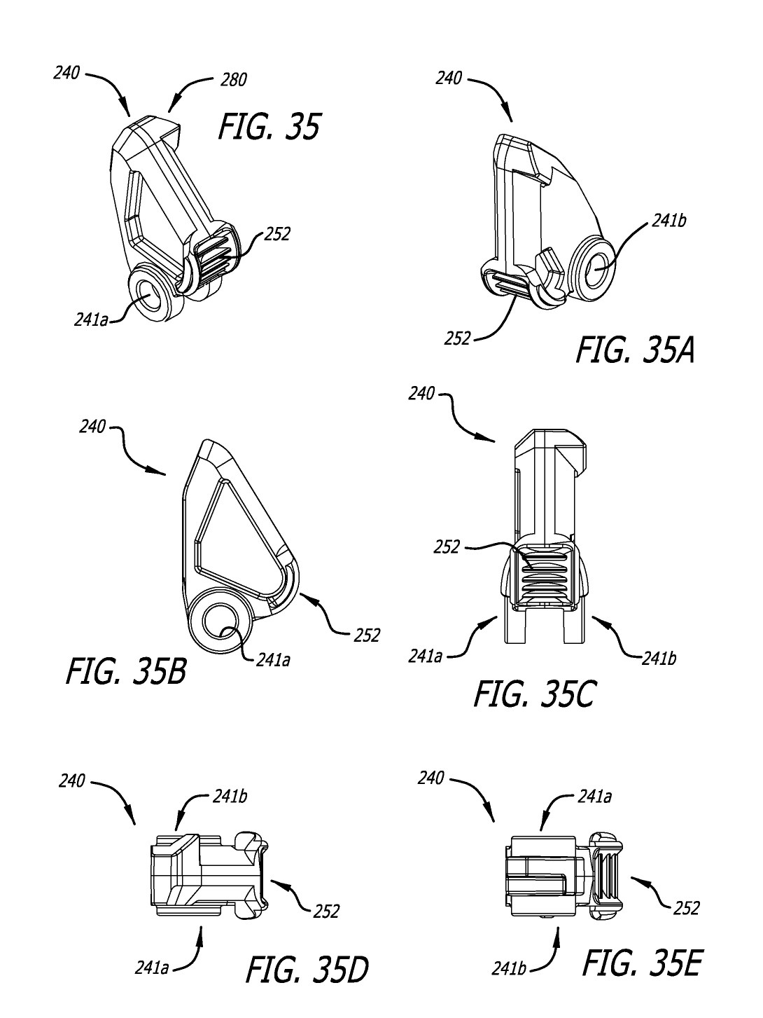

Referring to FIGS. 21, 23, 23A, 24, 25, and 26, in this example embodiment, the cutter apparatus 100 includes a blade release device 240 which is repositionable (e.g., in relation to the housing 110). The blade release device 240 (e.g., a blade change lever) can be formed of various materials, for example, a thermoplastic that has high stiffness, creep resistance, low warpage, and high dimensional stability (e.g., Polyoxymethylene (POM), Glass Filled), and by various processes (e.g., injection molding). In example embodiments, the blade release device 240 is mechanically coupled to the housing 110. Referring also to FIGS. 35, 35A, 35B, 35C, 35D, and 35E, in this example embodiment, the blade release device 240 includes channels 241a and 241b formed on opposing sides thereof (e.g., as shown). The channels 241a and 241b (of the blade release device 240) receive a post, cylindrical shaft, or the like (e.g., rivet 259) and serve to pivotally couple the blade release device 240 to the housing 110. In example embodiments, the blade release device 240 and the housing 110 are one or more of directly coupled (e.g., in direct contact with each other), indirectly coupled (e.g., coupled together by one or more intermediary coupling elements or components, such as the rivet 259), continuously coupled (e.g., at least one portion of the blade release device 240 repositioning in relation to a continuous portion of the housing 110 or an intermediary coupling element or component as the blade release device 240 is moved toward the blade carrier 118), and intermittently coupled (e.g., the blade release device 240 contacting or engaging different portions of the housing 110 or an intermediary coupling element or component at different times and/or without continuous coupling or surface contact as the blade release device 240 repositions in relation to the housing 110).

In this example embodiment, the cutter apparatus 100 includes a blade lock 242 for securing the blade 119 to the blade carrier 118. The blade lock 242 is repositionable in relation to at least a portion of the blade carrier 118. In this example embodiment, the blade lock 242 is coupled to (e.g., secured to, or attached to) the blade carrier 118, for example, adjacent to the member 234 (of the blade carrier 118) as shown. The blade lock 242 is provided, for example, in the form of a flexible piece of metal. The blade lock 242 can be formed of various materials, for example, a material made of or including a metal (or a metal alloy or a plastic) that has high strength and wear resistance (e.g., stainless steel), and by various processes (e.g., stamped).

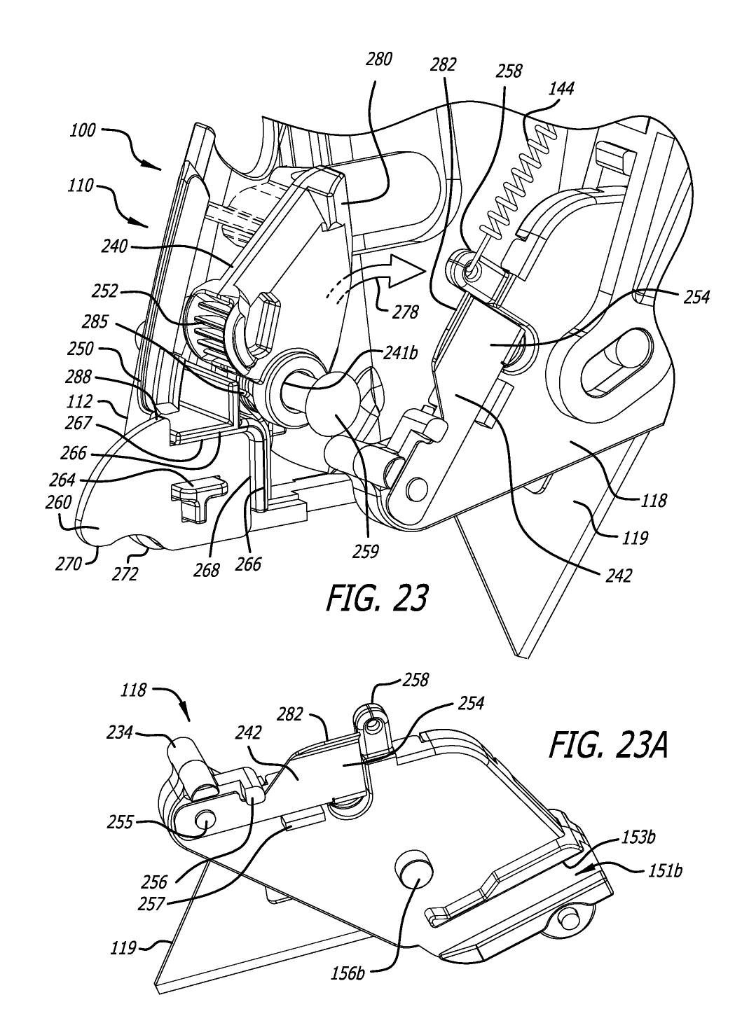

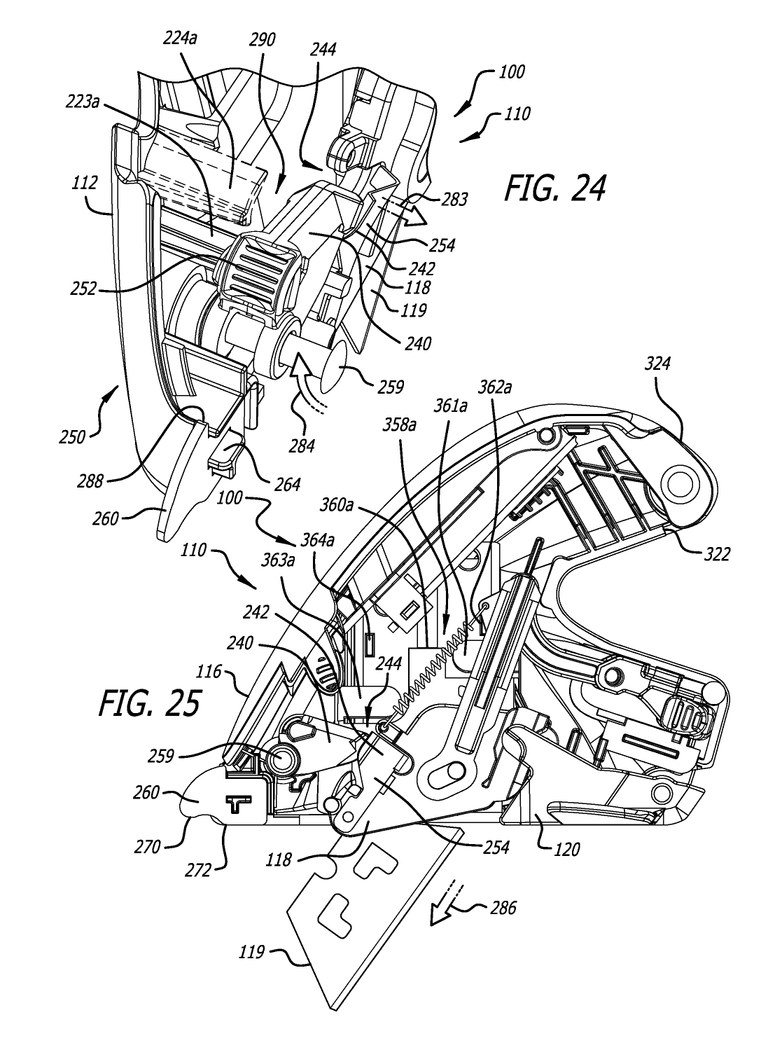

Referring to FIG. 24-26, the blade carrier 118 can include one or more portions such a portion 244 configured to facilitate engagement with another portion of the cutter apparatus 100 (for example, a portion of the blade release device 240) to prevent the blade carrier 118 from repositioning in relation to the housing 110 (e.g., pivoting back into the housing 110). The blade carrier 118 can include one or more engagement portions, such as a recessed portion 246, configured to engage a portion of the blade carrier 118 when the blade release device 240 is held in its blade release position, thereby preventing the blade carrier 118 from pivoting back into the housing 110 so long as the blade release device 240 is held in its blade release position. In this example embodiment, and referring also to FIG. 23, the blade release device 240 is accessible by a user of the cutter apparatus 100 via an opening 250 in the housing 110.

Referring to FIG. 23, the blade release device 240 can include one or more engagement portions, for example, pads or surfaces with ridges suitable for securely engaging a finger. In this example embodiment, the one or more engagement portions include or are provided in the form of a pad 252. In example embodiments, at least a portion of the blade lock 242 is repositionable (e.g., in relation to the blade carrier 118). In this example embodiment, the blade lock 242 includes a flexible portion 254 (e.g., a thin piece of stamped steel) which is secured to a post 255 on the blade carrier 118 as shown. In example embodiments, the cutter includes one or more elements or components configured to guide and/or limit movement of the blade lock 242 in relation to the blade carrier 118. In this example embodiment, guide members 256 and 257 are provided on the blade carrier 118 and configured as shown to allow the flexible portion 254 to reposition laterally in relation to the blade carrier 118, but to prevent rotation of the blade lock 242 about the post 255. In this example embodiment, the blade carrier 118 includes a structure 258 (e.g., including an aperture as shown) that is connected or coupled to the other end of the spring 144. In this example embodiment, the blade release device 240 includes a surface 280 (e.g., an angled surface as shown) that deflects a portion 282 (e.g., a complementary angled surface as shown) of the blade lock 242 away from the blade carrier 118 in response to the blade release device 240 being repositioned in relation to the housing 110. In this example embodiment, the blade release device 240 is biased by a spring 285 (or other biasing mechanism or device) away from the blade carrier 118 (e.g., to an upright position as shown in FIG. 23). The spring 285 (e.g., a torsion spring made of steel), by way of example, is configured to swivel or otherwise reposition about the rivet 259 and tensions one or more portions of the blade release device 240.

Example embodiments of cutters (or cutter apparatuses) include a tape splitter located, for example, at an end portion of the cutter. Referring again to FIG. 23, in this example embodiment, the cutter apparatus 100 includes a tape splitter 260 which is sized and configured (e.g., protruding from the distal end 158 of the cutter apparatus 100 as shown) to serve as a mechanism or device for splitting tape and/or other materials. The tape splitter 260 can be formed of various materials, for example, a material made of or including a metal (or a metal alloy or a plastic) that has high strength and wear resistance (e.g., stainless steel), and by various processes (e.g., stamped). In example embodiments, the tape splitter 260 is secured to (e.g., interconnected or engaged by complementary surfaces of) the housing 110. In example embodiments, the tape splitter 260 is mechanically coupled to the housing 110 and/or other elements or components of the cutter apparatus 100. In example embodiments, the tape splitter 260 is housed between two or more body portions of the cutter apparatus 100 (e.g., including one or more of the right side portion 112 and the left side portion 114 of the cutter apparatus 100).

In this example embodiment, the tape splitter 260 includes an opening 262 (e.g., shaped as shown). The right side portion 112 of the housing 110 includes a protrusion 264 that is shaped and configured (e.g., as a “T-shaped” support structure, as shown) to fit through the opening 262 and a peripheral support member 266 (e.g., an integrally formed portion of the housing 110) that is complementary in shape to top and rear portions 267 and 268 (of the tape splitter 260). In this example embodiment, the protrusion 264 and the peripheral support member 266 are both provided as part of the right side portion 112 (of the housing 110). By way of example, the protrusion 264 can be molded into the right side portion 112. In this example embodiment, the tape splitter 260 includes a bottom surface 270 that is raised slightly (e.g., 1-3 mm) above a bottom surface (e.g., adjacent bottom surface 272) of the cutter apparatus 110, for example, to lessen the incidence of inadvertent contact between the tape splitter 260 and objects being cut by the blade 119 of the cutter apparatus 100. In example embodiments, a cutter (or cutter apparatus) includes a tape splitter with no sharp edges (e.g., such as the tape splitter 260), which potentially reduces the risk of injury.

Example embodiments of cutters (or cutter apparatuses) include a blade release device and a tape splitter that is configured to guide or assist in guiding a finger toward the blade release device. In this example embodiment, the tape splitter 260 includes a top surface 288 shaped (e.g., as shown) to guide a finger toward an engagement portion (e.g. the pad 252) of the blade release device 240. Additionally, as shown in FIG. 23, the top surface 288 (of the tape splitter 260) defines a portion of the opening 250.

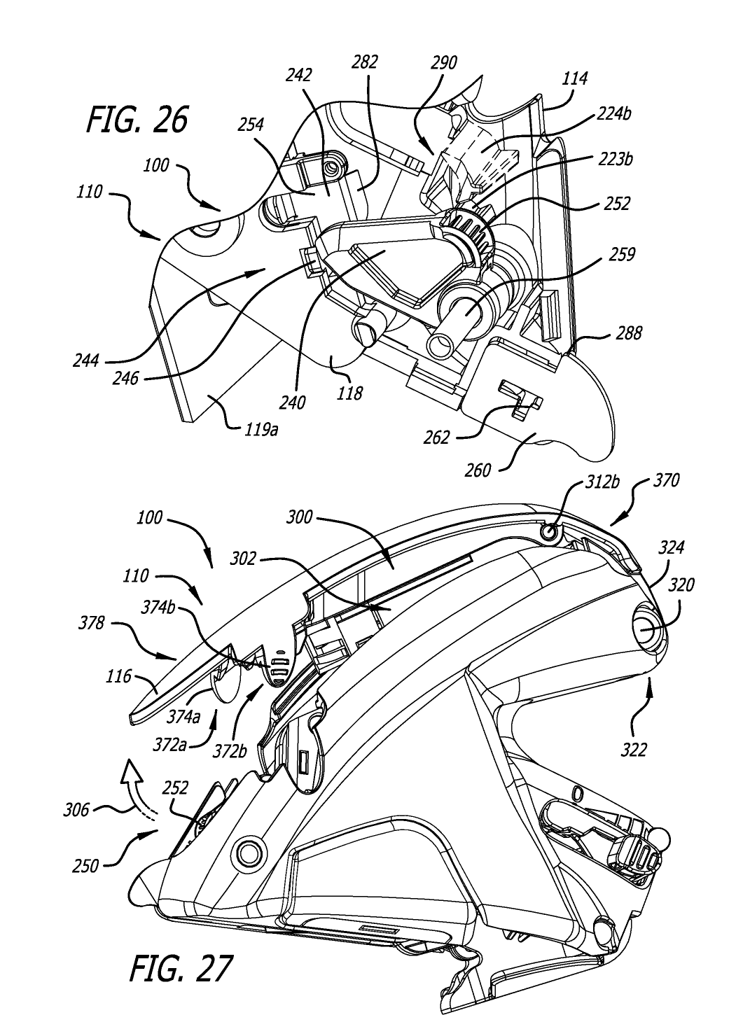

In relation to the cutters (or cutter apparatuses) described herein, an example method for changing a blade held by a cutter apparatus, which includes a housing, a blade carrier coupled to and repositionable in relation to the housing, and an actuator for repositioning the blade carrier, is now described (and in relation to FIGS. 23, 24, 25, and 26 for illustrative purposes). In this example embodiment, the method of changing a blade held by a cutter apparatus includes: repositioning the blade carrier 118 to a blade change position (FIG. 23), repositioning the blade release device 240 within the housing 110 to a blade release position at which the blade release device 240 disengages the blade lock 242 from the blade 119 (such that the blade 119 can be removed from the blade carrier 118) and engages a portion 244 of the blade carrier 118 (FIG. 24), and removing the blade 119 from the blade carrier 118 (FIG. 25) and positioning a replacement blade 119a (e.g., new blade or a different type of blade) on the blade carrier 118 while holding the blade release device 240 in its blade release position (FIG. 26). In an example embodiment, the method of changing a blade held by a cutter apparatus further includes releasing the blade release device 240 from its blade release position to allow the blade lock 242 to engage the replacement blade 119a.

In example embodiments, and referring again to FIG. 23, the blade change position (of the blade carrier 118) is also a deployed position of the blade carrier 118 at which a blade held by the blade carrier is extended from the housing. For example, the cutter apparatus 100 is configured (e.g., as previously discussed) such that, upon deployment, the blade carrier 118 repositions to one of multiple deployment positions depending upon which blade depth has been set and/or selected. In example embodiments, the deployed position provides (e.g., via a prior repositioning and/or setting (or locking) of the blade carrier 118) a predetermined blade depth, which controls the degree to which or the amount of the blade 119 that extends from the housing 110.

Referring to FIG. 21, in example embodiments, the cutter apparatus 100 is configured such that the blade carrier 118 repositions to a blade change position in response to the actuator 120 being depressed. In example embodiments, the action of repositioning the blade carrier to a blade change position includes and/or is effected by depressing or otherwise activating an actuator of the cutter apparatus (e.g., fully depressing the actuator until it is flush with the housing or another portion of the cutter apparatus).

Referring to FIGS. 23 and 24, in example embodiments, the cutter apparatus 100 is configured such that the blade carrier 118 (when in its blade change position) is prevented from repositioning back into the housing 110 when the blade release device 240 is in its blade release position. In example embodiments, the action of repositioning the blade carrier to a blade change position includes and/or is effected by depressing or otherwise activating an actuator of the cutter apparatus and holding the actuator in its depressed or activated position at least until a blade release device of the cutter apparatus is in (or has been moved to) its blade release position.

In example embodiments, the cutter apparatus 100 is configured such that an opening (e.g., the opening 250) and/or other configuration of one or more elements or components of the cutter apparatus 100 allows a finger to be brought into contact with one or more engagement portions (e.g. the pad 252) of the blade release device 240. In example embodiments, the action of repositioning the blade carrier to a blade change position includes and/or is effected by utilizing an opening in the housing or another portion of the cutter apparatus to allow a user of the cutter apparatus to bring a finger into contact with one or more engagement portions of a blade release device of the cutter apparatus.

In example embodiments, the cutter apparatus 100 is configured such that the blade release device 240 repositions to its blade release position by pivoting about a securing element (e.g., the rivet 259) that holds portions (e.g., the right side portion 112 and the left side portion 114) of the housing 110 together. In example embodiments, the action of repositioning the blade release device to a blade release position includes pivoting the blade release device about a securing element that holds portions of the housing together or about another element or component of the cutter apparatus.

In example embodiments, the cutter apparatus 100 is configured such that the blade release device 240 deflects a portion of the blade lock 242 away from the blade carrier 118 when the blade release device 240 repositions to its blade release position. By way of example, the flexible portion 254 (of the blade lock 242) is deflected (e.g., laterally repositioned in relation to the blade carrier 118 and/or the blade 119) as the blade release device 240 is pivoted toward the blade carrier 118 and the angled surface 280 (of the blade release device 240) is brought into contact with the complementary angled surface 282 (of the blade lock 242). In example embodiments, the action of repositioning the blade release device to a blade release position includes disengaging the blade lock from the blade by repositioning at least a portion of the blade lock in relation to the blade carrier, the blade, and/or another element or component of the cutter apparatus.

In example embodiments, a cutter (or cutter apparatus) includes a cover portion and a blade release device that is accessible only by opening the cover portion. In example embodiments, the cover portion includes or is provided in the form of a hood (e.g., the hood 116) that is coupled to and/or repositionable in relation to at least a portion of the cutter.

Example embodiments of cutters (or cutter apparatuses) with mechanisms or devices that facilitates a blade change operation are configured such that one or more portions (or steps) of the blade change operation are performed in conjunction with and/or dependent upon a repositioning of at least a cover portion of the cutter.

Referring now to FIG. 21, in an example embodiment, a blade change operation is facilitated by moving the blade depth selector 160 to a deepest cut position (as indicated by arrow 274) and activating the actuator 120 (as indicated by arrow 275), which repositions the blade carrier 118 to a position at which a “blade change lever” (such as the blade release device 240), which is accessible only with the cover (or hood) 116 opened (as indicated by arrow 276), is repositionable to separate or disengage a “blade lock” member (such as the blade lock 242) releasing the blade 119 from the blade carrier 118. Referring to FIG. 23, the blade release device 240 is moved to its blade release position by repositioning the blade release device 240 (as indicated by arrow 278) toward the blade carrier 118. Referring to FIG. 24, the blade release device 240 deflects the blade lock 242 away from the blade carrier 118 (as indicated by arrow 283) in response to the blade release device 240 being repositioned in relation to the housing 110, e.g., pivoted toward the blade carrier 118 (as indicated by arrow 284) and brought into contact with a portion of the blade lock 242. Referring to FIG. 25, in its blade release position, the blade release device 240 contacts and repositions at least a portion of the blade lock 242 such that the blade 119 can be removed from the blade carrier 118 (as indicated by arrow 286).

In operation, the blade 119 is changed by first setting the blade depth to the deepest setting (e.g., 15 mm) and activating the flapper 134. The cover (or hood) 116 is opened to allow access to the blade change device (or lever) 240. When depressed, the blade change lever 240 bends the blade lock 242 away from the blade carrier 118, allowing the blade 119 to be released. A new blade 119a is inserted and the blade change lever 240 is released, which allows the blade lock 242 to spring back and lock the blade 119a in place.

Thus, in an example embodiment, a cutter apparatus includes a housing, a blade carrier coupled to the housing, a blade lock for securing a blade to the blade carrier, and a blade release device coupled to and repositionable within the housing, the blade release device being repositionable to a blade release position at which the blade release device contacts and repositions at least a portion of the blade lock such that the blade can be removed from the blade carrier. In an example embodiment, the blade carrier is repositionable in relation to the housing to a blade change position. The blade change position is, for example, a deployed position (of the blade carrier) at which a blade held by the blade carrier is extended from the housing. In an example embodiment, the deployed position provides a predetermined (e.g., maximum) blade depth. In an example embodiment, the blade release device, when held in its blade release position, engages a portion of the blade carrier such that the blade carrier is prevented from repositioning in relation to the housing (e.g., pivoting back into the housing). In an example embodiment, the cutter apparatus includes an actuator for repositioning the blade carrier (e.g., by fully depressing the actuator and/or repositioning the actuator until it is flush with the housing). The actuator is configured, for example, to reposition the blade carrier to a blade change position.

In another example embodiment, a cutter apparatus includes a housing, a blade carrier coupled to the housing and repositionable in relation to the housing, an actuator for repositioning the blade carrier, a blade lock for securing a blade to the blade carrier, and a blade release device repositionable in relation to the housing to a blade release position for disengaging the blade lock from the blade carrier, wherein the cutter apparatus is configured such that a blade change operation requires a user of the cutter apparatus to overcome forces imparted upon multiple biased (e.g., independently spring-biased) components of the cutter apparatus to release the blade from the blade carrier. The multiple biased components include, in various example embodiments, two or more of: the blade carrier, the actuator, the blade lock, and the blade release device. In example embodiments, the blade change operation includes (or requires) repositioning multiple components of the cutter apparatus and/or sequentially repositioning components of the cutter apparatus. By way of example, the blade change operation includes (or requires) repositioning multiple components of the cutter apparatus (e.g., the flapper 134 and the blade release device 240) that deploy the blade carrier and disengage the blade lock, respectively. In an example embodiment, the components (e.g., the flapper 134 and the blade release device 240) are repositioned from opposing sides of the opening 250. By way of an additional example, the blade change operation includes (or requires) repositioning multiple components of the cutter apparatus (e.g., the flapper 134 and the blade release device 240) that deploy and lock the blade carrier (in its blade change position), respectively. In an example embodiment, the cutter apparatus also includes a blade depth selector repositionable in relation to the housing for setting a blade depth.

Example cutters (or cutter apparatuses) include a blade release device and a blade carrier that is repositionable to allow the blade release device to disengage a blade held by the blade carrier. In an example embodiment, the blade carrier is coupled to the housing such that the blade carrier prevents the blade release device from disengaging the blade lock unless the blade carrier is in a blade change position (e.g., a deployed position of the blade carrier that positions the blade lock for engagement with the blade release device). In an example embodiment, the blade change position is a deployed position (of the blade carrier) that provides a set or predetermined blade depth (e.g., a maximum blade depth). For example, a blade depth that allows the blade carrier to deploy to its blade change position is determined (or selected) by setting a blade depth selector element to a maximum blade depth position. Although example embodiments of cutters (or cutter apparatuses) described herein include a blade change device that is operable (to disengage a blade from the blade carrier) when the blade carrier is deployed at a set or predetermined blade depth (e.g., a maximum blade depth), the scope of the present invention(s) additionally includes and/or contemplates cutters (or cutter apparatuses) with a blade change device that is operable when the blade carrier is repositioned to a location other than its deployed position and/or when the blade carrier is deployed at a different blade depth (e.g., a blade depth other than blade depths, predetermined or otherwise, that are selectable to facilitate blade deployment).

In example embodiments, the blade release device and the blade carrier include complementary surfaces that engage when the blade carrier is in a blade change position and when the blade release device is advanced to its blade release position. For example, the complementary surfaces are configured such that the blade release device engages a portion of the blade carrier preventing the blade carrier from repositioning in relation to (e.g., pivoting back into) the housing until the blade release device repositions away from its blade release position.

In example embodiments, the blade change operation includes (or requires) repositioning multiple components of the cutter apparatus that perform two or more of: setting the blade depth, deploying the blade carrier, disengaging the blade lock, and locking the blade carrier (e.g., in its blade change position). By way of example, the blade change operation includes (or requires) repositioning the blade carrier to a blade change position (e.g., a deployed position) and then activating the blade release device. Additionally, in example embodiments, the blade change operation includes (or requires) that the user of the cutter apparatus utilize the actuator (e.g., a flapper) to maintain the blade carrier in its blade change position at least until the blade release device is moved to its blade release position. By way of an additional example, the blade change operation includes (or requires) holding the actuator (e.g., a flapper) in an activated (e.g., depressed) position and simultaneously activating (or deploying) the blade release device. The blade carrier and the blade release device can be configured (e.g., as previously described) such that the blade change operation does not require that the user of the cutter apparatus continue to hold the actuator (e.g., a flapper) in its activated position once the blade release device is in its blade release position. By way of an additional example, the blade change operation includes (or requires) holding the blade release device in a blade release position until the blade has been replaced. For example, the blade carrier, the blade release device, and/or additional elements or components of the cutter apparatus are configured such that the blade carrier is locked (e.g., held or secured) in a blade change position when the blade release device is in its blade release position. By way of an additional example, the blade change operation includes (or requires) locking (e.g., holding or securing) the blade carrier in a blade change position. By way of an additional example, the blade change operation includes (or requires) removing the blade from the blade carrier and positioning a replacement blade (e.g., a new blade or a different type of blade) on the blade carrier while holding the blade release device in its blade release position. In an example embodiment, the blade change operation additionally includes (or requires) securing the replacement blade to the blade carrier by allowing (or causing) the blade release device to reposition away from it blade release position (which, in turn, allows the blade lock to engage the replacement blade). In an example embodiment, the blade change operation additionally includes (or requires) securing the replacement blade to the blade carrier by allowing (or causing) the blade lock to engage the replacement blade.

Example embodiments of cutters (or cutter apparatuses) described herein are provided with a cutting positions lock that includes a channel (e.g., centrally located) which provides a path through which the blade release device 240 repositions during operation. Referring to FIGS. 12A, 12B, 24 and 26, in this example embodiment, the “locking slots” of the cutting positions lock 220 form a channel 290 configured to allow the blade change device 240 to pivot therethrough toward the blade carrier 118 when the blade change device 240 is moved to its blade release position. In an example embodiment, the stop elements 222a and 223a define (or provide) a right side of the channel 290, and the stop elements 222b and 223b define (or provide) a left side of the channel 290. In another example embodiment, which includes a third “locking slot” (as previously discussed), the stop elements 222a, 223a, and 224a define (or provide) a right side of the channel 290, and the stop elements 222b, 223b, and 224b define (or provide) a left side of the channel 290. Although example embodiments of cutters (or cutter apparatuses) described herein include a blade change device that is configured to be pivotally repositionable, the scope of the present invention(s) additionally includes and/or contemplates cutters (or cutter apparatuses) with a blade change device that is configured to be slidably repositionable, for example, along a linear or curved path (e.g., defined or provided by a track, a rail, or other guide and/or support structure).

### Blade Storage

In example embodiments described herein, a cutter (or cutter apparatus) includes a mechanism or device that facilitates blade storage (e.g., storage of new and used blades) within the cutter. In example embodiments, a cutter (or cutter apparatus) includes a storage compartment (e.g., a blade storage compartment) configured to serve as a cover for another storage compartment of the cutter. In example embodiments, a cutter (or cutter apparatus) includes multiple blade storage compartments one of which is configured to serve as a cover (e.g., for the other blade storage compartment). In example embodiments, a cutter (or cutter apparatus) includes a hood (or other repositionable portion) and a blade storage assembly (or device) that is accessible by repositioning (e.g., opening) the hood. In example embodiments, the blade storage assembly (or device) is integrated with and/or partially provided (or defined) by the hood. In example embodiments, the blade storage assembly (or device) includes a blade storage compartment that is coupled to and repositionable in relation to an underside of the hood.

Referring to FIGS. 27, 28, 29, 29A, and 29B, in this example embodiment, the cutter apparatus 100 includes or is provided with a blade storage assembly 300 (e.g., secured to a portion of the cutter apparatus 100 that is repositionable in relation to at least a portion of the housing 110). In this example embodiment, the blade storage assembly 300 includes blade storage compartments 302 and 304 which are configured and/or interconnected (e.g., as described herein) as storage compartments for new and used blades, respectively. In this example embodiment, the blade storage compartment 302 (e.g., a new blade storage compartment) serves as a cover for the blade storage compartment 304 (e.g., a used blade storage compartment). Referring to FIG. 27, the blade storage assembly 300 is coupled to (e.g., secured to or integrated with) the hood 116 such that the blade storage assembly 300 is made accessible to a user of the cutter apparatus 100 by repositioning the hood 116 in relation to another portion of the housing (as indicated by arrow 306). In this example embodiment, the blade storage assembly 300 is secured to (e.g., mounted on) the underside 308 of the hood 116.

In example embodiments, the hood 116 provides or defines a portion of at least one of the blade storage compartments. In this example embodiment, the blade storage compartment 304 is provided or defined in part by a recess 310 (e.g., a well or similar structure) at the underside 308 of the hood 116.

In example embodiments, at least one of the blade storage compartments is repositionable in relation to the hood 116. In this example embodiment, the blade storage compartment 302 is coupled to and repositionable in relation to the hood 116 (for gaining access to the blade storage compartment 304). The blade storage compartment 302 includes, for example, bearings 312a and 312b on opposing sides thereof and adjacent to an end portion 313 of the blade storage compartment 302. The bearings 312a and 312b are interfitted within recessed portions 314a and 314b, respectively, of the blade storage compartment 304. In this example embodiment, the blade storage compartment 302 is pivotally coupled to and repositionable in relation to the hood 116 and the blade storage compartment 304.

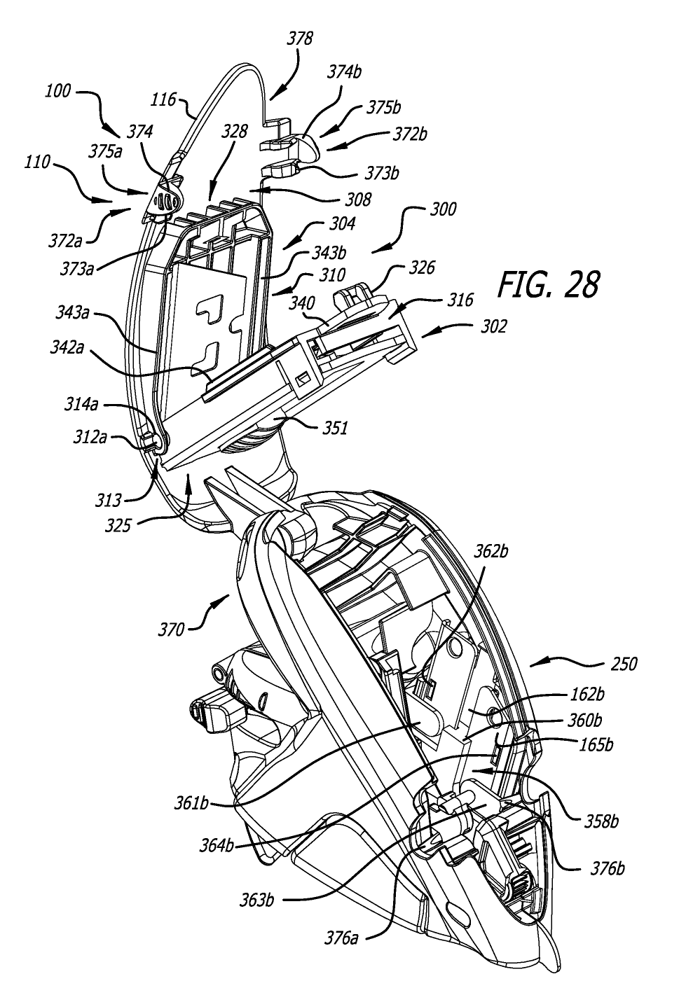

In this example embodiment, the blade storage assembly 300 and the hood 116 are configured such that (at least a portion of) one of the blade storage compartments (e.g., a new blade storage compartment) is repositionable away from the hood 116 providing access to another of the blade storage compartments (e.g., a used blade storage compartment). By way of example, and referring to FIG. 28, the blade storage compartment 302 is shown repositioned (i.e., pivoted about the bearings 312a and 312b) away from the hood 116 to a position or location at which an end portion 316 of the blade storage compartment 302 faces away from the hood 116 (and away from the housing 110 when the hood 116 is in its fully opened position).

Thus, in an example embodiment, a cutter (or cutter apparatus) includes a housing, a blade holder coupled to the housing, and a blade storage assembly including a blade storage compartment configured to serve as a cover for another storage compartment of the cutter (or cutter apparatus).

In example embodiments, a cutter apparatus or other tool includes a housing with a hood (or cover portion) that is mechanically coupled to the housing. Referring to FIGS. 25, 27, and 29, in this example embodiment, the hood 116 is coupled (e.g., pivotally coupled) to the housing 110. The hood 116 includes, for example, a channel 318 provided at a base portion 319 of the hood 116 as shown. In this example embodiment, the hood 116 swivels about a securing element, e.g., a rivet 320 (FIG. 27), that holds portions (e.g., body halves) of the housing 110 together. In this example embodiment, the housing 110 additionally includes a hood stop portion 322 that comes into contact with a back portion 324 of the hood. In example embodiments, the hood 116 and the housing 110 are one or more of directly coupled (e.g., in direct contact with each other), indirectly coupled (e.g., coupled together by one or more intermediary coupling elements or components, such as the rivet 320), continuously coupled (e.g., at least one portion of the hood 116 repositioning in relation to a continuous portion of the housing 110 or an intermediary coupling element or component as the hood 116 is opened or closed), and intermittently coupled (e.g., the hood 116 contacting or engaging different portions of the housing 110 or an intermediary coupling element or component at different times and/or without continuous coupling or surface contact as the hood 116 repositions in relation to the housing 110).

In example embodiments, a cutter apparatus or other tool includes a housing with a hood (or cover portion) and a storage assembly that is coupled to (e.g., secured to or integrated with) the hood. The storage assembly includes a storage compartment configured to serve as a cover for another compartment (e.g., which is included in or provided at least in part by the hood, the storage compartment, and/or other elements or components of the cutter apparatus or other tool).

In example embodiments, a cutter apparatus or other tool includes a housing and a storage assembly that includes or provides multiple blade storage compartments. By way of example, one of the blade storage compartments (e.g., a new blade storage compartment that holds five new blades) is configured to serve as a cover for another of the blade storage compartments (e.g., a used blade storage compartment that holds five used blades). One or more of the blade storage compartments (e.g., a used blade storage compartment) can be included in or provided at least in part by a hood (or cover portion) of the cutter apparatus or other tool.

Thus, in an example embodiment, a cutter (or cutter apparatus) includes a housing (e.g., including a hood or cover portion), a blade holder coupled to the housing, and a blade storage assembly including blade storage compartments, one of the blade storage compartments being configured to serve as a cover for another of the blade storage compartments.

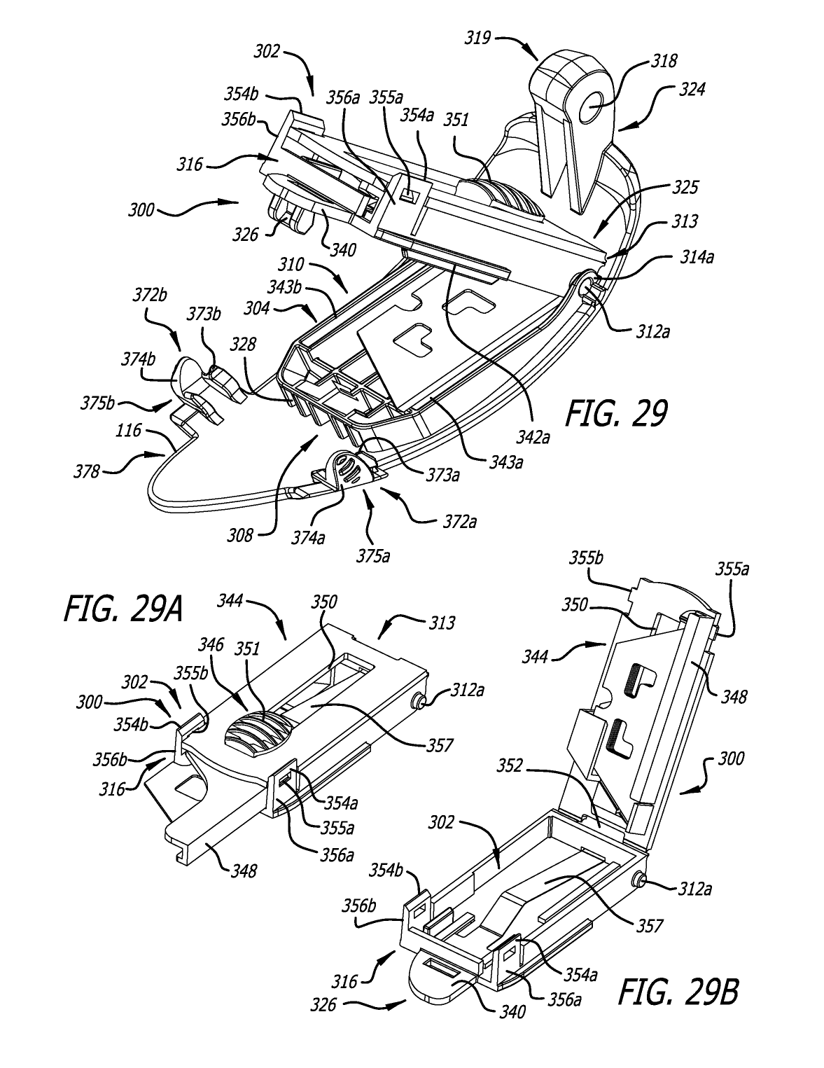

In example embodiments, the blade storage assembly and the hood are configured such that (at least a portion of) one of the blade storage compartments (e.g., a new blade storage compartment) is repositionable away from the hood a limited amount (e.g., opening to a predetermined and/or maximum angle). Referring to FIGS. 28, 29, and 29A, in this example embodiment, the end portion 313 of the blade storage compartment 302 comes into contact with a portion 325 of the underside of the hood 116, which prevents the blade storage compartment 302 from repositioning (pivoting) away from the hood 116 beyond an a predetermined and/or maximum angle (e.g., as shown). In example embodiments, one of the blade storage compartments (e.g., a used blade storage compartment) is defined in part by a recess (e.g., a well or similar structure) at the underside of the hood. In this example embodiment, the blade storage compartment 304 is defined in part by the recess 310 (e.g., a well or similar structure) at the underside of the hood 116. The blade storage compartment 304 is also defined in part by the blade storage compartment 302 (which is configured to serve as a cover for the blade storage compartment 304). In example embodiments, the blade storage assembly includes a mechanism or device (e.g., a latch) configured for securing another storage compartment to the recess and/or to another portion of the hood. In this example embodiment, the blade storage assembly 300 includes a latch 326 configured for securing the blade storage compartment 302 to a peripheral portion 328 of the recess 310. In this example embodiment, the latch 326 (e.g., provided on, secured to, or integrally formed as part of the blade storage compartment 302) includes a flexible portion 340, and the peripheral portion 328 (e.g., configured as shown) is rigid (or substantially rigid). Alternatively, the blade storage compartment 304 can include or be provided with a flexible portion configured to secure and/or engage a portion (e.g., a rigid portion) of the blade storage compartment 302. In example embodiments, at least one of the blade storage compartments includes one or more surfaces or portions configured to prevent lateral movement of one of the blade storage compartments in relation to the other and/or the hood. In this example embodiment, the blade storage compartment 302 includes (e.g., on opposing sides thereof) surfaces 342a and 342b, and the recess 310 includes (e.g., on opposing sides thereof) portions 343a and 343b. The surfaces 342a and 342b are complementary to (e.g., configured to engage and/or interfit with) the portions 343a and 343b, respectively, when the blade storage compartment 302 is positioned against the recess 310 (of the blade storage compartment 304).

In example embodiments, the blade storage assembly includes one or more portions that are repositionable for gaining access to one or more blade storage compartments. By way of example, referring to FIG. 29, the blade storage assembly 300 includes a repositionable portion, namely, the blade storage compartment 302 which is repositionable (as previously described) for gaining access to the blade storage compartment 304. By way of another example, referring to FIGS. 29A and 29B, the blade storage assembly 300 includes a repositionable portion, namely, a guide member 344 that is repositionable for gaining access to the blade storage compartment 302. In example embodiments, the blade storage assembly includes a blade dispenser element or component (e.g., a slider) coupled to and repositionable in relation to the guide member such that a portion of the blade dispenser element or component is extendable from a portion (e.g., an end portion or a side portion) the blade storage compartment for dispensing a blade therefrom. In this example embodiment, the blade storage assembly 300 includes a slider 346 coupled to and repositionable along the guide member 344 such that a blade extender portion 348 of the slider 346 is extendable from an end portion 316 of the blade storage compartment 302 for dispensing a blade therefrom. In this example embodiment, the guide member 344 includes an opening (or window) 350 (e.g., located at the top side of the guide member 344), and the slider 346 includes a button 351 configured to extend through the opening 350 and to be repositionable along (or within) the opening 350. The slider 346 includes, for example, one or more surfaces configured to engage one or more portions of a next blade to be dispensed when the slider 346 is activated/deployed.

In example embodiments, the blade storage assembly includes a portion that is repositionable for gaining access to a blade storage compartment and configured for dispensing a blade therefrom. By way of example, the repositionable portion includes or provides a cover for the blade storage compartment. Referring to FIGS. 29A and 29B, the guide member 344 is repositionable (e.g., pivotally coupled to the blade storage compartment 302) for gaining access to the blade storage compartment 302. In this example embodiment, the guide member 344 is pivotally attached to the blade storage compartment by a living hinge 352. In example embodiments, the blade storage assembly includes multiple blade storage compartments and a mechanism or device (e.g., a latch) configured for securing a cover and/or a blade dispenser element or component of one of the blade storage compartments to a repositionable portion (e.g., a cover) of another of the blade storage compartments. By way of example, the blade storage compartment 302 and the guide member 344 include complementary surfaces for securing the guide member 344 to the blade storage compartment 302. In this example embodiment, the blade storage compartment 302 includes latches 354a and 354b (e.g., including apertures and beveled upper edges as shown) on opposing sides of the blade storage compartment 302. In this example embodiment, the latches 354a and 354b are provided on the sides of the blade storage compartment 302, and at an opposite end of the storage compartment 302 from the living hinge 352. The guide member 344 includes protrusions 355a and 355b (e.g., tabs) on opposing sides of the guide member 344. In this example embodiment, the latches 354a and 354b include flexible portions 356a and 356b, respectively, which allow the latches 354a and 354b to reposition outward to receive (and thereby mechanically engage with) the protrusions 355a and 355b, respectively. In this example embodiment, the blade storage assembly 300 includes a spring 357 (e.g., a leaf spring) configured to bias blades stored within the blade storage compartment 302 toward the slider 346 (e.g., when the guide member 344 is in its closed position).

In operation, new blades are held in the blade storage compartment 302 which acts as a cover for used blades held in the blade storage compartment 304. The slider 346 mounted in the cover dispenses blades one at a time. The new blades are replaced by opening the cover, which is attached to the assembly by the living hinge 352. The blades are fed into the slider 346 by the spring 357.

In example embodiments, the blade storage assembly includes at least one cover that is repositionable in relation to at least one of the blade storage compartments. In example embodiments, the blade storage compartments are separate from each other (e.g., providing or defining mutually exclusive storage spaces, volumes, or compartments). In example embodiments, the blade storage compartments are coupled together (e.g., connected by a living hinge and/or an integrated latch).

In example embodiments, a tool includes a first repositionable portion configured to serve as a cover for an interior portion of the tool, the first repositionable portion defining, in conjunction with a second repositionable portion of the tool, a first storage compartment. In example embodiments, the first repositionable portion is coupled (e.g., pivotally coupled) to a housing of the tool. In example embodiments, the second repositionable portion is coupled (e.g., pivotally coupled) to the first repositionable portion and configured to provide (or define) a portion of the first storage compartment and/or serve as a cover for the first storage compartment. In example embodiments, the tool includes a third repositionable portion that defines, in conjunction with the second repositionable portion, a second storage compartment. In example embodiments, the third repositionable portion is coupled (e.g., pivotally coupled) to the second repositionable portion and configured to provide (or define) a portion of the second storage compartment and/or serve as a cover for the second storage compartment. Thus, in example embodiments, a tool includes or is provided with multiple repositionable portions configured to serve as covers (e.g., sequentially interconnected covers, or nested covers) and/or respectively provide (or define) compartments (e.g., storage compartments) within the tool.

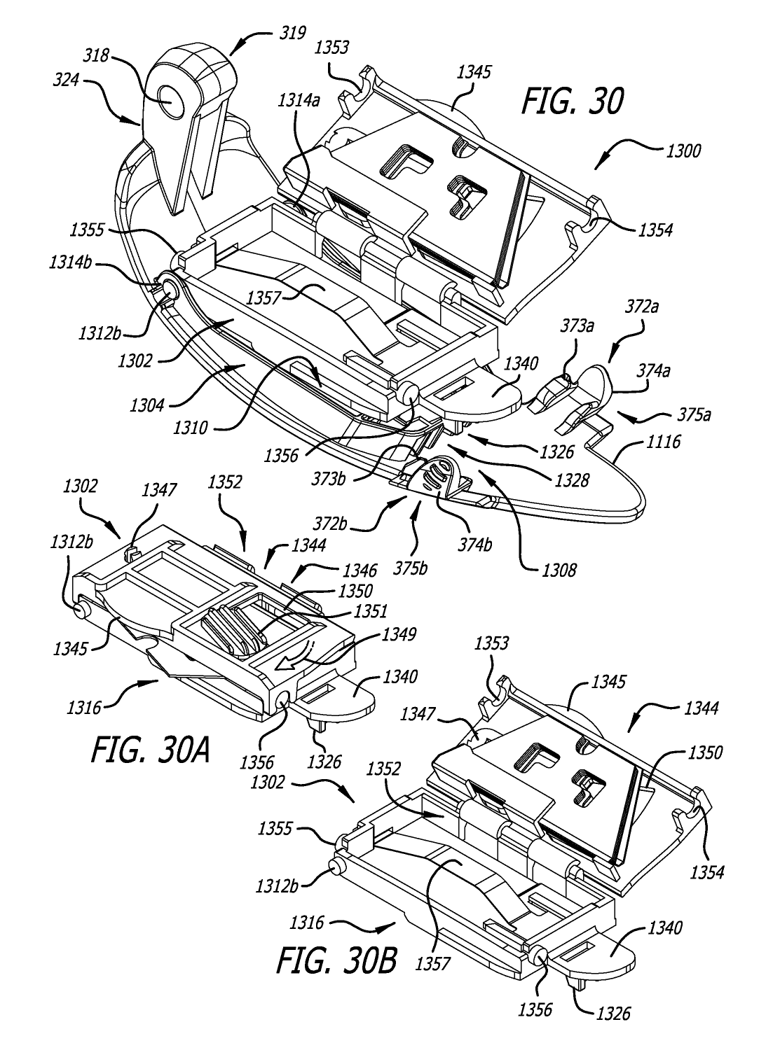

Referring to FIGS. 30, 30A, and 30B, in another example embodiment, a blade storage assembly 1300 (e.g., substantially similar to the blade storage assembly 300, except as described differently herein) includes blade storage compartments 1302 and 1304. In this example embodiment, the blade storage compartment 1302 (e.g., a new blade storage compartment) serves as a cover for the blade storage compartment 1304 (e.g., a used blade storage compartment). Referring to FIG. 30, the blade storage assembly 1300 is coupled to (e.g., secured to or integrated with) a hood 1116 (e.g., substantially similar to the hood 116, except as described differently herein) such that the blade storage assembly 1300 is made accessible to a user of the cutter apparatus 100 by repositioning the hood 1116 in relation to another portion of the housing (as previously described). In this example embodiment, the blade storage assembly 1300 is secured to (e.g., mounted on) the underside 1308 of the hood 1116.

In example embodiments, the hood 1116 provides or defines a portion of at least one of the blade storage compartments. In this example embodiment, the blade storage compartment 1304 is provided or defined in part by a recess 1310 (e.g., a well or similar structure) at the underside 1308 of the hood 1116.

In example embodiments, at least one of the blade storage compartments is repositionable in relation to the hood 1116. In this example embodiment, the blade storage compartment 1302 is coupled to and repositionable in relation to the hood 1116 (for gaining access to the blade storage compartment 1304). The blade storage compartment 1302 includes, for example, bearings on opposing sides thereof (only bearing 1312b is shown) and adjacent to an end portion 1313 of the blade storage compartment 1302. The bearings are interfitted within recessed portions 1314a and 1314b, respectively, of the blade storage compartment 1304. In this example embodiment, the blade storage compartment 1302 is pivotally coupled to and repositionable in relation to the hood 1116 and the blade storage compartment 1304.

In this example embodiment, the blade storage assembly 300 and the hood 116 are configured such that (at least a portion of) one of the blade storage compartments (e.g., a new blade storage compartment) is repositionable away from the hood 1116 providing access to another of the blade storage compartments (e.g., a used blade storage compartment). By way of example, the blade storage compartment 1302 is repositioned (i.e., pivoted about the bearings) away from the hood 1116 to a position or location at which an end portion 1316 of the blade storage compartment 1302 faces away from the hood 1116 (and away from the housing 110 when the hood 1116 is in its fully opened position).

In this example embodiment, the blade storage compartment 1304 is defined in part by a recess 1310 (e.g., a well or similar structure) at the underside of the hood 1116. The blade storage compartment 1304 is also defined in part by the blade storage compartment 1302 (which is configured to serve as a cover for the blade storage compartment 1304). The blade storage assembly 1300 includes a latch 1326 configured for securing the blade storage compartment 1302 to a peripheral portion 1328 of the recess 1310. In this example embodiment, the latch 1326 (e.g., provided on, secured to, or integrally formed as part of the blade storage compartment 1302) includes a flexible portion 1340, and the peripheral portion 1328 (e.g., configured as shown) is rigid (or substantially rigid). Alternatively, the blade storage compartment 1304 can include or be provided with a flexible portion configured to secure and/or engage a portion (e.g., a rigid portion) of the blade storage compartment 1302.

The blade storage assembly 1300 includes a repositionable portion, namely, the blade storage compartment 1302 which is repositionable for gaining access to the blade storage compartment 1304. Referring to FIGS. 30A and 30B, the blade storage assembly 1300 includes a repositionable portion, namely, a guide member 1344 that is repositionable for gaining access to the blade storage compartment 1302. The blade storage assembly 1300 includes a slider 1346 that is coupled to and repositionable in relation to the guide member 1344 (as indicated by arrow 1349) for engaging and dispensing a blade from the side portion 1316 of the blade storage compartment 1302 (e.g., as shown). The guide member 1344 includes an opening (or window) 1350 (e.g., located at the top side of the guide member 1344), and the slider 1346 includes a button 1351 configured to extend through the opening 1350 and to be repositionable along (or within) the opening 1350. In this example embodiment, the slider 1346 includes (or is connected to) a pivot axis 1347 which is interfitted with a portion of (or otherwise connected or coupled to) the guide member 1344 such that the slider 1346 is coupled to and pivotally repositionable in relation to the guide member 1344. The slider 1346 includes, for example, one or more surfaces configured to engage one or more portions of a next blade to be dispensed when the slider 1346 is activated/deployed by swiveling the slider 1346 within the blade storage compartment 1302.

The guide member 1344 is repositionable (e.g., pivotally coupled to the blade storage compartment 1302) for gaining access to the blade storage compartment 1302. In this example embodiment, the guide member 1344 is pivotally attached to the blade storage compartment by a snap fit hinge 1352, and the guide member 1344 includes or is provided with an edge portion 1345 (e.g., a laterally extended portion as shown that can be engaged to open the blade storage compartment 1302). The blade storage assembly 300 (previously described) can be provided with a snap fit hinge (e.g., as an alternative to the living hinge 352). Likewise, the blade storage assembly 1300 can be provided with a living hinge (e.g., as an alternative to the snap fit hinge 1352). In another alternative embodiment, a blade storage assembly is configured to dispense blades from a side portion (as with the blade storage assembly 1300) but is instead configured with a slider that is repositionable along a linear path (such as with the blade storage assembly 300).

The blade storage compartment 1302 and the guide member 1344 include complementary surfaces for securing the guide member 1344 to the blade storage compartment 1302. In this example embodiment, the blade storage compartment 1302 includes latches 1353 and 1354 (e.g., recessed surfaces as shown) are provided on the ends of the blade storage compartment 1302, and at an opposite side of the storage compartment 1302 from the snap fit hinge 1352. The guide member 1344 includes protrusions 1355 and 1356 (e.g., cylindrical posts that snap fit into the recesses of the latches 1353 and 1354, respectively). The blade storage assembly 1300 includes a spring 1357 (e.g., a leaf spring) configured to bias blades stored within the blade storage compartment 1302 toward the slider 1346 (e.g., when the guide member 1344 is in its closed position).

Referring again to FIGS. 27-29, in this example embodiment, the hood 116 is part of a handle portion 370 of the housing 110. The hood 116 includes latches 372a and 372b shaped to engage surfaces (e.g., complementary surfaces of the housing 110) for securing the hood 116 (in a closed position) In this example embodiment, the latches 372a and 372b (e.g., flexible fingers provided on, secured to, or integrally formed as part of the hood 116) include or are provided with surfaces (or latching members) 373a and 373b, respectively. The latches 372a and 372b also include flexible portions 374a and 374b, respectively, which can include or be provided with gripping surfaces (or elements) on their exterior surfaces (e.g., as shown). In this example embodiment, actuator portions 375a and 375b (of the latches 372a and 372b, respectively) include the aforementioned gripping surfaces of the flexible portions 374a and 374b, respectively.

Referring to FIG. 28, the surfaces 373a and 373b (of the latches 372a and 372b, respectively) are shaped to engage complementary surfaces 376a and 376b (of the housing 110), respectively. In this example embodiment, the complementary surfaces 376a and 376b define recesses or recessed portions, and the flexible portions 374a and 374b permit the surfaces 373a and 373b to reposition inward when the hood 116 is moved to its closed position such that that the surfaces 373a and 373b are engaged by the complementary surfaces 376a and 376b, respectively, to provide a positive lock of the hood 116 to the housing 110. In this example embodiment, the surfaces (or latching members) 373a and 373b are located at a front portion 378 of the hood 116 (e.g., at a lower front portion thereof as shown).

Thus, in an example embodiment, a cutter (or cutter apparatus) includes a housing with a hood (or cover portion), a blade holder coupled to the housing, and a blade storage assembly that is integrated with the hood and accessible by opening the hood. Although example embodiments of cutters (or cutter apparatuses) described herein include a blade carrier (or holder) that is configured to be repositionable (e.g., in relation to the cutter housing), the scope of the present invention(s) additionally includes and/or contemplates cutters (or cutter apparatuses) with a blade holder that is coupled to the housing, but not repositionable (e.g., a fixed blade).

In example embodiments, the blade storage assembly is secured to (e.g., mounted on) the underside of the hood. In example embodiments, the blade storage assembly includes a blade storage compartment (e.g., a new blade storage compartment) that is repositionable in relation to the hood (e.g., for gaining access to a used blade storage compartment). The blade storage compartment and the hood can be configured such that (at least a portion of) the blade storage compartment is repositionable away from the hood (e.g., to a used blade compartment open position, in which an end portion of the blade storage compartment faces away from the hood providing access to another storage compartment (e.g., a used blade storage compartment). In example embodiments, the blade storage assembly includes one or more blade storage compartments. The blade storage assembly and the hood can be configured such that (at least a portion of) one of the blade storage compartments (e.g., a new blade storage compartment) is repositionable away from the hood (e.g., to a used blade compartment open position) providing access to another of the blade storage compartments (e.g., a used blade storage compartment). The blade storage assembly and the hood can be configured such that (at least a portion of) one of the blade storage compartments (e.g., a new blade storage compartment) is repositionable away from the hood a limited amount (e.g., to a fixed or maximum angle, determined by contact between portions of the blade storage compartment and the hood). In example embodiments, one of the blade storage compartments (e.g., a used blade storage compartment) is defined in part by a recess (e.g., a well or similar structure) at the underside of the hood. The blade storage assembly can include a latch for securing another of the blade storage compartments to a peripheral portion of the recess. The latch (e.g., provided on another of the blade storage compartments) can include a flexible portion. Another of the blade storage compartments (e.g., a new blade storage compartment) can include surfaces (e.g., on opposing sides thereof) complementary to (e.g., engaging and/or interfitting with) portions of the recess (e.g., peripheral portions) to prevent lateral movement of the other blade compartment in relation to the hood when the other blade compartment is secured to a peripheral portion of the recess. In example embodiments, the blade storage assembly includes blade storage compartments are separate from each other (e.g., providing or defining mutually exclusive storage spaces, volumes, or compartments). In example embodiments, the blade storage assembly includes blade storage compartments are coupled together (e.g., connected by a living hinge and/or an integrated latch). In example embodiments, the blade storage assembly includes a blade storage compartment (e.g., a used blade storage compartment) and at least one cover (e.g., a new blade storage compartment) that is repositionable in relation to the storage compartment (for gaining access to the storage compartment). In example embodiments, the blade storage assembly includes a storage compartment (e.g., a new blade storage compartment) configured to serve as a cover for another compartment (e.g., a used blade storage compartment)

In example embodiments, a cutter (or cutter apparatus) includes a blade storage assembly that is integrated with a cover portion of the cutter and accessible only by opening the cover portion. In example embodiments, a cutter (or cutter apparatus) includes a blade storage assembly and a blade release device that are accessible only by opening a cover portion of the cutter.

Example embodiments of cutters (or cutter apparatuses) can include other hood latching (or securing) mechanisms or devices. By way of example, and referring to FIG. 22, a cutter apparatus 2100 (e.g., substantially similar to the cutter apparatus 100, except as described differently herein) includes a housing 2110 with a hood 2116 that is repositionable in relation to one or more portions of the housing 2110. In FIG. 22, the housing 2110 (only one side portion of which is shown) includes a latch (or latching member) 2272 and an opening 2276. A latch and an opening (e.g., mirror images of the latch 2272 and the opening 2276) are also provided on the other side portion of the housing 2110. In this example embodiment, the latch 2272 includes an engagement portion 2273 with peripheral surfaces (e.g., as shown) and an actuator portion 2274 (e.g., including a flexible portion). The actuator portion 2274 can be provided with gripping surfaces (or elements) on its exterior (e.g., as shown). The peripheral surfaces of the engagement portion 2273 are shaped to engage complementary surfaces of the opening 2276 (of the housing 2110). In this example embodiment, the opening 2276 defines a recess or recessed portion, and the actuator portion 2274 repositions (flexes) inward when the hood 2116 is moved to its closed position causing the engagement portion 2273 to position over and snaps into the opening 2276 to provide a positive lock of the hood 2116 to the housing 2110. In this example embodiment, the engagement portion 2273 is located at a front portion 2278 of the hood 2116 (e.g., at a lower front portion thereof as shown).

In this example embodiment, the latching members are visible through the openings when the hood is secured to the housing. Referring additionally to FIGS. 12A and 12B, additional room can be provided to accommodate the openings 2276 (FIG. 22) by removing (or not including) the optional stop elements 224a and 224b, which are the highest pair of “locking slots”.

The hood (or cover portion) latching mechanisms and devices described herein are not limited to cutters (or cutter apparatuses) and can be provided for other tools and/or tool housings.

Thus, in an example embodiment, a hand tool (or hand tool body) includes a housing with a handle portion (configured for gripping by a hand, e.g., to push or pull the hand tool) that includes a hood, the hood including latching members shaped to engage openings at opposite sides of the housing, respectively, for securing the hood to and providing a positive lock with the housing. In example embodiments, the handle portion is configured for gripping by a hand (e.g., as described herein) to accommodate pushing, pulling or otherwise repositioning the hand tool in relation to a workpiece. In example embodiments, the hood is coupled (e.g., pivotally coupled) to the (housing and/or the) handle portion. In example embodiments, the hood swivels about a securing element (e.g., a rivet) that holds portions (e.g., body halves) of the housing together. In example embodiments, the latching members each include a flexible portion (e.g., that permits movement of the latching members in relation to the openings, respectively). In example embodiments, the latching members each include an (outwardly facing) actuator portion configured to allow a user of the hand tool (e.g., to reposition the flexible portions) to disengage the latching members from the housing. In example embodiments, the latching members are located at a (lower) front portion of the hood. In example embodiments, the openings are defined by surfaces within the housing. In example embodiments, the latching members are visible through the openings when the hood is secured to the housing. In example embodiments, the hood and the housing are configured to permit the hood to reposition between a closed position and a fully opened position. The hood and the housing can be configured with respective surfaces that are brought into contact, for example, when the hood is in its fully opened position.

The hand tool (or hand tool body) can also include a storage assembly that is coupled to (e.g., secured to or integrated with) the hood. The storage assembly includes, for example, a storage compartment configured to serve as a cover for another compartment (e.g., of the storage assembly, or of the hand tool). The hand tool (or hand tool body) can also include a storage assembly at least a portion of which is integrally formed with the hood (e.g., at the underside of the hood or at another portion of the hood facing inside the housing).

### Cutter and Safety Holster System

Example embodiments described herein include a safety holster for a hand tool (such as a cutter) with a repositionable element. The safety holster includes portions that engage and reposition the element (e.g., to a safety position) when the hand tool is pushed or otherwise advanced into the body of the holster. Example embodiments include a holster which is a part or component of a cutter and safety holster system.

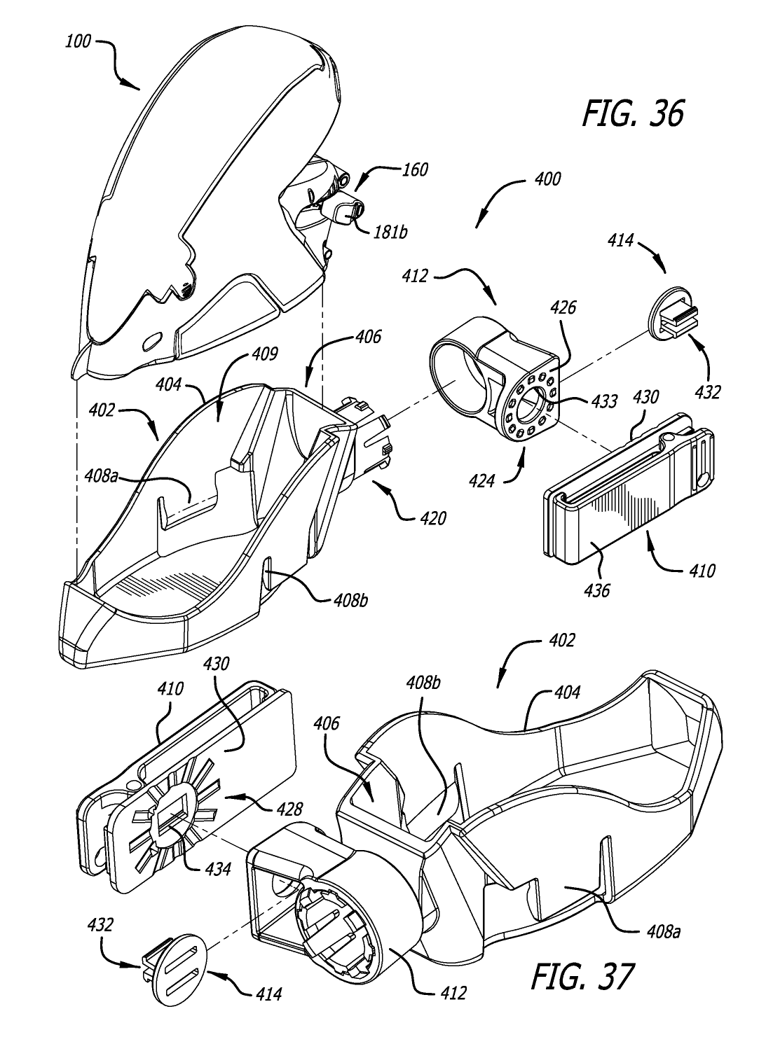

Referring to FIGS. 36-48, in an example embodiment, a cutter and safety holster system 400 includes a cutter, such as the cutter apparatus 100, including a housing and a component configured to reposition in relation to a housing, and a holster 402 including a body (or holster body) 404 sized to receive the cutter therein.

In example embodiments, a holster (or other enclosure) includes or is provided with one or more portions that cause a component of a cutter (or cutter apparatus) to reposition as the cutter is pushed into the holster. Referring to FIG. 36, in this example embodiment, the holster body 404 is configured to provide a cutter-holster interface 406 that causes a component (e.g., the blade depth selector 160) of the cutter apparatus 100 to reposition as the cutter apparatus is pushed into the holster. In example embodiments, the cutter-holster interface 406 is configured to cause the component to reposition in relation to a housing (and/or in relation to one or more other elements or components) of the cutter apparatus as the cutter apparatus is pushed into the holster.

In this example embodiment, the holster body 404 includes a pair of retaining elements 408a and 408b (e.g., on opposing sides thereof) that hold the cutter apparatus 100 in place (one on either side) when the cutter apparatus is fully inserted into the holster body and one or more surfaces 409 configured to reposition the component (of the cutter apparatus) as the cutter apparatus is pushed into the holster body.

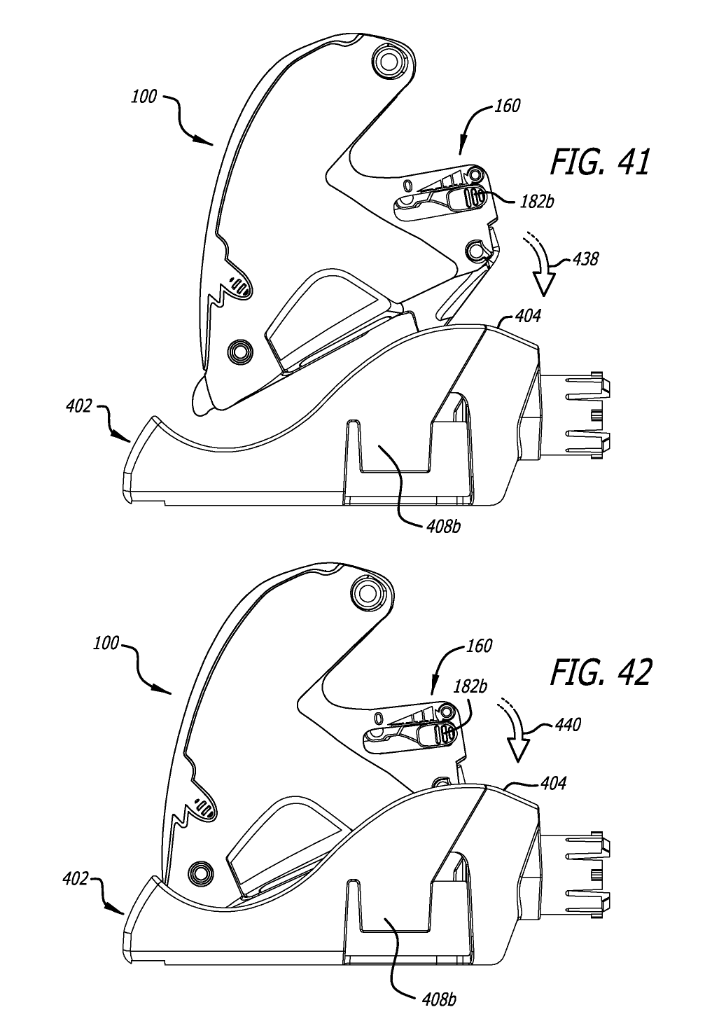

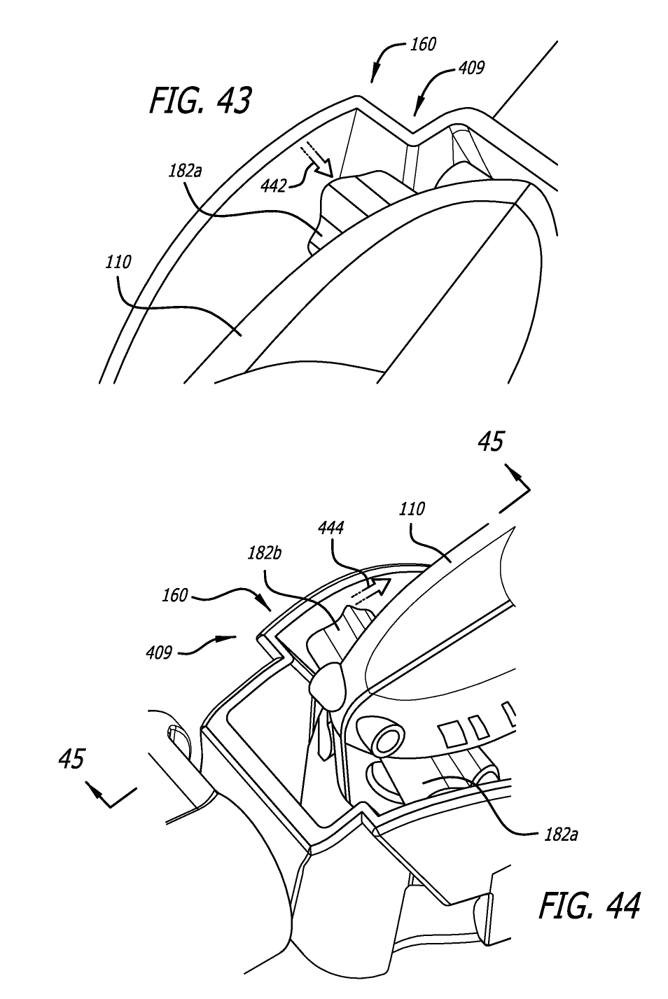

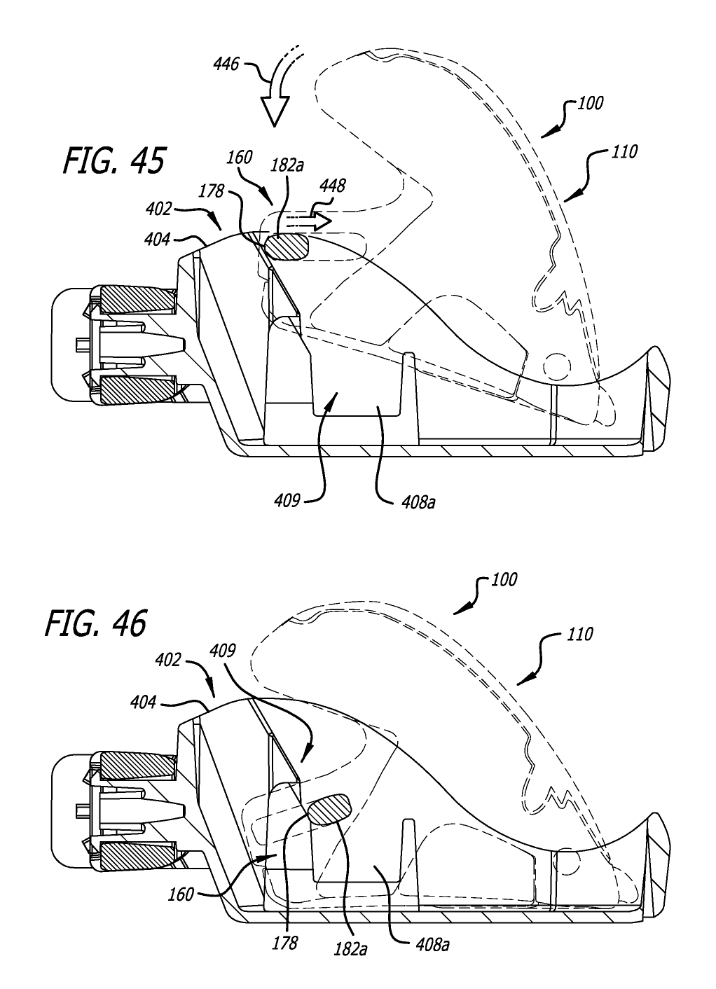

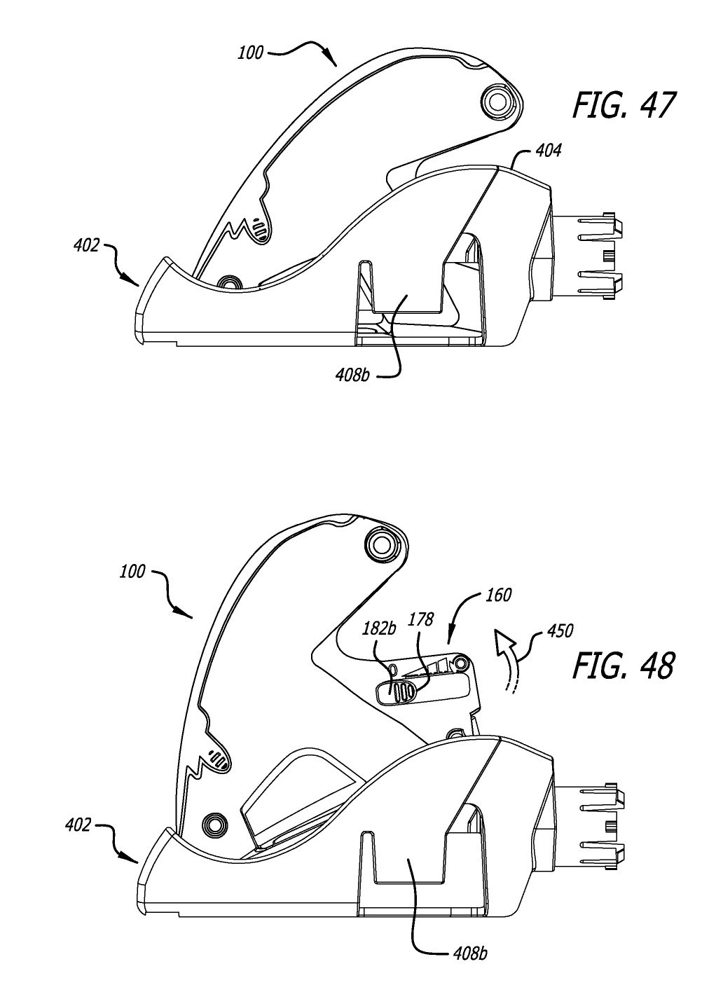

Referring to FIGS. 41 and 42, the cutter-holster interface 406 is utilized by pushing (or otherwise repositioning) the cutter apparatus 100 into the holster body 404 as indicated by arrows 438 and 440, respectively. In this example embodiment, the one or more surfaces 409 are configured to reposition the component (of the cutter apparatus) laterally in relation to the housing (of the cutter apparatus) as indicated by arrow 442 (FIG. 43) and along the housing as indicated by arrow 444 (FIG. 44) as the cutter apparatus is pushed into the holster body. As the cutter apparatus 100 is repositioned into the holster body 404 as indicated by arrow 446 (FIG. 45), the component (e.g., the engagement portion 178 of the blade depth selector 160) is repositioned along the housing as indicated by arrow 448 (FIG. 45) to an end position in relation to the housing 110 (e.g., to a “safe position” as shown in FIG. 46 and previously discussed in relation to the blade depth selector 160). The retaining elements 408a and 408b hold the cutter apparatus 100 in place (as shown in FIG. 47) when the cutter apparatus 100 is fully inserted into the holster body 404. In this example embodiment, the one or more surfaces 409 are configured such that the component does not reposition in relation to the housing 110 when the cutter apparatus 100 is taken out of the holster body 404, for example, by repositioning the cutter apparatus as indicated by arrow 450 (FIG. 48).

In operation, the cutter apparatus 100 is holstered by first placing the front of the cutter apparatus into the pocket on the front of the holster 402 (FIG. 41). As the rear of the cutter apparatus 100 is pressed into the holster body 404 (FIG. 42), a ramp molded into the right inside of the holster body pushes the engagement element 182a (of the blade depth selector 160) to the left (FIG. 43), and a ramp molded into the left inside of the holster body slides the engagement element 182b forward into the safe position (FIG. 44). When the cutter apparatus 100 is removed from the holster 402 (FIG. 48), the blade depth selector 160 is already set to the safe position, reducing the chance of accidental injury.

Thus, in an example embodiment, a holster for a cutter apparatus includes a body sized to receive a cutter apparatus therein and configured to provide a cutter-holster interface that causes a component of the cutter apparatus to reposition in relation to a housing of the cutter apparatus as the cutter apparatus is pushed into the holster. In example embodiments, the component is automatically repositioned to a safe (or other predetermined) position in relation to an operation performed by the component in response to the cutter apparatus being pushed into the holster (e.g., fully inserted into the holster). In example embodiments, the component of the cutter apparatus is a blade depth selector (e.g., a depth selector switch) that is coupled to and repositionable in relation to the housing of the cutter apparatus for allowing a user of the cutter apparatus to select an amount of blade extended from the housing when a blade of the cutter apparatus is deployed. In example embodiments, the component of the cutter apparatus is coupled to the housing of the cutter apparatus and repositionable in relation to the housing. In example embodiments, the component of the cutter apparatus is repositionable (e.g., laterally) in relation to the housing, the cutter-holster interface causing the component to move toward one side of the cutter apparatus in response to the cutter apparatus being pushed (or otherwise repositioned) into the holster. In example embodiments, the component of the cutter apparatus is repositionable (e.g., longitudinally) in relation to the housing (e.g., after initially repositioning the component laterally), the cutter-holster interface causing the component to move toward one end of the cutter apparatus as the cutter apparatus is pushed into the holster. In example embodiments, the component of the cutter apparatus is repositionable along a first direction (e.g., in relation to the housing) when the cutter apparatus is initially pushed into the holster and along a second direction (e.g., in relation to the housing) when the cutter apparatus is pushed further into the holster. By way of example, the first direction is across the cutter apparatus and/or the second direction is along the cutter apparatus. In example embodiments, the first direction is either toward a left side or toward a right side of the cutter apparatus, but not both. The second direction can be toward a distal end of the cutter apparatus. In example embodiments, the second direction is generally orthogonal to the first direction. In other example embodiments, the first and second directions are not orthogonal. In example embodiments, the holster body includes a pair of retaining elements (e.g., on opposing sides thereof) that hold the cutter apparatus in place when the cutter apparatus is fully inserted into the holster body. By way of example, the retaining elements (e.g., two plastic fingers molded into the holster) are configured to flex (e.g., laterally) to accommodate insertion of the cutter apparatus into the holster body. The retaining elements can be complementary in shape to portions (e.g., opposing side portions) of the housing. In example embodiments, the holster body includes one or more surfaces configured to reposition the component (of the cutter apparatus) laterally in relation to the housing and along the housing as the cutter apparatus is pushed into the holster body. In example embodiments, the holster body includes one or more surfaces configured to reposition the component (of the cutter apparatus) in multiple (different) directions (e.g., in a sequence of component repositioning stages) in relation to the housing as the cutter apparatus is pushed into the holster body.

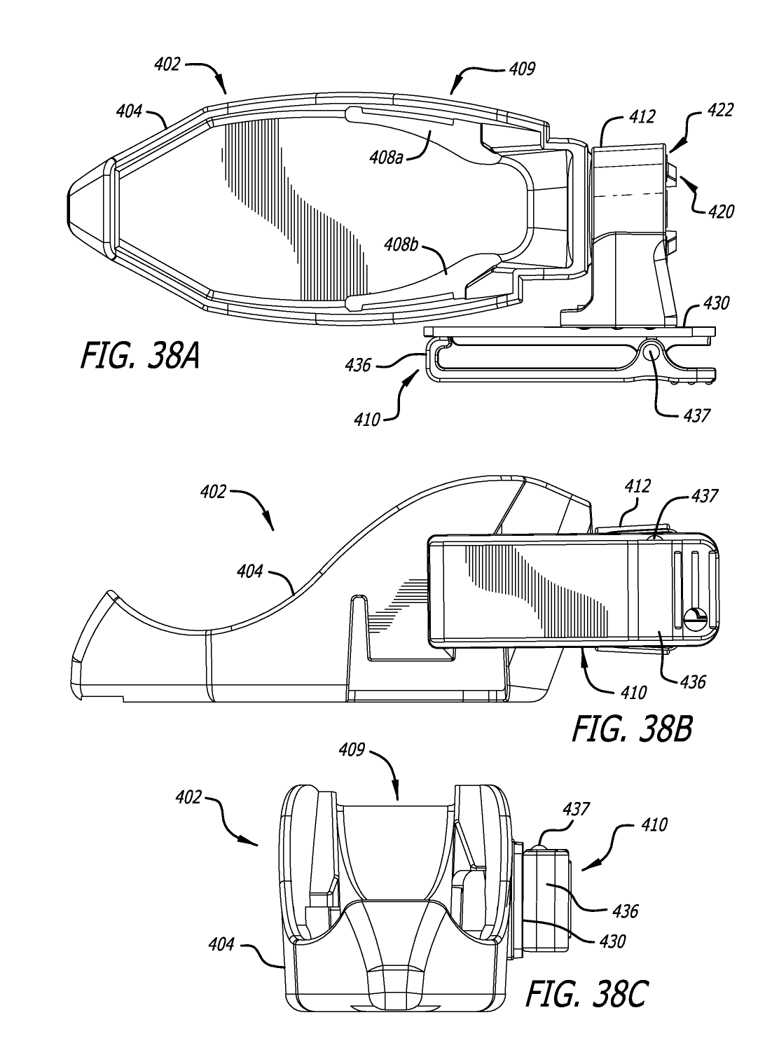

Referring to FIGS. 37, 38A, 38C, and 43-46, the one or more surfaces 409 can include one or more ramps (e.g., inside the holster body 404). The one or more surfaces 409 (e.g., ramps or other structures) can be located at opposing sides of the holster body. In example embodiments, the one or more surfaces 409 are shaped differently (e.g., asymmetrical) at opposing sides of the holster body (e.g., FIGS. 38A and 38C). In example embodiments, the one or more surfaces 409 vary in angle in relation to opposing sides of the holster body (e.g., FIGS. 38A and 38C). In example embodiments, the one or more surfaces 409 include one or more arrangements of multiple surfaces (e.g., a contiguous arrangement of multiple surfaces that form a guide path) to provide one or more guide paths for the component (e.g., FIGS. 38A, 38C, 45, and 46). In example embodiments, the one or more guide paths include guide paths that are different for each of the opposing sides of the holster body (e.g., FIGS. 38A and 38C). In example embodiments, a cutter and safety holster system additionally includes one or more of reconfigurable elements or components that allow a user of the system to securing the holster to an object (e.g., a belt) in multiple different configurations.

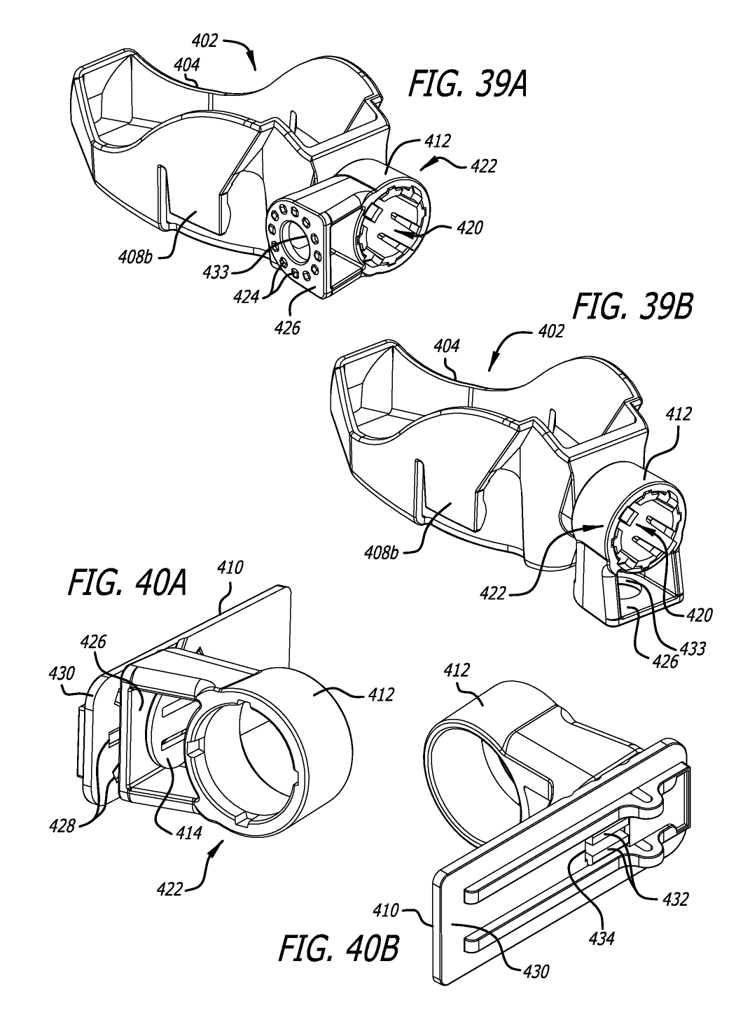

Referring to FIGS. 36, 39A, and 39B, in this example embodiment, the cutter and safety holster system 400 additionally includes a clip 410, a coupler (or hinge) 412, and a locking element 414 (e.g., a locking button). Referring to FIGS. 39A and 39B, engagement members 420 (e.g., plastic fingers extending from the holster body 404) and complementary surfaces 422 (e.g., indentations provided on the hinge 412) provide a rotatable/reconfigurable coupling between the holster body 404 and the hinge 412. The engagement members 420 can be provided, by way of example, on a post molded into the rear of the holster body 404 (e.g., including four plastic fingers as shown). Referring to FIGS. 37, 40A, and 40B, engagement surfaces 424 (e.g., protrusions or raised portions extending from the base 426 of the hinge 412) and complementary surfaces 428 (e.g., indentations or recessed portions on the base 430 of the clip 410) provide a rotatable/reconfigurable coupling between the clip 410 and the hinge 412. In this example embodiment, the engagement surfaces 424 (on the base 426 of the hinge 412) are provided in the form of twelve protrusions (e.g., equally spaced and arranged as shown), and the complementary surfaces 428 (on the base 430 of the clip 410) are provided in the form of twelve slots (e.g., equally spaced and radially arranged as shown). The number of engagement surfaces 424 and complementary surfaces 428 can be greater or less than twelve. In other example embodiments, the number of engagement surfaces 424 is different from the number of complementary surfaces 428. In other example embodiments, the engagement surfaces 424 and the complementary surfaces 428 are arranged differently (e.g., spaced differently). Referring to FIGS. 36, 40A, and 40B, a portion 432 (e.g., two plastic fingers with cantilevered end portions as shown or other engagement members of the locking element 414) and a complementary portion 434 (e.g., an opening of the clip 410) provide a lock element/clip interconnection between the clip 410 and the hinge 412. Referring to FIG. 36, the portion 432 (of the locking element 414) is first inserted through an opening 433 (FIG. 36) in the base 426 (of the hinge 412), and the portion 432 is oriented/rotated as desired. Referring to FIGS. 40A and 40B, with the engagement surfaces 424 (of the hinge 412) oriented as desired and engaged by the complementary surfaces 428 (of the clip 410), the orientation of the hinge 412 in relation to the clip 410 can now be locked by inserting (e.g., snap fitting) the portion 432 (of the locking element 414) through the complementary portion 434 (of the clip 410). Referring to FIGS. 38A-38C, the clip 410 also includes an attachment portion 436 (e.g., sized and configured for securing to a belt) that is, for example, pivotally coupled to the base portion 430 (of the clip 410) about pivot axis 437 (e.g., a rivet) in conventional fashion, e.g., including a spring (not shown) to bias the attachment portion 436 to its closed position. The holster body 404, the hinge 412, locking element 414, and the base portion 430 and the attachment portion 436 (of the clip 410) can be formed of various materials, for example, a thermoplastic that has high strength, rigidity, and impact resistance (e.g., Acrylonitrile butadiene styrene (ABS)), and by various processes (e.g., injection molding).

In example embodiments, a holster for a cutter apparatus further includes or is provided with a clip (or other attachment mechanism or device) and a coupler (e.g., one or more coupling elements) configured to allow a user of the holster to selectively reorient the clip in relation to the holster. By way of example, the one or more coupling elements facilitate selection of one of a plurality of holster-clip configurations. In example embodiments, the one or more coupling elements include one or more rotatable coupling elements (e.g., a hinge with one or more interfaces configured to facilitate mulitiple different coupling configurations). The one or more rotatable coupling elements include a hinge that is coupled to and rotatably repositionable in relation to the holster and/or the clip. In example embodiments, a holster further includes or is provided with a locking element for securing the hinge in position in relation to the clip (e.g., in a position determined by a selectable configuration involving and/or facilitated by the one or more coupling elements). The locking element can include one or more portions that engages one or more complementary portions of the clip when the locking element is in a locked position. In example embodiments, the one or more rotatable coupling elements include a hinge (or other interface element or component) configured to allow the holster to rotatably reposition in a first rotational plane in relation to the hinge and to allow the clip to rotatably reposition in a second rotational plane in relation to the hinge. In example embodiments, the first rotational plane is generally orthogonal to the second rotational plane. In other example embodiments, the first and second rotational planes are not orthogonal.

In an example embodiment, a cutter and safety holster system includes a cutter with a housing and a component configured to reposition in relation to the housing (and/or in relation to one or more other elements or components of the cutter), and a holster with a body sized to receive the cutter therein and configured to provide a cutter-holster interface that causes the component to reposition in relation to the housing as the cutter is pushed into the holster. In example embodiments, the cutter-holster interface is configured to automatically reposition the component to a safe (or other predetermined) position in relation to an operation performed by the component in response to the cutter being pushed into the holster (e.g., fully inserted into the holster body). In example embodiments, the component of the cutter is a blade depth selector (e.g., a depth selector switch) that is coupled to and repositionable in relation to the housing of the cutter for allowing a user of the cutter to select an amount of blade extended from the housing when a blade of the cutter is deployed. In example embodiments, the component of the cutter is coupled to the housing of the cutter and repositionable in relation to the housing. In example embodiments, the component of the cutter is repositionable (e.g., laterally) in relation to the housing, the cutter-holster interface causing the component to move toward one side of the cutter in response to the cutter being pushed (or otherwise repositioned) into the holster. In example embodiments, the component of the cutter is repositionable (e.g., longitudinally) in relation to the housing (e.g., after initially repositioning the component laterally), the cutter-holster interface causing the component to move toward one end of the cutter as the cutter is pushed into the holster. In example embodiments, the component of the cutter is repositionable along a first direction (e.g., in relation to the housing) when the cutter is initially pushed into the holster and along a second direction (e.g., in relation to the housing) when the cutter is pushed further into the holster. By way of example, the first direction is across the cutter and/or the second direction is along the cutter. In example embodiments, the first direction is either toward a left side or toward a right side of the cutter, but not both. The second direction can be toward a distal end of the cutter. In example embodiments, the second direction is generally orthogonal to the first direction. In other example embodiments, the first and second directions are not orthogonal.

In operation, the hinge 412 attaches to the engagement members 420 (e.g., four plastic fingers) at the rear of the holster body 404. The engagement members 420 engage with the complementary surfaces 422 (e.g., indentations) provided on the hinge 412, keeping the hinge 412 in place. The complementary surfaces 422 interface with the engagement members 420 to allow the hinge 412 to be rotated into three different carrying positions. The hinge 412 is attached to the base portion 430 of the clip 410 by way of the portion 432 of the locking element 414. The portion 432 (e.g., two fingers) interfaces with the complementary portion 434 (e.g., a slot) in the base portion 430, thereby allowing the clip 410 to be rotated into twelve different positions.

### Ergonomic Cutter

Example embodiments described herein pertain to an ergonomic hand tool (e.g., an ergonomic cutter) and/or an ergonomic housing or handle for same. In example embodiments described herein, a cutter (or cutter apparatus) and/or a housing or handle for same includes one or more surfaces or other structural features that facilitate or accommodate ergonomic handling or other utilizations of the cutter.

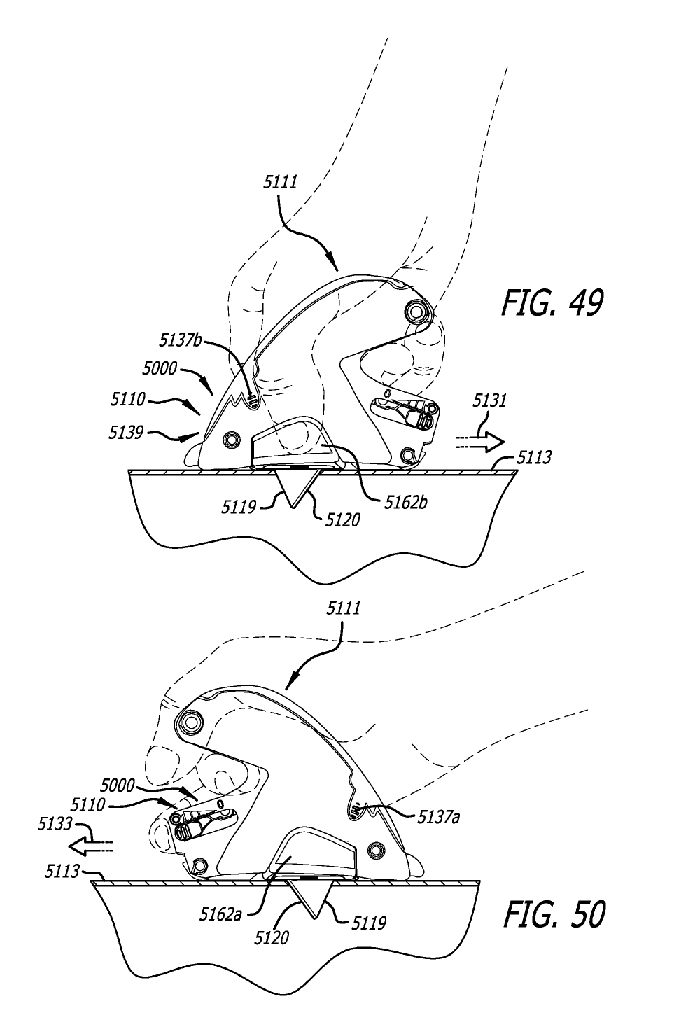

Referring to FIGS. 49-56, in an example embodiment, a hand tool (or hand tool body) 5000 includes a housing 5110 (e.g., substantially similar to the housing 110, except as described differently herein) with a handle 5111 configured for gripping by a hand (e.g., to push or pull the hand tool), the housing 5110 being configured to provide multiple (different) hand-housing interfaces favorable to natural accommodation of the hand while using the hand tool (e.g., holding and repositioning the hand tool in relation to a workpiece 5113). In example embodiments, the housing 5110 and the handle 5111 are sized and shaped to fit in the palm of a hand (e.g., of typical or average size among a particular population or group of people). The housing 5110 and the handle 5111 can also be sized and shaped to accommodate hands that are smaller or larger (than typical or average), as well as hands that are atypical in their proportions. For example, the housing 5110 and the handle 5111 can be sized and shaped to accommodate hands with fingers that are unusually short or long (in relation to palm size).

Thus, in an example embodiment, a hand tool (or hand tool body) includes a housing with a handle that is sized and shaped to fit in the palm of a hand, the housing being configured to provide multiple hand-housing interfaces favorable to natural accommodation of the hand while using the hand tool (e.g., holding and repositioning the hand tool in relation to a workpiece). As shown in FIGS. 49 and 50, in example embodiments, the hand-housing interfaces include one or more interfaces that accommodate the hand at a neutral wrist position. The term “neutral wrist position” means that the wrist is in a natural position in which the hand is generally aligned with the forearm. In other words, the hand is not bent forward or back, or angled side-to-side. Referring again to FIGS. 49 and 50, in example embodiments, the hand-housing interfaces include a tool repositioning interface in which one or more fingers of the hand (e.g., the index finger and the middle finger) are positioned on one side of the housing and the thumb is positioned on the other side of the housing.

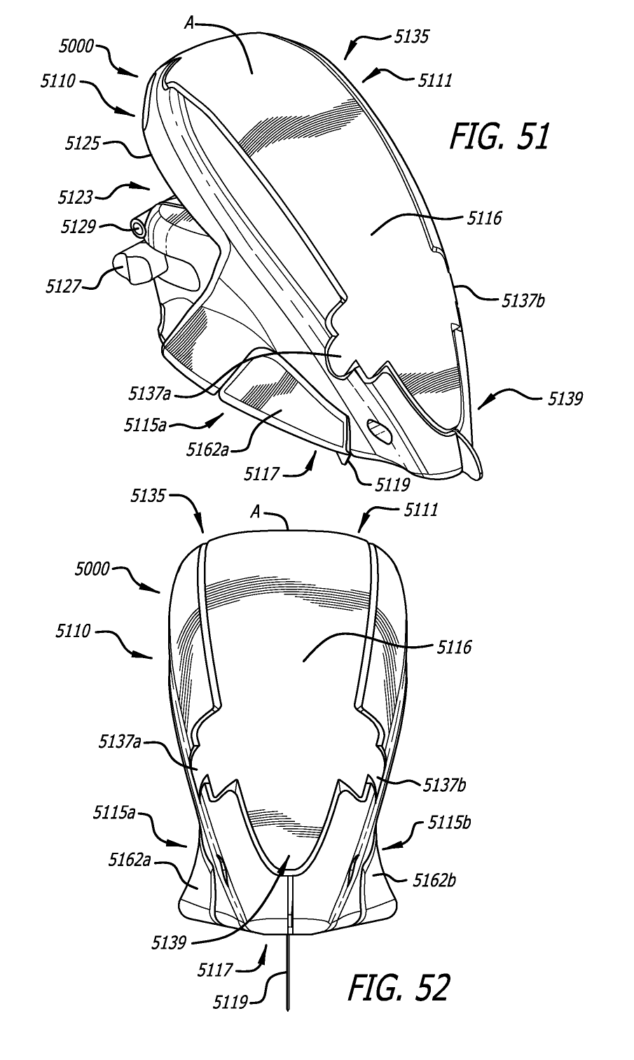

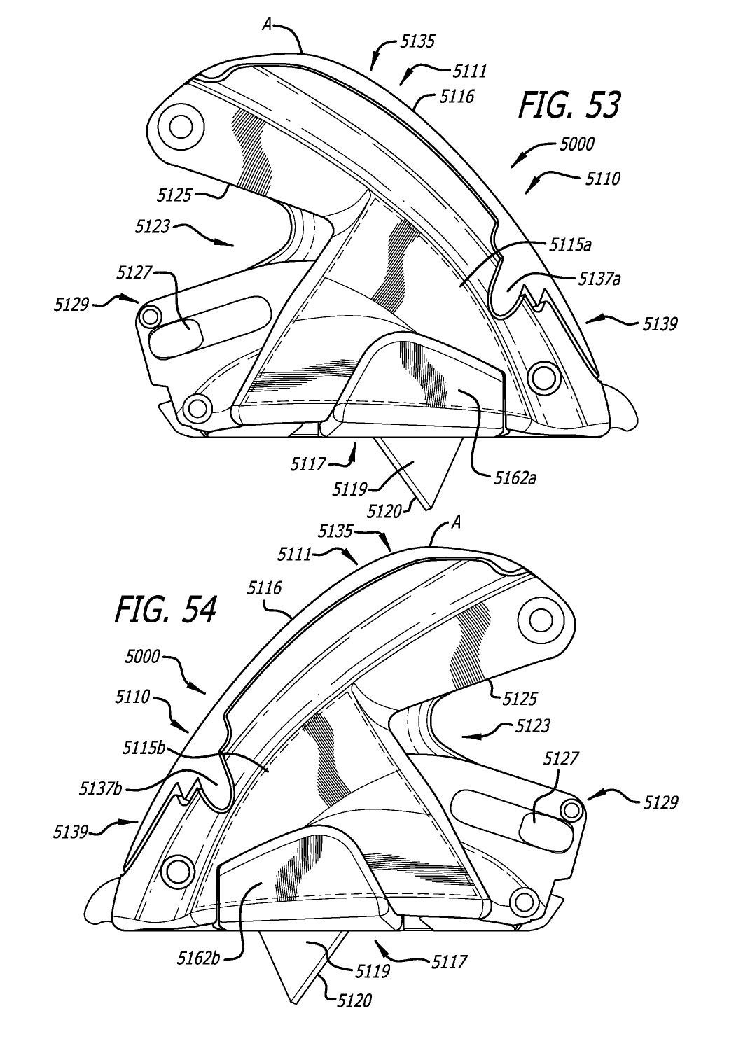

Referring to FIGS. 51-54, in this example embodiment, the hand tool 5000 includes a right side recessed portion 5115a and a left side recessed portion 5115b. FIGS. 53 and 54 show areas of the hand tool 5000 (and the housing 5110), denoted with dashed lines, that provide the right side recessed portion 5115a and the left side recessed portion 5115b, which are both adjacent to a bottom side 5117 of the hand tool 5000 from which a blade 5119 with a cutting edge 5120 extends and/or is deployed. Accordingly, in example embodiments, the hand-housing interfaces include a tool repositioning interface in which one or more fingers (e.g., the index finger and the middle finger) and/or the thumb of the hand are positioned on one or more recessed portions of the housing (e.g., adjacent to the bottom side of the hand tool). In example embodiments, the one or more recessed portions are provided at least in part by a cut guard of the hand tool. In this example embodiment, the right side recessed portion 5115a and the left side recessed portion 5115b are provided in part by cut guards 5121a and 5121b, respectively. In example embodiments, the one or more recessed portions are located adjacent to (and/or along) a side or portion (e.g., a bottom side) of the hand tool that repositions along a workpiece during use or operation of the hand tool. In this example embodiment, the one or more recessed portions are located adjacent to (and along) the bottom side 5117 of the hand tool (e.g., flaring outward as shown to provide structures on opposing sides of the housing for supporting/engaging the one or more fingers and/or the thumb). In example embodiments, the one or more recessed portions extend (e.g., flare) outward adjacent to the bottom side of the hand tool (e.g., providing structures on opposing sides of the housing for supporting and/or engaging the one or more fingers and/or the thumb). In example embodiments, the one or more recessed portions include a recessed portion formed in part by a portion of the handle. In this example embodiment, the one or more recessed portions include a recessed portion 5123 formed in part by an underside 5125 of the handle 5111 (e.g., sized and shaped to receive one or more fingers and/or a thumb). In example embodiments, the recessed portion is between the handle and a repositionable element or component (e.g., a blade depth selector) of the hand tool.

In example embodiments, the hand-housing interfaces include a tool repositioning interface in which one or more fingers and/or the thumb of the hand are positioned at an underside of the handle (e.g., facing a lower rear portion of the housing). By way of example, and referring again to FIG. 49, the housing can be configured such that the one or more fingers and/or the thumb, when gripping the underside of the handle, are biased away from a component of the hand tool (e.g., a blade depth selector) that is repositionable in relation to the housing. In example embodiments, the housing includes a lower rear portion that faces the underside of the handle, the lower rear portion including a component of the hand tool (e.g., a blade depth selector) that is repositionable in relation to the housing. In example embodiments, the component is accessible (e.g., can be toggled) from either side of the housing and/or located at a portion of the housing where the component will not interfere with a user's gripping of the handle. Referring again to FIGS. 53 and 54, in this example embodiment, the housing 5110 includes a lower rear portion 5129 that faces the underside 5125 of the handle 5111, the lower rear portion 5129 including a component 5127 (e.g., a blade depth selector switch) that is repositionable in relation to the housing 5110.

In example embodiments, the hand-housing interfaces include an interface that accommodates repositioning a cutting edge of (or secured to) the hand tool toward the user of the hand tool (e.g., as denoted by arrow 5131 in FIG. 49) and another interface that accommodates repositioning the cutting edge away from the user (e.g., as indicated by arrow 5133 in FIG. 50). The hand-housing interfaces (shown in FIGS. 49 and 50, respectively) are both accommodated without having to change the direction that the cutting edge faces in relation to the housing. In example embodiments, the hand tool includes a blade with a cutting edge that faces, when deployed, a single direction in relation to the housing, and multiple (different) hand-housing interfaces accommodate using the blade (e.g., when it is deployed). In example embodiments, the hand tool is a cutter apparatus including a blade, and the handle is shaped to allow a user of the cutter apparatus to perform a cutting operation by either repositioning the housing (e.g., pulling the handle) toward the user with the blade facing toward the user or, with the housing turned in the opposite direction, repositioning the housing (e.g., pushing the handle) away from the user with the blade facing away from the user.

In example embodiments, the hand tool (or hand tool body) includes a curved top portion and/or a cover portion (e.g., sized and shaped to ergonomically facilitate one or more of the hand-housing interfaces described herein). Referring to FIGS. 51-54, in this example embodiment, the handle 5111 includes a hood 5116 and a curved top portion 5135 (e.g., shaped as shown). By way of example, the curved top portion 5135 can be substantially the same in curvature (or shape) moving distally or proximally from an apex (denoted “A”) or topmost point of the housing 5110.

The hand tool (or hand tool body) can also be sized and shaped to ergonomically facilitate gaining access to an interior portion of the hand tool and/or opening a cover portion (e.g., a hood) of the hand tool. By way of example, and referring again to FIG. 49, the cover portion can include or be provided with latches (or other engagement mechanisms or devices) positioned (e.g., at opposing sides of the housing) such that one or more fingers and the thumb, when holding the hand tool, are positioned slightly below the latches, respectively. In this example embodiment, the hood 5116 includes latches 5137a and 5137b positioned at opposing sides of the housing at a front portion 5139 of the hood 5116 such that one or more fingers and the thumb, when holding the hand tool, are positioned slightly below the latches 5137a and 5137b, respectively. Accordingly, in example embodiments, the thumb and forefinger (which hold the hand tool at opposite sides of the housing, respectively) only need to be repositioned a small amount (upward) in order to depress and disengage the cover latches from the housing.

In example embodiments, the hand tool (or hand tool body) includes one or more repositionable portions (e.g., sized and shaped to ergonomically facilitate one or more of the hand-housing interfaces described herein). By way of example, the one or more repositionable portions can include one or more cut guards (or guide members). The one or more repositionable portions include, for example, the cut guards 162a and 162b (e.g., as previously described).

Thus, in an example embodiment, a cutter apparatus includes a housing configured for gripping by a hand, a blade coupled to the housing, and a pair of cut guards coupled to the housing at opposite sides thereof, the cut guards being repositionable in relation to the housing and independently extendable therefrom facilitating ambidextrous operation, the cut guards flaring outward adjacent to the bottom side of the cutter apparatus providing structures on opposing sides of the housing for supporting and/or engaging one or more fingers and/or the thumb.

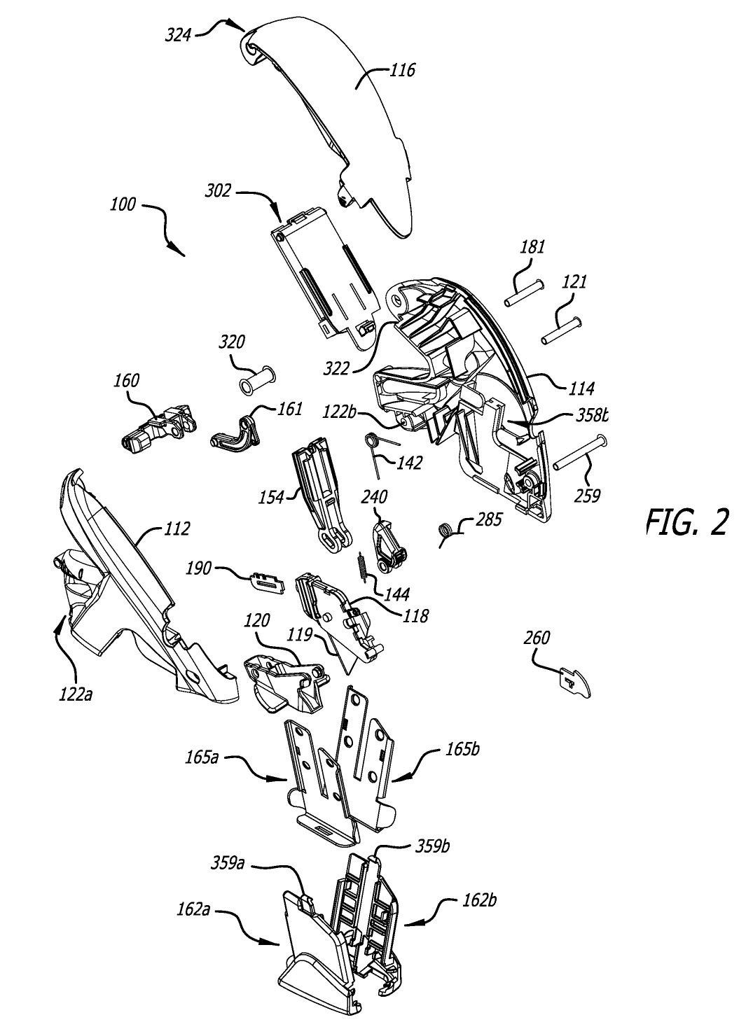

In example embodiments, the one or more repositionable portions include one or more wear resistant portions. In example embodiments, a cutter (or cutter apparatus) includes or is provided with cut guards that each include a wear resistant portion at both an inside portion and a bottom portion of the cut guard. Referring to FIGS. 2, 9, and 10, in this example embodiment, the cut guards 162a and 162b include wear resistant portions 165a and 165b, respectively (e.g., formed or provided as shown). In this example embodiment, the wear resistant portion 165a is (or includes) a sheet metal piece (e.g., a single sheet metal piece) providing an inside surface 166a of the cut guard, the sheet metal piece wrapping around a bottom edge 167a of the cut guard to additionally provide a bottom facing surface 168a of the cut guard. Likewise, the wear resistant portion 165b is (or includes) a sheet metal piece (e.g., a single sheet metal piece) providing an inside surface 166b of the cut guard, the sheet metal piece wrapping around a bottom edge 167b of the cut guard to additionally provide a bottom facing surface 168b of the cut guard. In this example embodiment, the wear resistant portions 165a and 165b are secured to the cut guards 162a and 162b, respectively (e.g., interfitted to complementary surfaces of the cut guards 162a and 162b as shown).

Thus, in an example embodiment, a cutter (or cutter apparatus) includes a housing configured for gripping by a hand, a blade coupled to the housing, and one or more cut guards coupled to and repositionable in relation to the housing, the one or more cut guards each including a wear resistant portion at both an inside portion and a bottom portion of the cut guard. In example embodiments, the wear resistant portion is made of metal (and the adjacent portions of the cut guards are made of plastic). In example embodiments, the wear resistant portion is sheet metal. In example embodiments, the wear resistant portion for each of the one or more cut guards is a sheet metal piece (e.g., a single sheet metal piece) providing an inside surface of the cut guard, the sheet metal piece wrapping around a bottom edge of the cut guard to additionally provide a bottom facing surface of the cut guard. In example embodiments, the wear resistant portion or portions accommodate different cutting modes associated with different positions of the one or more cut guards in relation to the housing. In example embodiments, the one or more cut guards include a pair of cut guards coupled to the housing at opposite sides thereof, the cut guards being repositionable in relation to the housing and independently extendable therefrom.

In example embodiments, the guards and the housing include one or more surfaces that prevent the guards from being removed after the guards are installed. By way of example, the one or more surfaces include or are provided by a retaining member on each guard. Referring to FIGS. 2, 25, and 28, in this example embodiment, the housing 110 includes guides 358a and 358b that provide a support structure allowing the cut guards 162a and 162b to independently reposition between retracted and extended positions in relation to the housing 110. The guides 358a and 358b are provided in the form of, for example, opposing guide channels that receive edges of slots provided in the wear resistant portions 165a and 165b, respectively. In this example embodiment, the cut guards 162a and 162b include retaining members 359a and 359b (e.g., cantilevered arms, as shown in FIG. 2), respectively, which engage stop surfaces 360a and 360b at the top of the guides 358a and 358b, respectively, preventing the cut guards 162a and 162b from repositioning away from the bottom side of the housing beyond their extended positions.

In example embodiments, the cut guards are coupled to the housing with a friction fit (e.g., plastic fingers with a raised divot hold the guards in place after they are slid either up or down in relation to the housing). Referring again to FIGS. 2, 25, and 28, in this example embodiment, the cut guards 162a and 162b are coupled to the housing 110 with a friction fit. The housing 110 and the cut guards 162a and 162b can additionally include cooperative elements configured to assist in holding the cut guards 162a and 162b in place after they are slid either up (e.g., to the fully-retracted position) or down (e.g., to the fully-extended position) in relation to the housing. In this example embodiment, the cooperative elements that hold the cut guards 162a and 162b in place after they are slid up are provided in the form of fingers 361a and 361b (of the housing 110) and protrusions 362a and 362b (of the cut guards 162a and 162b), respectively. The fingers 361a and 361b flex laterally in relation to the housing 110, but are inflexible or rigid along a direction of movement of the cut guards 162a and 162b in relation to the housing 110. The protrusions 362a and 362b (e.g., raised divots that extend as shown through openings in the wear resistant portions 165a and 165b, respectively) are positioned above the fingers 361a and 361b, respectively, when the cut guards 162a and 162b are fully retracted.

Likewise, the cooperative elements that hold the cut guards 162a and 162b in place after they are slid down can be provided, for example, in the form of fingers 363a and 363b (of the housing 110) and protrusions 364a and 364b (of the cut guards 162a and 162b), respectively. The fingers 363a and 363b flex laterally in relation to the housing 110, but are inflexible or rigid along a direction of movement of the cut guards 162a and 162b in relation to the housing 110. The protrusions 364a and 364b (e.g., raised divots that extend as shown through openings in the wear resistant portions 165a and 165b, respectively) are positioned below the fingers 363a and 363b, respectively, when the cut guards 162a and 162b are fully extended.

In example embodiments, a cutter (or cutter apparatus) includes one or more wear resistant portions configured to protect the cutter from wear caused by contact with either a surface of a workpiece that is being cut or a surface that is being used to guide movement of the cutter apparatus during a cutting operation. By way of example, the one or more wear resistant portions include one or more cut guards and a blade actuator. The one or more wear resistant portions include, for example, the cut guards 162a and 162b and the actuator 120 (e.g., as previously described). Referring again to FIGS. 9 and 10, in this example embodiment, the cutter apparatus 100 further includes an additional wear resistant component in the form of a blade actuator (i.e., the actuator 120) that is coupled to and repositionable in relation to the housing 110. In example embodiments, the additional wear resistant component includes a contact surface, and the blade actuator is configured to activate in response to the contact surface coming into contact with a workpiece. Accordingly, and referring to FIG. 9, in this example embodiment, the blade actuator 120 and the cut guards 162a and 162b provide a substantially contiguous wear resistant region (or area) 169 at the bottom of the cutter apparatus when the blade actuator 120 is in an activated position (e.g., flush in relation to adjacent portions of the housing) and the cut guards 162a and 162b are retracted (e.g., in a retracted position in relation to the housing).

Thus, in an example embodiment, a cutter apparatus includes a housing configured for gripping by a hand, a blade coupled to the housing, one or more cut guards coupled to and repositionable in relation to the housing, and a blade actuator coupled to and repositionable in relation to the housing, wherein the one or more cut guards and the blade actuator include wear resistant portions configured to protect the cutter apparatus from wear caused by contact with either a surface of a workpiece that is being cut or a surface that is being used to guide movement of the cutter apparatus during a cutting operation (and independent of how far a cut guard is extended in relation to the housing).

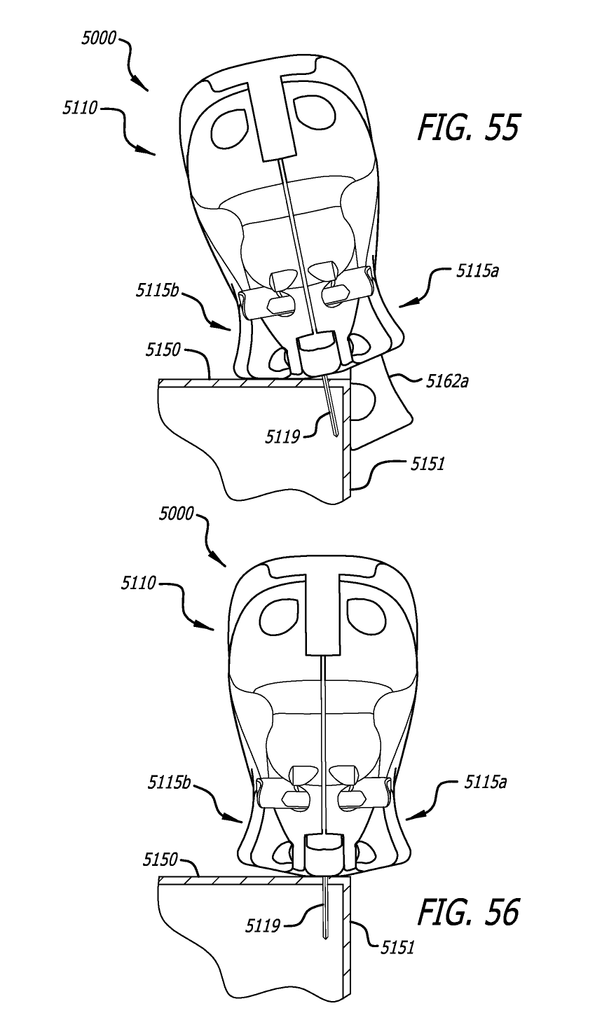

By way of example, and referring to FIGS. 55 and 56, the hand tool 5000 (e.g., a cutter apparatus) is protected from wear caused by contact with either a surface of a workpiece that is being cut (e.g., in a “top cut mode” with one of the guards extended, as shown in FIG. 55) or a surface that is being used to guide movement of the cutter apparatus during a cutting operation (e.g., in a “tray cut mode” or “standard cut mode” with both guards retracted, as shown in FIG. 56). As shown in FIG. 55, in this example embodiment, the cut guards 5162a and 5162b are angled in relation to (toward) the blade 5119 such that the blade 5119 is less likely to make contact with merchandise within an object 5150 (e.g., a box) being cut when a guard (the cut guard 5162a, in this example) is extended and the inside surface of the cut guard bears against a side surface 5151 of the object during a cutting operation.

In example embodiments, none of the planar contact surfaces of the cut guards are parallel or substantially parallel to each other. In example embodiments, the cut guards do not reposition along parallel or substantially parallel paths. In example embodiments, the cut guards each reposition (e.g., translate) in relation to the housing along a path (defined for example by the mechanical interface between the guides 358a and 358b and the cut guards and/or the wear resistant portions) that is at an angle with (i.e., not parallel or substantially parallel to) the plane in which the blade is extended and/or deployed.

In operation, the cut guards allow the knife to be slid along the top of a box, allowing the top of the box to be removed more easily and safely, with less risk of damage to merchandise. The cut guards on either side of the knife allow/facilitate ambidextrous operation. When the cut guards are slid either up or down, plastic fingers with a raised divot, for example, hold them in place. The cut guards are angled inward, toward the cutting edge of the blade, which reduces the chance of damage to merchandise. A retaining tab, for example, on each guard prevents the guards from being removed after they are installed.

Referring to FIGS. 51-56, in an additional ergonomic aspect of the cutter design, the cut guards 5162a and 5162b (as well as adjacent portions of the housing 5110) flare outward toward the bottom side 5117 of the cutter. In example embodiments, the cut guards 5162a and 5162b and/or the housing 5110 are shaped and configured such that the effective width of the housing 5110 increases at the bottom side 5117, thereby provide greater gripping comfort and stability when cutting. For example, the ends of thumb and forefinger, in addition to the palm of the hand, can more readily apply downward force when cutting, which also aids in distributing downward force, thereby potentially lessening or delaying onset of discomfort to the palm of hand.

Although the present invention(s) has(have) been described in terms of the example embodiments above, numerous modifications and/or additions to the above-described embodiments would be readily apparent to one skilled in the art. It is intended that the scope of the present invention(s) extend to all such modifications and/or additions.

What is claimed is:

1. A cutter apparatus comprising:
a housing with an opening;
a blade carrier coupled to and repositionable in relation to the housing;
an actuator for repositioning the blade carrier to a deployed position, the blade carrier repositioning toward the deployed position in response to movement of the actuator toward an actuator blade deployment position;
a push rod that is repositionable within the housing and coupled to the blade carrier such that a location of one or more portions of the push rod in relation to the housing determines the blade depth extending from the opening of the housing when the blade carrier is deployed; and
a blade depth selector coupled to the push rod such that a user of the cutter apparatus can set the location to provide a desired blade depth by selectively repositioning the blade depth selector in relation to the housing.

2. The cutter apparatus of claim 1, wherein the blade carrier is repositionable with multiple degrees of freedom of operational movement.

3. The cutter apparatus of claim 1, wherein the actuator is coupled to the blade depth selector such that movement of the blade depth selector to a different blade depth selection position causes at least a portion of the actuator to reposition in relation to the housing.

4. The cutter apparatus of claim 1, wherein the push rod is mechanically coupled to the blade carrier.

5. The cutter apparatus of claim 1, wherein the push rod is slidably supported at opposing sides thereof by a pair of ridges within the housing.

6. The cutter apparatus of claim 1, wherein the push rod is slidably supported at opposing sides thereof by a pair of channels within the housing.

7. The cutter apparatus of claim 6, wherein the pair of channels include stop surfaces that limit movement of the push rod.

8. The cutter apparatus of claim 1, wherein the push rod is slidably supported at opposing sides thereof by a pair of ridges within the housing and by a pair of channels within the housing.

9. The cutter apparatus of claim 1, wherein the push rod includes one or more portions that receive one or more complementary portions of the blade carrier and about which the blade carrier pivots as the actuator is moved toward its blade deployment position.

10. The cutter apparatus of claim 9, wherein the one or more portions of the push rod are shaped to permit movement of the blade carrier toward an end portion of the housing in response to a cutting edge of the blade coming into contact with a workpiece.

11. The cutter apparatus of claim 1, wherein the blade depth selector includes an engagement portion and linkage that allows the engagement portion to reposition in relation to the housing.

12. The cutter apparatus of claim 11, wherein the engagement portion includes opposing engagement elements that extend from openings on opposite sides of the housing to allow ambidextrous operation of the blade depth selector.

13. The cutter apparatus of claim 1, wherein the blade depth selector is repositionable along a blade depth selector path and includes an engagement portion with opposing engagement elements that extend respectively from a pair of openings on opposite sides of the housing.

14. The cutter apparatus of claim 13, wherein the opposing engagement elements are fixed in position in relation to each other.

15. The cutter apparatus of claim 13, wherein the pair of openings is located at portion of the housing which is separate from another portion of the housing that is shaped for gripping by a hand.

16. The cutter apparatus of claim 13, wherein the housing includes blade depth indicator markings providing visual representations of selectable blade depths corresponding to positions of the engagement portions along the pair of openings resulting in the respective blade depth selections.

17. The cutter apparatus of claim 1, wherein the blade depth selector includes a blade depth stop tab that engages one of a plurality of stop surfaces within the housing.

18. The cutter apparatus of claim 17, wherein the stop surfaces are provided by a blade depth stop plate that includes notches complementary in shape to the blade depth stop tab.

19. The cutter apparatus of claim 18, wherein the blade depth stop tab and the blade depth stop plate are made of metal.

20. The cutter apparatus of claim 17, wherein the blade depth selector includes a flexible portion that allows a user of the cutter apparatus to disengage the blade depth stop tab from an opposing engagement surface so that the blade depth selector can be repositioned along a blade depth selector path.

21. The cutter apparatus of claim 20, wherein the flexible portion is configured to allow a portion of the blade depth selector to reposition laterally in relation to the blade depth selector path.

22. The cutter apparatus of claim 17, wherein the blade depth selector includes an engagement portion; and the blade depth stop tab travels within a channel sized to permit sufficient lateral repositioning of the engagement portion to disengage the blade depth stop tab from an opposing engagement surface while preventing excessive lateral movement of the engagement portion.

23. The cutter apparatus of claim 1, wherein the blade depth selector is pivotally coupled to the push rod by a blade depth linkage member.

24. The cutter apparatus of claim 23, further comprising:
a spring connected between the blade depth linkage member and the blade carrier.

25. The cutter apparatus of claim 1, further comprising:
a spring operatively connected between the blade depth selector and the blade carrier.

26. The cutter apparatus of claim 13, wherein the opposing engagement elements are resiliently coupled to a central portion of the blade depth selector.

27. The cutter apparatus of claim 26, wherein the engagement elements bias opposing portions of the blade depth selector to engage one of a plurality of pairs of stop surfaces within the housing, the engagement elements disengaging from the stop surfaces when both of the engagement elements are depressed so that the blade depth selector can be repositioned along the blade depth selector path.

28. The cutter apparatus of claim 26, wherein the blade depth selector includes a pair of fingers that are coupled respectively to the engagement elements, the fingers engaging with one of a plurality of opposing pairs of stop surfaces within the housing, the fingers disengaging from the stop surfaces when both of the engagement elements are depressed so that the blade depth selector can be repositioned along the blade depth selector path.

29. The cutter apparatus of claim 1, wherein the blade depth selector includes a cam wheel that is pivotally coupled and repositionable in relation to the housing and the push rod repositions in response to movement of the cam wheel.

30. The cutter apparatus of claim 29, wherein the push rod is curved in shape and pivotally coupled to the blade carrier.
